(19) United States
(12) Patent Application Publication
(10) Pub. No.: US 2013/0018704 A1
(43) Pub. Date: Jan. 17, 2013

(54) SYSTEMS AND METHODS FOR DETERMINING SCHOOL GEOGRAPHIC BOUNDARIES AND RELATED SEARCHES

(71) Applicant: Ying Liu, San Jose, CA (US)

(72) Inventor: Ying Liu, San Jose, CA (US)

(21) Appl. No.: 13/541,514

(22) Filed: Jul. 3, 2012

Related U.S. Application Data
(60) Provisional application No. 61/507,580, filed on Jul. 13, 2011.

(51) Int. Cl. G06Q 50/20

(52) U.S. Cl. 705/7.38

(57) ABSTRACT

Method, system, and computer program product for collecting and integrating school information. The method includes collecting boundary data for one or more schools, and determining one or more boundary lines based on at least the collected boundary data. Each of the one or more boundary lines represent a border between a first area assigned to a first school selected from the one or more schools and a second area assigned to a second school selected from the one or more schools. Additionally, the method includes digitizing the one or more boundary lines, and collecting student performance data for the one or more schools. The collected student performance data include first student performance data for the first school and second student performance data for the second school. Moreover, the method includes storing the one or more digitized boundary lines and the student performance data in one or more data stores.

### 1. CROSS-REFERENCES TO RELATED APPLICATIONS

This application claims priority to U.S. Provisional Patent Application No. 61/507,580, filed Jul. 13, 2011, incorporated by reference herein for all purposes.

### 2. BACKGROUND OF THE INVENTION

The present invention is directed to determining and utilizing geographic boundaries. More particularly, the invention provides systems and methods for determining school geographic boundaries and related searches. Merely by way of example, the invention has been applied to the determination of the boundaries of schools for attendance determination and usage of those boundaries for searching purposes. But it would be recognized that the invention has a much broader range of applicability.

In urban and suburban areas, many municipalities (e.g., cities, villages, towns, unincorporated areas, etc.) are often found in a very small geographic area. Each of these municipalities have boundaries that vary from the simple to the very complex based on, for example, the locations of roads and geographic features (e.g., rivers and other bodies of water, hills, etc.) as well as historical events. In other examples, the municipal boundaries are seemingly not logical and/or not related to any current day landmarks. These municipal boundaries often serve as practical boundaries for the availability of governmental services. In yet other examples, one or more municipalities may share governmental services across their respective boundaries.

FIG. 1 is a simplified conventional diagram showing a municipal boundary of the City of Cupertino, Calif. and several surrounding municipalities. This diagram is merely an example, which should not unduly limit the scope of the claims. One of ordinary skill in the art would recognize many variations, alternatives, and modifications. As shown in FIG. 1, Cupertino shares an often irregular boundary between other municipalities such as Sunnyvale, Santa Clara, Saratoga, and others. For example, the shape and/or location of the boundaries of Cupertino are not always readily determinable from the other geographic features depicted on the map.

One common governmental service is the public school system. Public school services are generally organized into school districts. In some cases, boundaries of the school districts align with corresponding municipal boundaries. In other cases, the boundaries of the school districts align very poorly, or not all, with the municipal boundaries. Some school districts have only a single school, but most include multiple schools. Some districts have multiple levels of schools (e.g., high schools, middle schools, and/or elementary schools) and others have only one level of school (e.g., the Los Gatos-Saratoga Joint Union High School District includes only high schools, which service parts or all of several elementary and middle school districts). Most schools have boundaries (e.g., attendance boundaries) that determine which of the schools the children residing at a particular address are to attend.

FIG. 2 is a simplified conventional diagram showing the boundary map of certain elementary schools in the Cupertino School District. This diagram is merely an example, which should not unduly limit the scope of the claims. One of ordinary skill in the art would recognize many variations, alternatives, and modifications. Comparison of the boundaries for the City of Cupertino in FIG. 1 and the Cupertino School District in FIG. 2 shows significant differences between the two boundaries. For example, the Stocklmeir Elementary School has a boundary that is almost entirely outside of the City of Cupertino and within the boundary of the City of Sunnyvale. In another example, elementary schools such as Garden Gate and/or Collins have boundaries that overlap both the City of Cupertino as well as other municipalities.

The quality of public schools often varies between districts and even among schools within the same district. For example, the quality of the public schools is often an important factor considered by parents when they purchase a home and/or select a property to rent. In another example, the quality of the public schools impacts the price and resale value of properties. Hence, it is highly desirable to improve techniques for determining the boundaries of schools and using those boundaries to search for a desired property (e.g., residence, home, house, apartment, duplex, townhouse, flat, rental unit, rental property, and/or real estate property).

### 3. BRIEF SUMMARY OF THE INVENTION

The present invention is directed to determining and utilizing geographic boundaries. More particularly, the invention provides systems and methods for determining school geographic boundaries and related searches. Merely by way of example, the invention has been applied to the determination of the boundaries of schools for attendance determination and usage of those boundaries for searching purposes. But it would be recognized that the invention has a much broader range of applicability.

According to at least one embodiment, a method for collecting and integrating school information includes collecting boundary data for one or more schools; determining one or more boundary lines based on at least the collected boundary data, each of the one or more boundary lines representing a border between a first area assigned to a first school selected from the one or more schools and a second area assigned to a second school selected from the one or more schools; digitizing the one or more boundary lines; collecting student performance data for the one or more schools, the collected student performance data including first student performance data for the first school and second student performance data for the second school; and storing the one or more digitized boundary lines and the student performance data in one or more data stores. The process for storing the one or more digitized boundary lines and the student performance data includes associating the one or more digitized boundary lines with at least the first school and the second school and associating the first student performance data with the first school and the second student performance data with the second school.

According to another embodiment, a method for creating one or more boundary lines includes identifying one or more sources of school boundary data; processing information associated with each of the one or more sources of school boundary data; identifying a format for each of the one or more sources of school boundary data; collecting boundary data for one or more schools from the one or more sources of school boundary data; determining one or more boundary lines based on at least the collected boundary data, each of the one or more boundary lines representing a border between a first area assigned to a first school selected from the one or more schools and a second area assigned to a second school selected from the one or more schools; digitizing the one or more boundary lines; resolving inconsistencies between the one or more digitized boundary lines; and storing the one or more digitized boundary lines in one or more data stores. The process for storing the one or more digitized boundary lines includes associating the one or more digitized boundary lines with at least the first school and the second school.

According to yet another embodiment, a method for collecting school data includes collecting first student performance data associated with a school from a first data source; collecting second student performance data associated with the school from a second data source; processing information associated with the first student performance data and the second student performance data; processing the first student performance data and the second student performance data; if the first student performance data is not consistent with the second student performance data, generating third student performance data based on at least information associated with the second student performance data; if the first student performance data is consistent with the second student performance data, generating the third student performance data based on at least information associated with the first student performance data and the second student performance data; determining a geolocation of the school; and storing the third student performance data and the geolocation in one or more data stores. The process for storing the third student performance data and the geolocation includes associating the third student performance data with the school and associating the geolocation with the school.

According to yet another embodiment, a method for collecting and storing property data includes accessing a first property data source using a first interface; requesting at least first property data correspond to a first property from the first property data source; determining a geolocation for the first property based on at least information associated with the first property data; accessing one or more first data stores; receiving, from the one or more first data stores, information associated with one or more attending schools related to the geolocation; and storing the first property data and the one or more attending schools in one or more second data stores. The process for storing the first property data and the one or more attending schools includes associating the one or more attending schools with the first property. According to yet another embodiment, a method for searching for a school includes receiving, by a search interface, one or more school search parameters and one or more geographic search parameters, the one or more school search parameters including at least one or more student performance thresholds; processing information associated with the one or more school search parameters and the one or more geographic search parameters; accessing one or more data stores; requesting, from the one or more data stores, at least student performance data for a school; processing the student performance data and the one or more student performance thresholds; requesting, from the one or more data stores, at least one or more attendance boundaries for the school; processing the one or more attendance boundaries and the one or more geographic search parameters; and generating a search result identifying at least data associated with the school if the one or more attendance boundaries satisfy the one or more geographic search parameters and the student performance data meets or exceeds the one or more student performance thresholds.

According to yet another embodiment, a method for searching for a property includes receiving, by a search interface, one or more school search parameters, one or more geographic search parameters, and one or more property search parameters, the one or more school search parameters including at least one or more student performance thresholds; processing information associated with the one or more school search parameters, the one or more geographic parameters, and the one or more property search parameters; accessing one or more data stores; requesting, from the one or more data stores, at least student performance data for a school; processing the student performance data and the one or more student performance thresholds; requesting, from the one or more data stores, at least one or more attendance boundaries for the school; requesting, from the one or more data stores, at least property location data and property characteristic data corresponding to a property, the property location data including an address corresponding to the property; processing information associated with the property characteristic data and the one or more property search parameters; processing information associated with the address and the one or more geographic search parameters; processing information associated with the address and the one or more attendance boundaries; and generating a search result identifying at least data associated with the property if the student performance data meets or exceeds the one or more student performance thresholds, the address satisfies the geographic search parameters' the address is within the one or more attendance boundaries, and the first property satisfies the one or more property search parameters.

According to yet another embodiment, a method for searching for a property includes receiving, by a search interface, a target school and property search parameters; processing information associated with the target school and the one or more property search parameters; accessing one or more data stores; requesting, from the one or more data stores, one or more attendance boundaries for the target school; requesting, from the one or more data stores, at least property location data and property characteristic data corresponding to a property, the property location data including an address corresponding to the property; processing information associated with the property characteristic data and the one or more property search parameters; processing information associated with the address and the one or more attendance boundaries; and generating a search result identifying at least data associated with the property if the address is within at least the one or more first attendance boundaries and the property satisfies the one or more property search parameters.

According to yet another example, a method for searching for a property includes receiving, by a search interface, a first target school, a second target school, and property search parameters; processing information associated with the first target school, the second target school, and the one or more property search parameters; accessing one or more data stores; requesting, from the one or more data stores, one or more first attendance boundaries for the first target school; requesting, from the one or more data stores, one or more second attendance boundaries for the second target school; requesting, from the one or more data stores, at least property location data and property characteristic data corresponding to a property, the property location data including an address corresponding to the property; processing information associated with the property characteristic data and the one or more property search parameters; processing information associated with the address and the one or more first attendance boundaries; processing information associated with the address and the one or more second attendance boundaries; and generating a search result identifying at least data associated with the property if the address is within the one or more first attendance boundaries, the address is within the one or more second attendance boundaries, and the first property satisfies the one or more property search parameters.

According to yet another embodiment, a method for identifying one or more school combinations includes receiving, by a search interface, a first school; processing information associated with the first school; accessing one or more data stores; requesting, from the one or more data stores, one or more first attendance boundaries for the first school; requesting, from the one or more data stores, one or more second attendance boundaries for at least a second school; determining a first area based on at least information associated with the first attendance boundaries; determining a second area based on at least information associated with the second attendance boundaries; processing the first area and the second area; identifying a school combination if the first area and the second area overlap; and generating a search result identifying at least data associated with the school combination.

Depending upon the embodiment, one or more of these benefits may be achieved. These benefits and various additional objects, features, and advantages of the present invention can be fully appreciated with reference to the detailed description and accompanying drawings that follow.

### 4. BRIEF DESCRIPTION OF THE DRAWINGS

FIG. 1 is a simplified conventional diagram showing a municipal boundary of the City of Cupertino, Calif. and several surrounding municipalities.

FIG. 2 is a simplified conventional diagram showing the boundary map of certain elementary schools in the Cupertino School District.

FIG. 3 is a simplified diagram showing a method for collecting and integrating various types of school information according to one embodiment of the present invention.

FIG. 4 is a simplified diagram showing a method for generating boundary information for a school district according to one embodiment of the present invention.

FIG. 5 is a simplified diagram showing the process for creating one or more school boundaries using a street attendance directory information source as part of the method for generating boundary information for a school district according to one embodiment of the present invention.

FIG. 6A is a simplified diagram showing a collection of geolocations and associated shapes as displayed in a boundary editor as part of the method for generating boundary information for a school district according to one embodiment of the present invention

FIG. 6B is a simplified diagram showing a collection of geolocations and associated shapes and corresponding school boundaries as displayed in a boundary editor as part of the method for generating boundary information for a school district according to one embodiment of the present invention

FIG. 7 is a simplified diagram showing the process for creating one or more school boundaries using an online school locator information source as part of the method for generating boundary information for a school district according to another embodiment of the present invention.

FIG. 8 is a simplified diagram showing the process for creating one or more school boundaries using a boundary map information source as part of the method for generating boundary information for a school district according to yet another embodiment of the present invention.

FIG. 9 is a simplified diagram showing the display of the boundary editor with both a boundary map and a corresponding street map displayed as part of the method for generating boundary information for a school district according to one embodiment of the present invention.

FIG. 10 is a simplified diagram showing a method for collecting, cleaning, and normalizing school information according to one embodiment of the present invention.

FIG. 11 is a simplified diagram showing a method for collecting and storing property information according to one embodiment of the present invention.

FIG. 12 is a simplified diagram showing a process for merging identical properties as part of a method for collecting and storing property information according to one embodiment of the present invention.

FIG. 13 is a simplified diagram showing a method for performing a school search query using school boundary information according to one embodiment of the present invention.

FIG. 14 is a simplified diagram showing a method for performing a property search query using school boundary information according to one embodiment of the present invention.

FIGS. 15A, 15B, and 15C are simplified diagrams showing samples of a web interface for an implementation of the method for performing a property search query using school boundary information according to one embodiment of the present invention.

FIG. 16 is a simplified diagram showing a method for performing a property search query using school boundary information according to another embodiment of the present invention.

FIGS. 17A and 17B are simplified diagrams showing samples of a web interface for an implementation of the method for performing a property search query using school boundary information according to one embodiment of the present invention.

FIG. 18 is a simplified diagram showing a method for performing a school search query using school boundary information according to an embodiment of the present invention.

FIG. 19 is a simplified diagram showing a process for determining school overlap combinations using school boundary information as part of the method for performing a school search query using school boundary information according to an embodiment of the present invention.

FIG. 20 is a simplified diagram showing a sample search result for the method for performing a school search query using school boundary information according to one embodiment of the present invention.

FIG. 21 is a simplified diagram of the school boundary digitization and integration process according to one embodiment of the present invention.

FIG. 22 is a simplified diagram of the school boundary data based school locator according to one embodiment of the present invention.

FIG. 23 is a simplified diagram of the property-first process of searching for properties within the boundary of a school or an overlap of multiple schools according to one embodiment of the present invention.

FIG. 24 is a simplified diagram of the pre-processing method for searching for properties within the boundary of a school or an overlap of multiple schools according to one embodiment of the present invention.

FIG. 25 is a simplified diagram of the property-first process of searching for properties with both school search criteria and property search criteria according to one embodiment of the present invention.

FIG. 26 is a simplified diagram of the school-first process of searching for properties with both school search criteria and property search criteria according to one embodiment of the present invention.

FIG. 27 is a simplified diagram of the pre-processing method for searching for properties with both school search criteria and property search criteria according to one embodiment of the present invention.

### 5. DETAILED DESCRIPTION OF THE INVENTION

The present invention is directed to determining and utilizing geographic boundaries. More particularly, the invention provides systems and methods for determining school geographic boundaries and related searches. Merely by way of example, the invention has been applied to the determination of the boundaries of schools for attendance determination and usage of those boundaries for searching purposes. But it would be recognized that the invention has a much broader range of applicability.

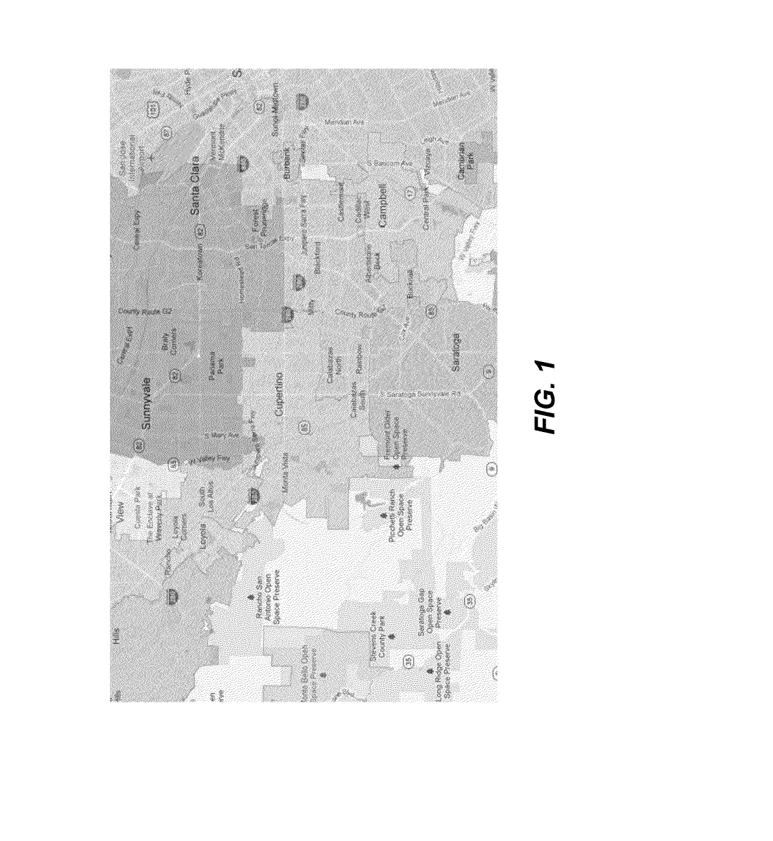

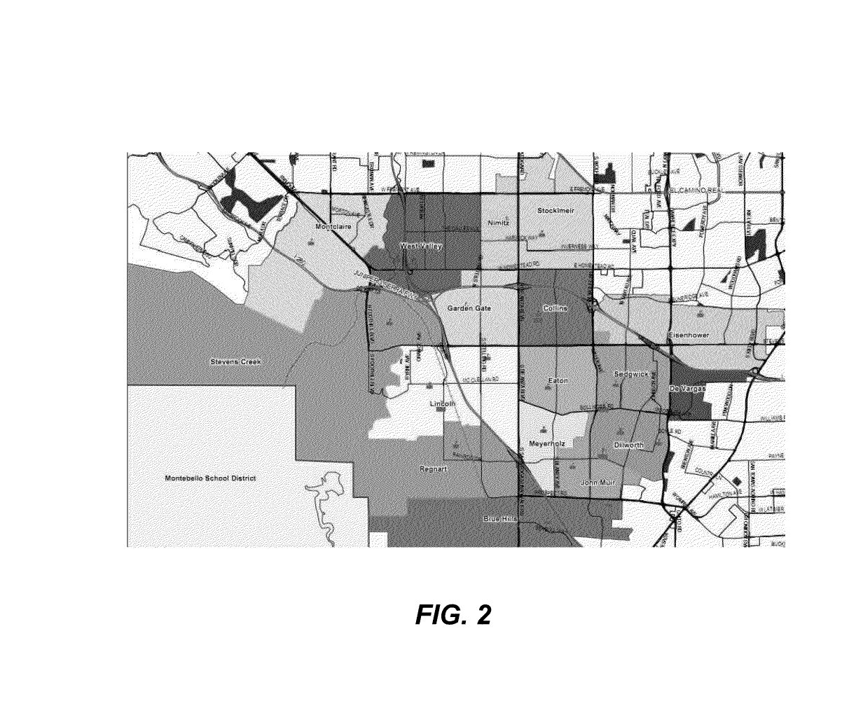

As FIGS. 1 and 2 demonstrate, it is not a simple task to determine the schools and/or school districts that serve a particular address. The school boundaries and/or the school district boundaries often do not align with municipal boundaries. In addition, each school district, and possibly each school, provides their attendance boundaries using different approaches and/or largely incompatible systems. For example, one school district and/or school may provide a web site to enter an address to determine the attending school and/or the attending schools if the school district has schools at multiple levels (e.g., elementary, middle, and/or high). In another example, the address is entered using a very strict format. In yet another example, the address is input using one or more input fields. In yet another example, the one or more input fields include one or more selected from a list consisting of address number, street name, apartment number, city, state, zip code, and the like. In yet another example, each web site uses a different format and/or a different number of the one or more input fields. In yet another example, the school district may simply supply a map that does not always clearly provide enough low-level detail to identify the attending school along the border regions between schools or between school districts. In yet another example, if a particular address is not within the school district or school currently being searched, there is no mechanism to identify the relevant adjacent school and/or school district the address is part of.

Consequently, a system that identifies school attendance and boundary information for all the addresses in a particular area, irrespective of the individual schools and/or school districts would be advantageous. For example, such a system would provide a single common search mechanism for identifying the attendance information for a specific address. In another example, it would eliminate the problems caused by the disparate approaches used by different school districts and/or schools. In yet another example, a system that identified attendance information at the individual school level would also address differences between schools in the same school district. In yet another example, such a system could pre-determine the school attendance information for all the addresses to reduce the impracticalities and inefficiencies of having to make this determination during a search.

In certain embodiments, the system that identifies school attendance and boundary information is based on geolocation data rather than address. For example, geolocation data identifies a geographic location. In another example, geolocation data is an absolute location. In yet another example, geolocation is a relative location. In yet another example, geolocation data includes a latitude and longitude. In yet another example, geolocation data includes World Geodetic System coordinates. In yet another example, a geolocation-based school attendance and boundary system records the boundaries using polygons and/or other boundary representations. In yet another example, the geolocation-based system reduces the problems associated with the parsing of text addresses that must account for differences such as “Ave.” versus “Avenue” and/or “Mt.” versus “Mountain.” In yet another example, the geolocation-based system reduces problems associated with new addresses that are not in a school district's and/or school's attendance database. In yet another example, these new addresses are the result of new construction. In yet another example, the geolocation-based school attendance and boundary system leverages existing geocoding services. In yet another example, geocoding services convert street addresses to geolocation data.

In some embodiments, the system that identifies school attendance and boundary information provides additional advantages. For example, the system supports searching for home properties within the boundary of a selected school and/or an overlap of multiple selected schools. In another example, the system supports searching for properties with both property criteria and school criteria. In yet another example, the system supports digitization and integration of school boundary information across multiple school districts.

In certain embodiments, the system supports home buyers and renters. For example, schools play important roles in house hunting efforts of individuals, parents, families, and/or real estate professionals because houses with good attending schools have good neighborhood and/or resale values. In another example, the system extends the capabilities of property search services. In yet another example, many property search services focus primarily on property search and do not include particularly helpful school relevant search services. In yet another example, existing property search services report only the distance to the nearest schools, but do not account for the actual school district and/or attendance boundaries of the property. In yet another example, it is not straightforward to locate attending schools for a particular property. In yet another example, it is hard to search for home properties within a selected school attendance boundary and/or an overlap of multiple selected school attendance boundaries. In yet another example, it is hard to search for properties with both property search criteria (e.g., location, price, lot size) and school search criteria (e.g., school performance score ranges). In yet another example, it is time-consuming to figure out the answers to the above questions using existing property search services. In yet another example, school boundary information is required to support these enhanced searches and/or services and such information is often poorly managed and digitized by each school district and/or school itself. In yet another example, no single system to integrates digitized school boundary information.

According to some embodiments, the system that identifies school attendance and boundary information integrates digitized school boundary information across multiple school districts. For example, a single-point-of-access system, provides more user-friendly property search services. In another example, the system significantly reduces user search time.

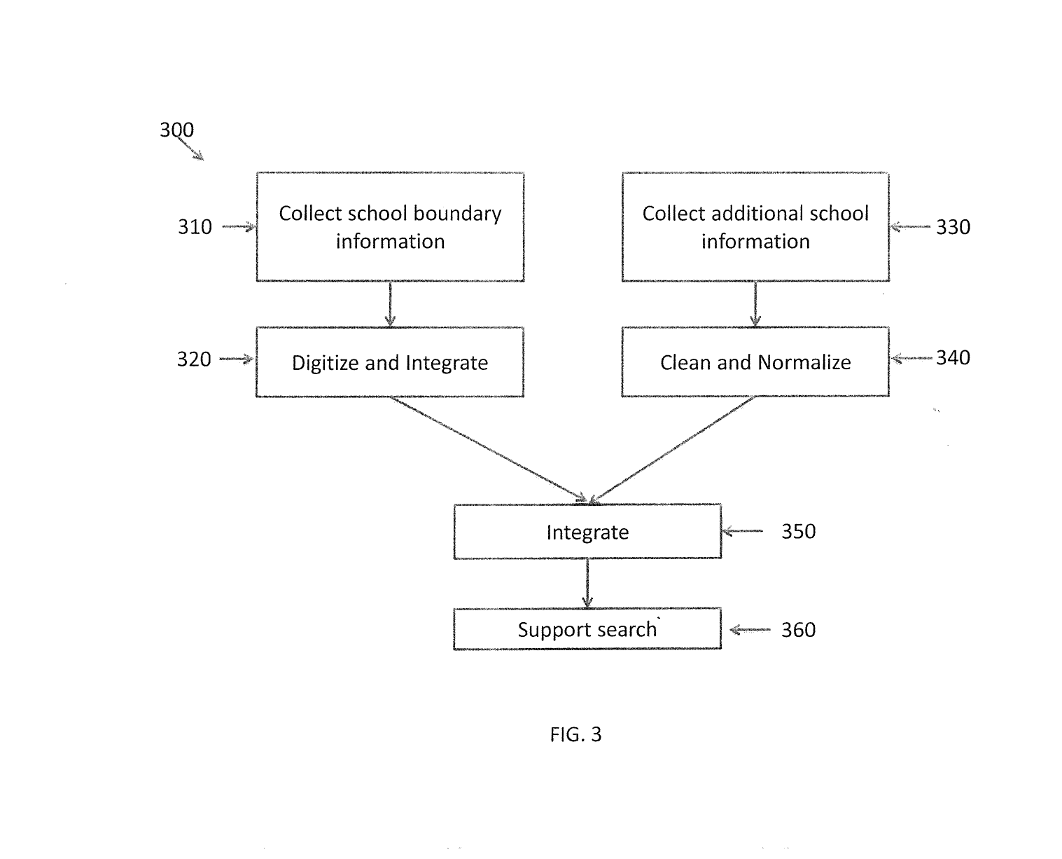

FIG. 3 is a simplified diagram showing a method for collecting and integrating various types of school information according to one embodiment of the present invention. This diagram is merely an example, which should not unduly limit the scope of the claims. One of ordinary skill in the art would recognize many variations, alternatives, and modifications. As shown in FIG. 3, the method 300 includes a process 310 for collecting school boundary information, a process 320 for digitizing and integrating the school boundary information, a process 330 for collecting additional school information, a process 340 for cleaning and normalizing the additional school information, a process 350 for integrating the school boundary information and the additional school information, and a process 360 for supporting searches of the integrated school information. According to certain embodiments, the method 300 is performed using variations among the processes 310-360 as would be recognized by one of ordinary skill in the art. For example, some or all of the processes of the method 300 are performed by one or more computers (e.g., one or more servers) and/or one or more processors directed by software. In another example, some or all of the processes of the method 300 are performed according to instructions included in one or more computer-readable media (e.g., one or more computer-readable media in a computer program product). In yet another example, some or all of the processes of the method 300 are performed automatically.

At the process 310, school boundary information is collected. For example, the school boundary information is provided by a school district. In another example, the school boundary information is provided by a school. In yet another example, the school boundary information is provided by another governmental entity (e.g., a municipality, county, or state). In yet another example, the school boundary information is collected from a web site. In yet another example, the school boundary information is collected using a web service. In yet another example, the school boundary information is collected from a search service. In yet another example, the school boundary information is collected using paper and/or electronic documents.

At the process 320, the school boundary information is digitized and integrated. For example, the collected school boundary information is converted to a common digital format. In another example, the collected school boundary information is digitized using geolocation information (e.g., latitude and longitude). In yet another example, the collected school boundary information is organized into one or more boundaries (e.g., boundary lines) that define the attendance area for one or more schools. In yet another example, the collected school boundary information from one or more schools and/or one or more school districts is integrated into a common data store. In yet another example, the collected school boundary information from one or more schools and/or one or more school districts is integrated into one or more data stores. In yet another example, the common data store and/or each of the one or more data stores are selected from a list consisting of a database, a file, and the like. In yet another example, the common data store and/or each of the one or more data stores are located in any one selected from a list consisting of memory, disk, CD, server, cloud storage, and the like.

At the process 330, additional school information is collected. For example, the additional school information includes a name for each school. In another example, the additional school information includes an address for each school. In yet another example, the additional school information includes the geolocation for each school. In yet another example, the additional school information includes a school district to which each school belongs. In yet another example, the additional school information includes rating information for each school. In yet another example, the additional school information includes student performance data. In yet another example, the additional school information includes information about one or more selected from a group consisting of county, phone number, email address, type, level, grades, Academic Performance Index (API) scores, reviews, number of students, number of classrooms, student-teacher ratio, year of construction, enrollment, diversity, geolocation, and the like. In yet another example, the API scores are a standardized score that measures the academic performance and growth of a school on a variety of academic measures. In yet another example, the API scores vary between 200 and 1000. In yet another example, the additional school information is recorded for one or more time periods. In yet another example, the one or more time periods include calendar years. In yet another example, the one or more time periods include academic years. In yet another example, the additional school information is provided by a school. In yet another example, the additional school information is provided by a school district. In yet another example, the additional school information is provided by another governmental entity (e.g., a municipality, county, or state). In yet another example, the additional school information is provided by a non-governmental entity. In yet another example, the additional school information is collected from a web site. In yet another example, the additional school information is collected using a web service. In yet another example, the additional school information is collected from a search service. In yet another example, the additional school information is collected using paper and/or electronic documents.

At the process 340, the additional school information is cleaned and normalized. For example, different schools use different metrics and/or formats to report the same additional school information. In another example, the different metrics and/or formats are converted into a uniform metric and/or format. In yet another example, the different metrics are converted into one or more comparable metrics. In yet another example, additional school information that is missing is estimated. In yet another example, aggregate metrics are computed.

At the process 350, the school boundary information and the additional school information is integrated. For example, the school boundary information is matched to the corresponding additional school information. In yet another example, the school boundary information and the corresponding additional school information are indexed by an identifier unique to each school. In yet another example, the school boundary information and the additional school information from one or more schools and/or one or more school districts is integrated into a common data store. In yet another example, the school boundary information and the additional school information from one or more schools and/or one or more school districts is integrated into one or more data stores. In yet another example, the common data store and/or each of the one or more data stores are selected from a list consisting of a database, a file, and the like. In yet another example, the common data store and/or each of the one or more data stores are located in any one selected from a list consisting of memory, disk, CD, server, cloud storage, and the like.

At the process 360, the integrated school information is prepared to support searching. For example, the integrated school information is made accessible via a web site. In another example, the integrated school information is made accessible via a search interface. In yet another example, the integrated school information is made accessible via a web service. In yet another example, the integrated school information is integrated with a search engine. In yet another example, the integrated school information is separated by geographical region. In yet another example, relationships among the integrated school information are pre-computed.

As discussed above and further emphasized here, FIG. 3 is merely an example, which should not unduly limit the scope of the claims. One of ordinary skill in the art would recognize many variations, alternatives, and modifications. For example, two or more of the processes 310-360 share one or more common sub processes.

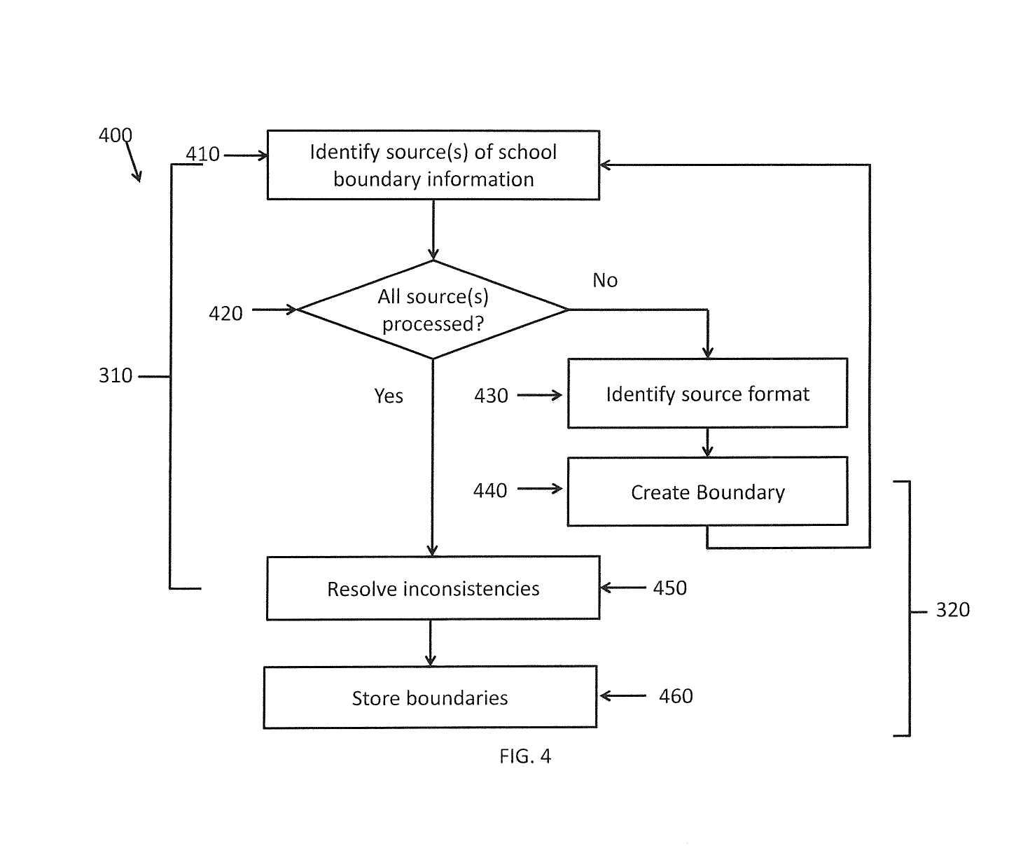

FIG. 4 is a simplified diagram showing a method for generating boundary information for a school district according to one embodiment of the present invention. This diagram is merely an example, which should not unduly limit the scope of the claims. One of ordinary skill in the art would recognize many variations, alternatives, and modifications. As shown in FIG. 4, the method 400 includes a process 410 for identifying one or more sources of school boundary information, a process 420 for determining whether all of the one or more information sources are processed, a process 430 for indentifying the format of an information source, a process 440 for creating school boundaries, a process 450 for resolving inconsistencies between the one or more information sources, and a process 460 for storing the school boundaries. According to certain embodiments, the method 400 is performed using variations among the processes 410-460 as would be recognized by one of ordinary skill in the art. For example, one or more of the processes 410-440 are representative of some of the processes that are used to implement process 310 for collecting school boundary information. In another example, one or more of the processes 440-460 are representative of some of the processes that are used to implement process 320 for digitizing and integrating school boundary information. In yet another example, one or more of the processes 410-460 are representative of some of the processes that are used to implement a combination of the processes 310 and 320. In yet another example, some or all of the processes of the method 400 are performed by one or more computers (e.g., one or more servers) and/or one or more processors directed by software. In yet another example, some or all of the processes of the method 400 are performed according to instructions included in one or more computer-readable media (e.g., one or more computer-readable media in a computer program product). In yet another example, some or all of the processes of the method 400 are performed automatically.

At the process 410, one or more sources of school boundary information are identified. For example, one of the one or more sources of school boundary information is provided by a school district. In another example, one of the one or more sources of school boundary information is provided by a school. In yet another example, one of the one or more sources of school boundary information is provided by another governmental entity (e.g., a municipality, county, or state). In yet another example, one of the one or more sources of school boundary information is a web site. In yet another example, one of the one or more sources of school boundary information is a web service. In yet another example, one of the one or more sources of school boundary information is a search service. In yet another example, one of the one or more sources of school boundary information is one or more paper and/or electronic documents.

At the process 420, a determination is made to see if all of the one or more information sources are processed. For example, use of more than one information source provides redundancy. In another example, use of more than one information source provides greater robustness in a school boundary that is created. In yet another example, each of the one or more information sources is selected for individual processing by the processes 430 and 440. In yet another example, if there is another information source to process, control is transferred to process 430. In yet another example, if there are no other information sources to process, control is transferred to process 450.

At the process 430, the format of an information sources is identified. For example, the information source is one of the one or more information sources. In another example, the information source is formatted using a street attendance directory. In yet another example, the street attendance directory identifies the addresses for each school using a list of streets and one or more address ranges including one or more addresses on each street. In yet another example, the information source is formatted as an online school locator. In yet another example, the online school locator provides an interface that receives a street address. In yet another example, the online school locator generates a list of zero or more attending schools for the street address. In yet another example, the online school locator generates zero attending schools when the street address is not part of the school district. In yet another example, the online school locator generates a list of more than one attending schools in the school district when the school district includes schools with a level selected from a group consisting of elementary, middle, junior high, senior high, high, and the like. In yet another example, the information source is formatted as a boundary map. In yet another example, the boundary map depicts school boundaries using a map that includes streets and other geographic landmarks. In yet another example, the format of the information source is used to develop and select the process used to create the school boundaries from the information source.

At the process 440, the one or more school boundaries are created. For example, the information source is used to identify all of the street addresses that are part of the attendance area for each of the one or more schools in the school district. In another example, the one or more school boundaries include one or more boundary lines. In yet another example, the one or more school boundaries are created using one or more polygons. In yet another example, a boundary for a school is defined using a single polygon. In yet another example, the boundary for a school is defined using multiple polygons. In yet another example, the boundary for a school is contiguous. In yet another example, the boundary for a school is discontiguous. In yet another example, the boundary for a school completely surrounds a boundary for another school. In yet another example, one or more of edges of the boundary for a school align with geographic landmarks. In yet another example, the geographic landmarks include a street. In yet another example, the geographic landmarks include a river and/or a body of water. In yet another example, the geographic landmarks include some other natural isolation feature.

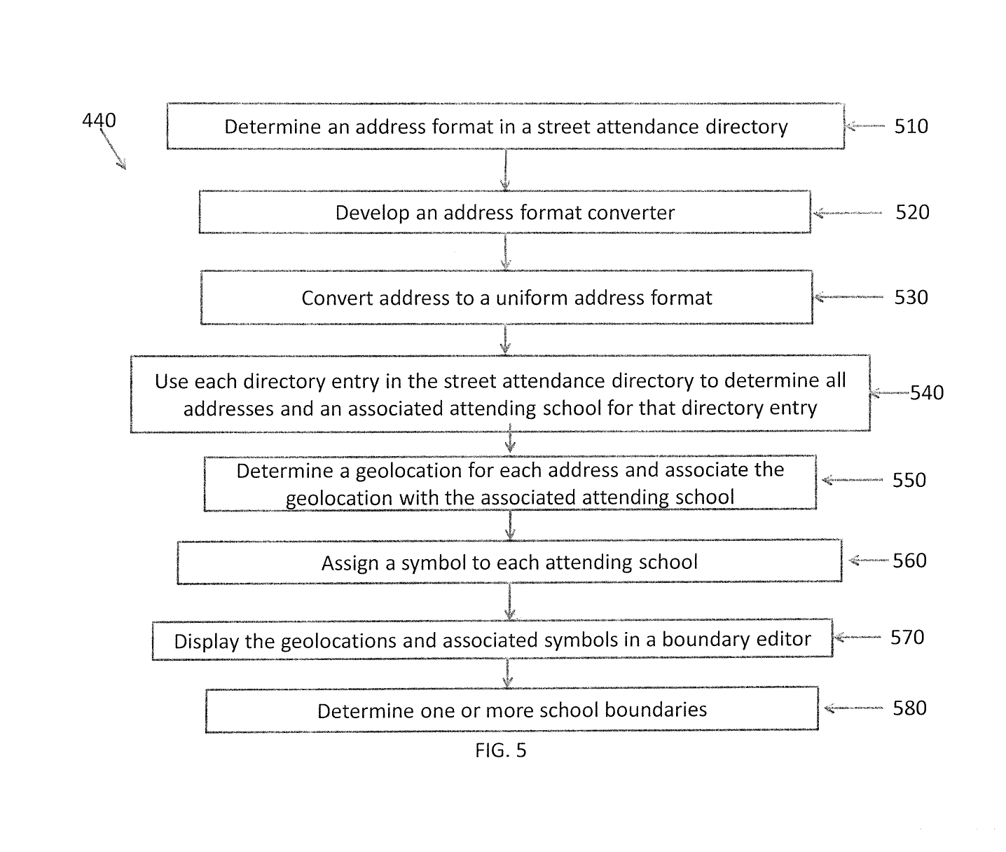

FIG. 5 is a simplified diagram showing the process 440 for creating one or more school boundaries using a street attendance directory information source as part of the method 400 for generating boundary information for a school district according to one embodiment of the present invention. This diagram is merely an example, which should not unduly limit the scope of the claims. One of ordinary skill in the art would recognize many variations, alternatives, and modifications. As shown in FIG. 5, the process 440 includes a process 510 for determining an address format in a street attendance directory, a process 520 for developing an address format converter, a process 530 for converting addresses to a uniform address format, a process 540 for using each address directory entry in the street attendance directory to determine all addresses and an associated attending school for that directory entry, a process 550 for determining a geolocation for each address and associating the geolocation with the associated attending school, a process 560 for assigning a symbol to each attending school, a process 570 for displaying the geolocations and associated symbols in a boundary editor, and a process 580 for determining one or more school boundaries. According to certain embodiments, the process 440 is performed using variations among the processes 510-580 as would be recognized by one of ordinary skill in the art. For example, some or all of the processes of the process 440 are performed by one or more computers (e.g., one or more servers) and/or one or more processors directed by software. In another example, some or all of the processes of the process 440 are performed according to instructions included in one or more computer-readable media (e.g., one or more computer-readable media in a computer program product). In yet another example, some or all of the processes of the process 440 are performed automatically. In some embodiments, the process 520 is omitted.

At the process 510, an address format in the street attendance directory is determined. For example, the street attendance directory includes one or more directory entries (e.g., attending school records) associating a range of addresses with an attending school. In another example, the range of addresses includes a street name, a numerical address range, and a city (e.g., King Street, 123-860, San Jose, Calif.). In yet another example, the range of addresses is limited to one side of the street (e.g., River Dr., 200-800 even only, Cupertino, Calif.). In yet another example, the address range includes different delimiters (e.g., comma, semicolon, etc.), abbreviations (e.g., St., Dr., Ave., etc.), and/or zip codes. In yet another example, each street attendance directory includes differences in formatting and/or notation. In yet another example, the street attendance directory includes associated attending schools that are of different levels (e.g., elementary, middle, junior high, senior high, high, etc.). In yet another example, a range of addresses is associated with multiple attending schools, where each of the multiple attending schools at a different level. In yet another example, the process 510 includes reviewing the one or more directory entries to determine the format.

At the optional process 520, an address format converter is developed. For example, the address format converter is a text parser. In another example, the text parser recognizes the delimiters used in the one or more entries. In yet another example, the address format converter allows for the use of uniform address formats in the process 440 for creating one or more school boundaries using a street attendance directory information source.

At the process 530, addresses are converted to a uniform address format. For example, the address format converter developed in process 520 is used to provide a uniform address format. In another example, another address format converter for another street attendance directory is reused. In yet another example, addresses are converted between the range of addresses format in the street attendance directory into a uniform address format.

At the process 540, each address directory entry in the street attendance directory is used to determine all the addresses and the associated attending school for that directory entry. For example, if River Dr. has addresses 180, 185, 190, 195, 200, 205, and 210 and the directory entry includes “River Dr., 200-800 even only, Cupertino, Calif.: Union Elementary” then addresses 200 and 210 are associated with the attending school Union Elementary. In another example, all of the one or more directory entries are used. In yet another example, all of the addresses in the school district are associated with attending schools as specified in the street attendance directory. In yet another example, upon completion of the process 540, a list of one or more addresses and associated attending schools is determined.

At the process 550, a geolocation is determined for each address and the geolocation is associated with the associated attending school. For example, each address in the list of one or more addresses is converted to a geolocation. In another example, a geocoding service is used to convert each address to geolocation data. In yet another example, the geolocation is associated with the associated attending school found in the list of one or more addresses and associated attending schools.

At the process 560, a symbol is assigned to each attending school. For example, each school in the school district is assigned a unique symbol. In another example, the unique symbol is a graphical shape. In yet another example, the graphical shape is selected from a group consisting of a circle, a square, a triangle, a star, a letter, a number, and the like. In yet another example, each symbol has a different color.

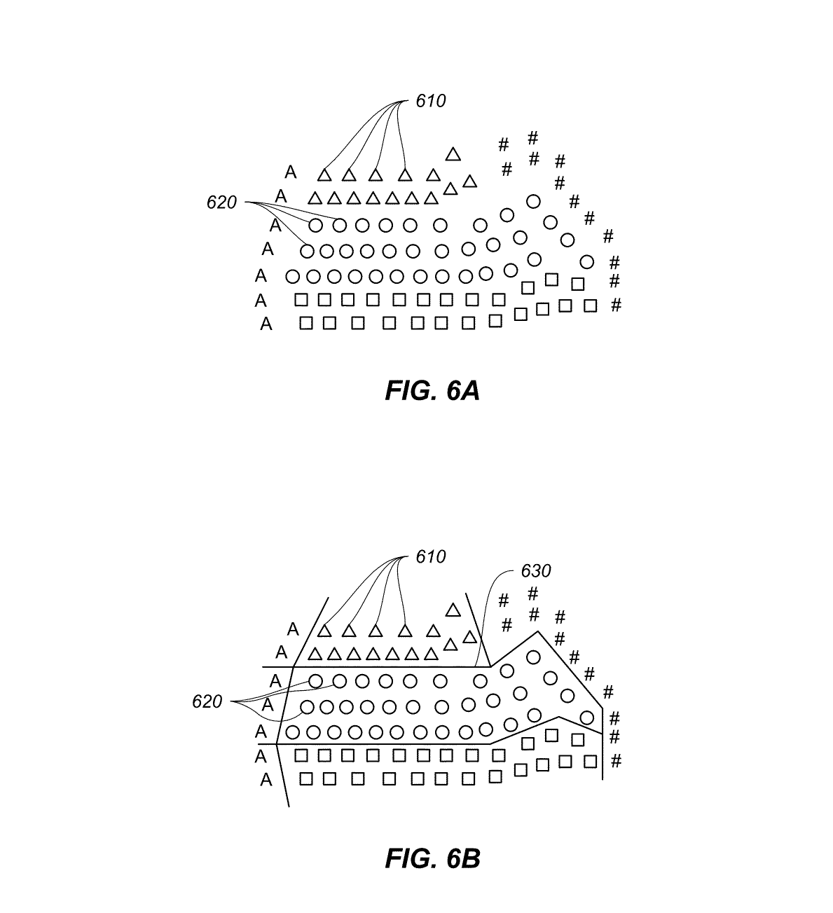

At the process 570, the geolocations and associated shapes are displayed in a boundary editor. FIG. 6A is a simplified diagram showing a collection of geolocations and associated shapes as displayed in a boundary editor as part of the method 400 for generating boundary information for a school district according to one embodiment of the present invention. This diagram is merely an example, which should not unduly limit the scope of the claims. One of ordinary skill in the art would recognize many variations, alternatives, and modifications. As shown in FIG. 6A, each of the geolocations is drawn at a corresponding screen location based on x and y coordinates associated with the geolocation using the associated symbol. For example, each associated symbol corresponds to a different one of the one or more schools in the school district. In another example, triangular symbols 610 are associated with school A. In yet another example, circular symbols 620 are associated with school B. In yet another example, the x and y coordinates are based on the latitude and longitude of each of the geolocations. In yet another example, the associated symbols visually identify all the addresses associated with each of the one or more schools in the school district. In yet another example, only the associated symbols for the subset of the one or more schools that are at a same level are displayed. In yet another example, previously determined school boundaries are also drawn.

At the process, 580, one or more school boundaries are determined. FIG. 6B is a simplified diagram showing a collection of geolocations and associated shapes and corresponding school boundaries as displayed in a boundary editor as part of the method 400 for generating boundary information for a school district according to one embodiment of the present invention. This diagram is merely an example, which should not unduly limit the scope of the claims. One of ordinary skill in the art would recognize many variations, alternatives, and modifications. As shown in FIG. 6B, one or more school boundaries are placed between geolocations with differing symbols. For example, edges are determined between regions with clusters of one symbol and clusters of another symbol. In another example, an edge 630 is shown between clusters of the triangular symbols 610 and clusters of the circular symbols 620. In yet another example, the edge 630 represents part of the boundary of school A. In yet another example, the edge 630 represents part of the boundary of school B. In yet another example, the edge 630 represents part of the boundary between school A and school B.

In yet another example, the one or more school boundaries are created using one or more polygons. In yet another example, a boundary for a school is defined using a single polygon. In yet another example, the boundary for a school is defined using multiple polygons. In yet another example, the boundary for a school is contiguous. In yet another example, the boundary for a school is discontiguous. In yet another example, the boundary for a school completely surrounds a boundary for another school. In yet another example, one or more of edges of the boundary for a school align with geographic landmarks. In yet another example, the geographic landmarks include a street. In yet another example, the geographic landmarks include a river and/or a body of water. In yet another example, the geographic landmarks include some other natural isolation feature. In yet another example, other boundary representations are used for the one or more school boundaries. In yet another example, edges from previously determined school boundaries are included in the one or more boundaries determined during process 570.

According to certain embodiments, the boundary editor includes one or more drawing tools. For example, the boundary editor includes one or more tools for adding vertices, moving vertices, and/or deleting vertices. In another example, the boundary editor includes one or more tools for connecting one or more vertices to form edges and/or complete boundaries. In yet another example, the boundary editor includes one or more tools for reusing previously determined boundaries. In yet another example, the boundary editor includes one or more tools for converting points on the screen to corresponding geolocations. In yet another example, the boundary editor includes one or more tools for locating vertices using geolocations. In yet another example, the boundary editor includes one or more tools for overlaying a street map and/or a municipal boundary map over geolocations and associated symbols. In yet another example, the boundary editor includes one or more tools for zooming into and/or out of different portions of the display area.

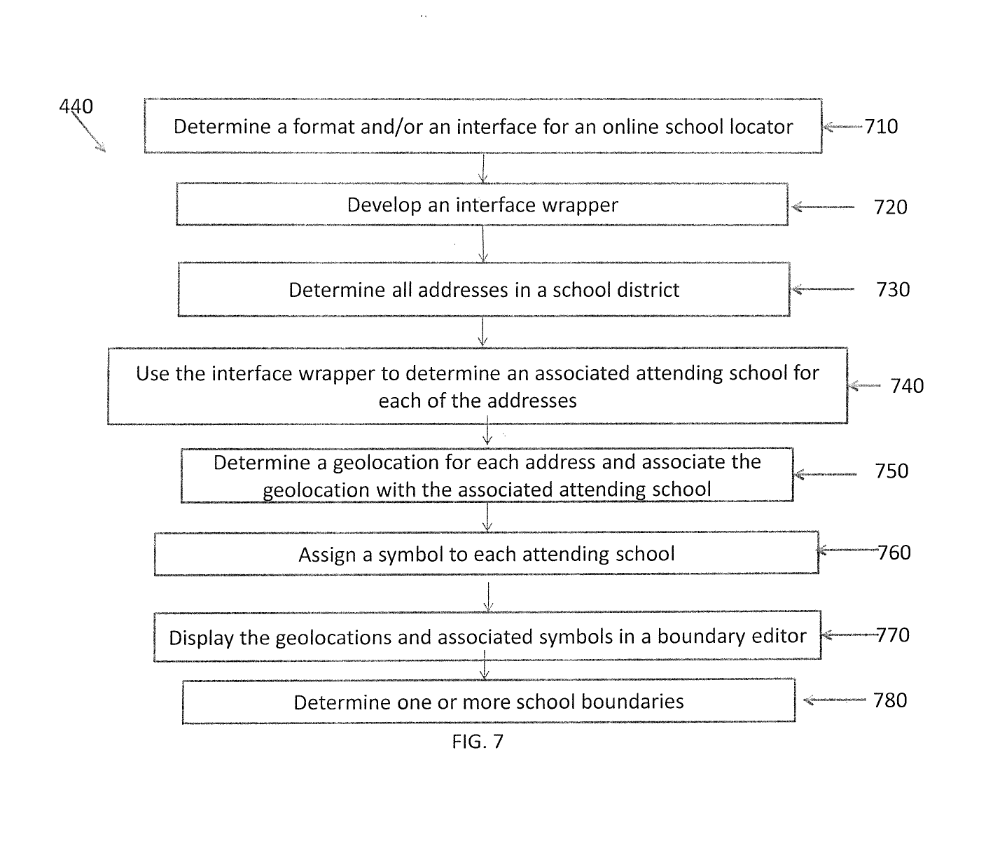

FIG. 7 is a simplified diagram showing the process 440 for creating one or more school boundaries using an online school locator information source as part of the method 400 for generating boundary information for a school district according to another embodiment of the present invention. This diagram is merely an example, which should not unduly limit the scope of the claims. One of ordinary skill in the art would recognize many variations, alternatives, and modifications. As shown in FIG. 7, the process 440 includes a process 710 for determining a format and/or an interface for an online school locator, a process 720 for developing an interface wrapper, a process 730 for determining all addresses in a school district, a process 740 for using the interface wrapper to determine an associated attending school for each of the addresses, a process 750 for determining a geolocation for each address and associating the geolocation with the associated attending school, a process 760 for assigning a symbol to each attending school, a process 770 for displaying the geolocations and associated symbols in a boundary editor, and a process 780 for determining one or more school boundaries. According to certain embodiments, the process 440 is performed using variations among the processes 710-780 as would be recognized by one of ordinary skill in the art. For example, some or all of the processes of the process 440 are performed by one or more computers (e.g., one or more servers) and/or one or more processors directed by software. In another example, some or all of the processes of the process 440 are performed according to instructions included in one or more computer-readable media (e.g., one or more computer-readable media in a computer program product). In yet another example, some or all of the processes of the process 440 are performed automatically. In some embodiments, the process 720 is omitted.

At the process 710, a format and/or an interface for an online school locator is determined. For example, the online school locator is a web site. In another example, the online school locator is a web service. In yet another example, the online school locator provides an interface that receives a street address. In yet another example, the online school locator generates a list of zero or more attending schools for the street address. In yet another example, the online school locator generates zero attending schools when the street address is not part of the school district. In yet another example, the online school locator generates a list of more than one attending schools in the school district when the school district includes schools selected from a level selected from a group consisting of elementary, middle, junior high, senior high, high, and the like.

According to certain embodiments, the online school locator has a format and an interface. For example, the online school locator is a form-driven web page. In another example, each of the fields in the form driven web page includes an identifier. In yet another example, different web pages will use different identifiers for fields that represent the same information. In yet another example, the form-driven web page generates HTML output that includes substantive information and formatting directives. In yet another example, the online school locator is a web service. In yet another example, the web service includes procedure names, parameters, and parameter types. In yet another example, different web services use different procedure names, parameters, and/or parameter types to implement the same or similar web service. In yet another example, the process 710 includes viewing the HTML source of web pages and/or the interface of web services to determine the format and interface for the corresponding online school locator. In yet another example, the process 710 includes determining how to map an address into an HTML request and/or a web service call. In yet another example, the process 710 includes determining how to extract an attending school from an HTML response and/or a web service response.

At the optional process 720, an interface wrapper is developed. For example, the interface wrapper includes software that browses web pages and/or web sites. In another example, the interface wrapper generates HTML requests. In yet another example, the interface wrapper receives HTML responses. In yet another example, the interface wrapper parses the HTML responses. In yet another example, the interface wrapper performs screen scraping. In yet another example, the interface wrapper, performs bulk data downloading. In yet another example, the interface wrapper generates web services calls. In yet another example, the interface wrapper receives web services responses. In yet another example, the interface wrapper parses the web services responses. According to certain embodiments, the interface wrapper is a software component. For example, the software component is customized for each web page, web site, and/or web service. In another example, the software component is semi-customized for each web page, web site, and/or web service. In yet another example, the process 720 includes writing and/or testing the software component.

At the process 730, all addresses in the school district are determined. For example, the addresses are determined using the online school locator in coordination with the interface wrapper. In another example, the addresses are determined using a database. In yet another example, the database is provided by the United States census. In yet another example, only those addresses near a school district boundary are determined.

At the process 740, the interface wrapper is used to determine an associated attending school for each of the addresses. For example, each of the addresses is passed to the interface wrapper. In another example, the interface wrapper prepares a HTML request and/or a web service call using each of the addresses. In yet another example, the interface wrapper makes the HTML request and/or the web service call to the online school locator. In yet another example, the interface wrapper receives the response. In yet another example, the interface wrapper parses the response to determine the attending school associated with each of the addresses. In yet another example, upon completion of the process 740, a list of one or more addresses and associated attending schools is determined. In some embodiments, a previously developed interface wrapper is reused.

At the process 750, a geolocation is determined for each address and the geolocation is associated with the associated attending school. For example, each address in the list of one or more addresses is converted to a geolocation. In another example, a geocoding service is used to convert each address to geolocation data. In yet another example, the geolocation is associated with the associated attending school found in the list of one or more addresses and associated attending schools.

At the process 760, a symbol is assigned to each attending school. For example, each school in the school district is assigned a unique symbol. In another example, the unique symbol is a graphical shape. In yet another example, the graphical shape is selected from a group consisting of a circle, a square, a triangle, a star, a letter, a number, and the like. In yet another example, each symbol has a different color.

At the process 770, the geolocations and associated shapes are displayed in a boundary editor. For example, the boundary editor used in process 570 of FIG. 5 is suitable for the process 770. In another example, the process 770 displays a figure similar to FIG. 6A.

At the process, 780, one or more school boundaries are determined. For example, the boundary determination process 580 of FIG. 5 is suitable for the process 780. In another example, the process 780 determines one or more school boundaries as shown in FIG. 6B. In yet another example, the boundary editor described in the processes 570 and 580 is used for the process 780.

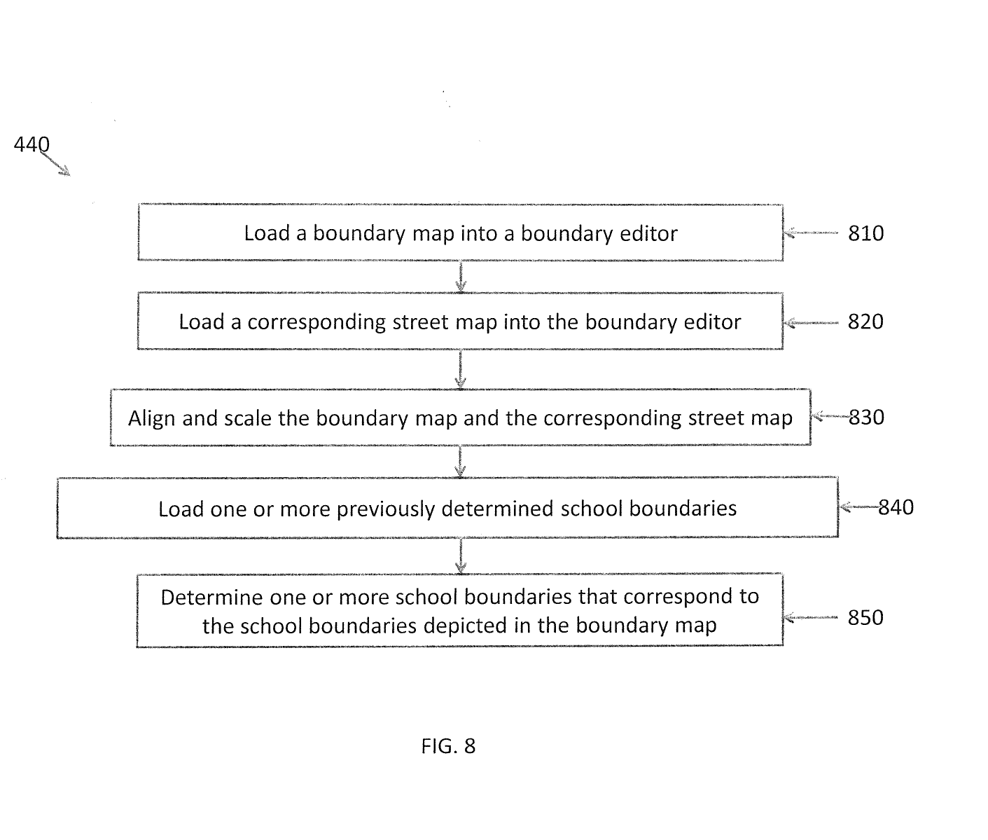

FIG. 8 is a simplified diagram showing the process 440 for creating one or more school boundaries using a boundary map information source as part of the method 400 for generating boundary information for a school district according to yet another embodiment of the present invention. This diagram is merely an example, which should not unduly limit the scope of the claims. One of ordinary skill in the art would recognize many variations, alternatives, and modifications. As shown in FIG. 8, the process 440 includes a process 810 for loading a boundary map into a boundary editor, a process 820 for loading a corresponding street map into the boundary editor, a process 830 for aligning and scaling the boundary map and the corresponding street map, a process 840 for loading one or more previously determined school boundaries, and a process 850 for determining one or more school boundaries that correspond to the school boundaries depicted in the boundary map. According to certain embodiments, the process 440 is performed using variations among the processes 810-850 as would be recognized by one of ordinary skill in the art. For example, some or all of the processes of the process 440 are performed by one or more computers (e.g., one or more servers) and/or one or more processors directed by software. In another example, some or all of the processes of the process 440 are performed according to instructions included in one or more computer-readable media (e.g., one or more computer-readable media in a computer program product). In yet another example, some or all of the processes of the process 440 are performed automatically. In some embodiments, the process 840 is omitted.

At the process 810, a boundary map is loaded into a boundary editor. For example, the boundary map is an electronic document that depicts the boundaries for one or more schools in a geographic area. In another example, the boundary map is a school boundary information source provided by a school district. In yet another example, the boundary map depicts school boundaries using a map that includes streets and other geographic landmarks. In yet another example, the boundary editor is the boundary editor used in processes 570 and 580 as shown in FIG. 5 and/or the processes 770 and/or 780 as shown in FIG. 7.

At the process 820, a corresponding street map is loaded into the boundary editor. For example, the corresponding street map covers the same geographical area as the boundary map. In another example, the corresponding street map is displayed at the same size as the boundary map. In yet another example, the corresponding street map is loaded from a map database. In yet another example, the corresponding street map is loaded from a web page and/or a web service.

At the process 830, the boundary map and the corresponding street map are aligned and scaled. For example, the boundary map and the corresponding street map are aligned so that the geolocation of the upper left corner of the boundary map and the geolocation of the upper left corner of the corresponding street map are the same. In another example, the boundary map and the corresponding street map are scaled so that the boundary map and the corresponding street map display the same geographical area at the same relative scale. In yet another example, the boundary map and/or the corresponding street map are translated and/or scaled.

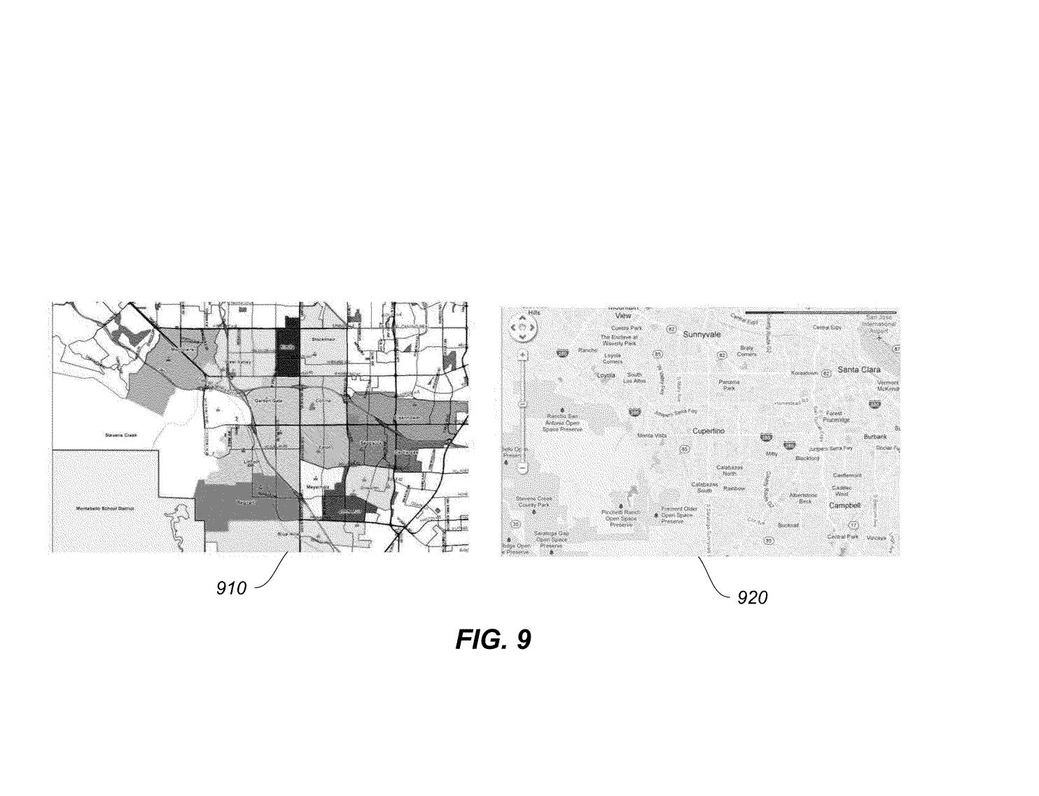

In yet another example, the boundary map and the corresponding street map are displayed together. FIG. 9 is a simplified diagram showing the display of the boundary editor with both a boundary map and a corresponding street map displayed as part of the method 400 for generating boundary information for a school district according to one embodiment of the present invention. This diagram is merely an example, which should not unduly limit the scope of the claims. One of ordinary skill in the art would recognize many variations, alternatives, and modifications. As shown in FIG. 9, a boundary map 910 is depicted side-by-side with a corresponding street map 920. For example, the relative size and scale of the boundary map 910 and the corresponding street map 920 are selected so that both depict the same geographical area at the same relative size.

As discussed above and further emphasized here, FIG. 9 is merely an example, which should not unduly limit the scope of the claims. One of ordinary skill in the art would recognize many variations, alternatives, and modifications. For example, the boundary map 910 and the corresponding street map 920 are overlaid so that the corresponding street map 920 is displayed over the boundary map 910. In another example, the boundary editor displays two cursors that track the same geolocation in both the boundary map 910 and the corresponding street map 920. In yet another example, the positions of the boundary map 910 and the corresponding street map 920 is switched. In yet another example, the boundary map 910 and the corresponding street map 910 are displayed vertically with one above the other.

Referring to FIG. 8, at the optional process 840, one or more previously determined school boundaries are loaded. For example, one or more previously determined school boundaries that correspond to previously processed schools and/or school districts are loaded into the boundary editor. In another example, the one or more previously determined school boundaries are reused. In yet another example, the one or more previously determined school boundaries ensure consistency in the school boundaries between schools in adjacent school districts. In yet another example, the one or more previously determined school boundaries decrease the amount of time needed to determine one or more school boundaries in subsequent processes. In yet another example, if one or more previously determined school boundaries are not available, then process 840 is omitted.

At the process 850, one or more school boundaries are determined that correspond to the school boundaries depicted in the boundary map. For example, the boundary editor is used to select geolocation points that correspond to the one or more school boundaries depicted on the boundary map. In another example, one or more vertices for the one or more school boundaries are selected using the boundary editor. In yet another example, the one or more vertices are associated with the corresponding attending school. In yet another example, the boundary editor includes one or more tools that allow the boundary map and the corresponding street map to be transformed similarly. In yet another example, if a portion of the boundary map is zoomed into and/or zoomed out of, the corresponding street map zooms similarly. In yet another example, if a portion of the corresponding street map is zoomed into and/or zoomed out of, the boundary map zooms similarly.

Referring back to FIG. 4, at the process 450, inconsistencies between the one or more information sources are resolved. For example, an inconsistency occurs when a street address is classified to the attendance area of two schools of a same level. In another example, an inconsistency occurs when a street attendance directory information source indicates that a street address is within the boundary for elementary school A and an online school locator information source indicates that the street address is within the boundary for elementary school B. In yet another example, inconsistencies occur when a boundary determined from an information source differs from another boundary determined from another information source. In yet another example, if the difference between the boundary and the another boundary is below a threshold, then the inconsistency is ignored. In yet another example, the threshold is based on a size of a typical residential real estate parcel. In yet another example, the threshold is less than 50 square feet. In yet another example, the difference between the boundary and the another boundary are evaluated on a local basis. In yet another example, the difference between the boundary and the another boundary include one or more regions where the boundary and the another boundary are different. In yet another example, each of the one or more regions is separately compared to the threshold. In yet another example, if the boundary and the another boundary classify all the street addresses in the school district the same way, then the inconsistency is ignored. According to some embodiments, if an inconsistency is not ignored it is resolved using a priority criteria among the information sources. For example, a street attendance directory information source is more reliable than an online school locator information source and a boundary determined from the street attendance directory information source is selected. In another example, an online school locator information source is more reliable than a boundary map information source and a boundary determined from the online school locator information source is selected. In yet another example, other priorities among the information source types are used. In yet another example, an additional school information source is identified to resolve the inconsistencies. In yet another example, the additional school information source is an office of the school district. In certain embodiments, the process 450 determines a single boundary for each of the one or more schools in the school district.

At the process 460, the one or more school boundaries are stored. For example, each of the one or more school boundaries are associated with a unique identifier that is associated with the corresponding one of the one or more schools. In another example, the unique identifier is stored with the corresponding one of the one or more school boundaries. In yet another example, the one or more school boundaries are indexed by their corresponding unique identifier. In yet another example, the one or more school boundaries are stored in a common data store. In yet another example, the one or more school boundaries are stored in one or more data stores. In yet another example, the common data store and/or each of the one or more data stores are located in any one selected from a list consisting of memory, disk, CD, server, cloud storage, and the like.

According to certain embodiments, the one or more school boundaries are stored using boundary representations. For example, the boundary representations are polygons. In another example, the polygons are stored using one or more ordered lists of vertices. In yet another example, the vertices are represented using geolocation data. In yet another example, other boundary representations are used. In yet another example, a bounding rectangle for each of the one or more school boundaries is determined. In yet another example, the bounding rectangle identifies a minimum and a maximum east-west range of the corresponding school boundary and a minimum and a maximum north-south range of the corresponding school boundary. In yet another example, the bounding rectangle is also stored.

As discussed above and further emphasized here, FIG. 4 is merely an example, which should not unduly limit the scope of the claims. One of ordinary skill in the art would recognize many variations, alternatives, and modifications. In some embodiments, the method 400 is adapted to process only the boundary for a single school. For example, at the process 440, the boundary for only a single school is created. According to certain embodiments, the method 400 is adapted for use in a larger area. For example, the method 400 is applied to a plurality of school districts in the larger area. In another example, the larger area is a metropolitan area. In yet another example, the larger area is a county. In yet another example, the larger area is a state. In yet another example, the larger area is a country.

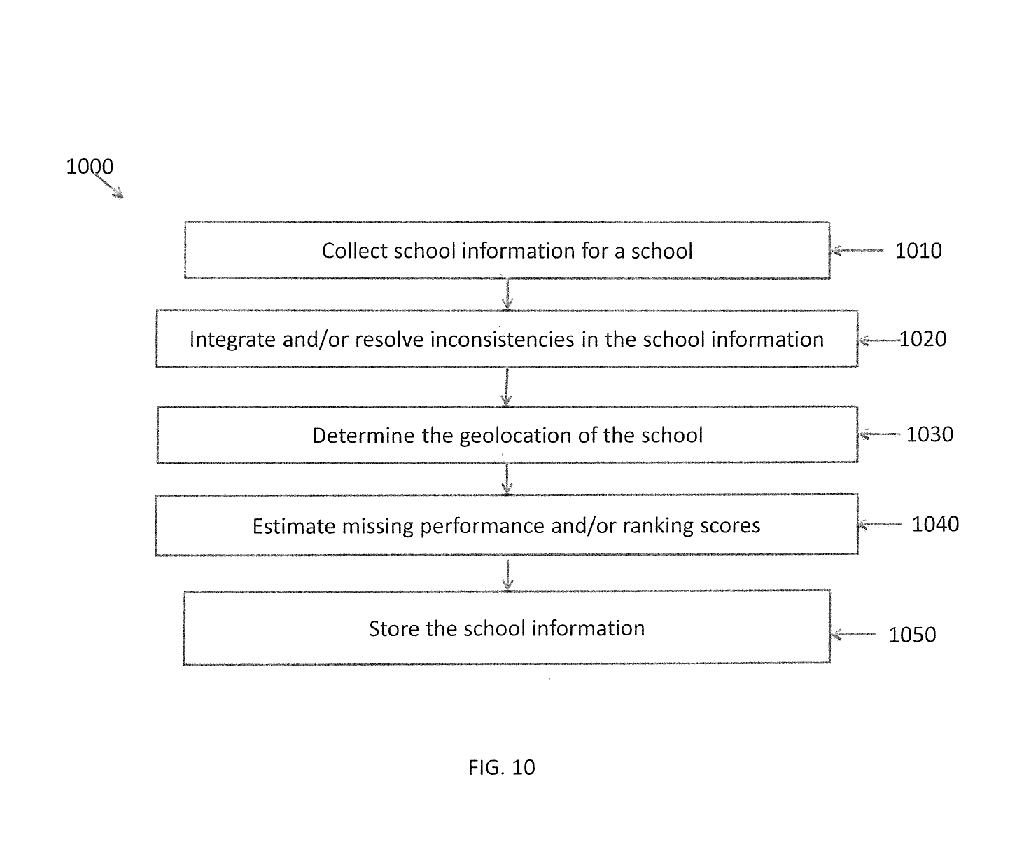

FIG. 10 is a simplified diagram showing a method for collecting, cleaning, and normalizing school information according to one embodiment of the present invention. This diagram is merely an example, which should not unduly limit the scope of the claims. One of ordinary skill in the art would recognize many variations, alternatives, and modifications. As shown in FIG. 10, the method 1000 includes a process 1010 for collecting school information for a school, a process 1020 for integrating and/or resolving inconsistencies in the school information, a process 1030 for determining the geolocation of the school, a process 1040 for estimate missing performance and/or ranking scores, and a process 1050 for storing the school information. According to certain embodiments, the method 1000 is performed using variations among the processes 1010-1050 as would be recognized by one of ordinary skill in the art. For example, the process 1010 is representative of some of the processes that are used to implement process 330 for collecting school information. In another example, one or more of the processes 1020-1050 are representative of some of the processes that are used to implement process 340 for cleaning and normalizing school information. In yet another example, one or more of the processes 1010-1050 are representative of some of the processes that are used to implement a combination of the processes 330 and 340. In yet another example, some or all of the processes of the method 1000 are performed by one or more computers (e.g., one or more servers) and/or one or more processors directed by software. In yet another example, some or all of the processes of the method 1000 are performed according to instructions included in one or more computer-readable media (e.g., one or more computer-readable media in a computer program product). In yet another example, some or all of the processes of the method 1000 are performed automatically. In some embodiments, the process 1040 is omitted.

At the process 1010, school information for a school is collected. For example, the school information includes a name for the school. In another example, the school information includes an address for the school. In yet another example, the school information includes a school district to which the school belongs. In yet another example, the school information includes rating information for the school. In yet another example, the additional school information includes student performance data. In yet another example, the school information includes information about one or more selected from a group consisting of county, phone number, email address, type, level, grades, Academic Performance Index (API) scores, reviews, number of students, number of classrooms, student-teacher ratio, year of construction, enrollment, diversity, geolocation, and the like. In yet another example, the API scores are a standardized score that measures the academic performance and growth of a school on a variety of academic measures. In yet another example, the API scores vary between 200 and 1000. In yet another example, the school information is recorded for one or more time periods. In yet another example, the one or more time periods include calendar years. In yet another example, the one or more time periods include academic years. In yet another example, the school information is provided by a school. In yet another example, the school information is provided by a school district. In yet another example, the school information is provided by another governmental entity (e.g., a municipality, county, or state). In yet another example, the school information is provided by a non-governmental entity. In yet another example, the school information is collected from a web site. In yet another example, the school information is collected using a web service. In yet another example, the school information is collected from a search service. In yet another example, the school information is collected using paper and/or electronic documents.

According to some embodiments, the process 1010 includes developing an interface wrapper. For example, the interface wrapper includes software that browses web pages and/or web sites. In another example, the interface wrapper generates HTML requests. In yet another example, the interface wrapper receives HTML responses. In yet another example, the interface wrapper parses the HTML responses. In yet another example, the interface wrapper performs screen scraping. In yet another example, the interface wrapper, performs bulk data downloading. In yet another example, the interface wrapper generates web services calls. In yet another example, the interface wrapper receives web services responses. In yet another example, the interface wrapper parses the web services responses. According to certain embodiments, the interface wrapper is a software component. For example, the software component is customized for each web page, web site, and/or web service. In another example, the software component is semi-customized for each web page, web site, and/or web service. In yet another example, the process 1010 includes writing and/or testing the software component.

In certain embodiments, the process 1010 includes using the interface wrapper to determine the school information. For example, the web sites and/or web services with school information associated with the school are visited using the interface wrapper. In another example, the interface wrapper prepares a HTML request and/or a web service call for each web site and/or web service with school information associated with the school. In yet another example, the interface wrapper makes the HTML request and/or the web service call to each web site and/or web service with school information associated with the school. In yet another example, the interface wrapper receives a response. In yet another example, the interface wrapper parses the response to determine the school information. In some embodiments, a previously developed interface wrapper is reused.

At the process 1020, the school information is integrated and/or inconsistencies are resolved. For example, different schools use different metrics and/or formats to report the same school information. In another example, the different metrics and/or formats are converted into a uniform metric and/or format. In yet another example, an identifier is associated with the school. In yet another example, the identifier is a county-district-school (CDS) code. In yet another example, the identifier is identified in a third-party database. In yet another example, the third-party includes the National Center for Education Statistics (NCES). In yet another example, the school information is indexed by the identifier. In yet another example, the use of the identifier helps integrate the school information.

In some embodiments, inconsistencies exist between school information provided by different sources of the school information. For example, the process 1020 includes resolving the inconsistencies. In another example, some sources of school information are considered more reliable than others. In yet another example, school information received from a school district is more reliable than school information from a school. In yet another example, school information received from a school is more reliable than school information from a municipality and/or a state. In yet another example, school information received from other third-party sources (e.g., ratings websites) are considered least reliable. In yet another example, other priorities among the school information sources is used. In yet another example, a further school information source is identified to resolve the inconsistencies. In yet another example, the further school information source is an office of the school district.

At the process 1030, a geolocation is determined for the school. For example, the address of the school is converted to a geolocation. In another example, a geocoding service is used to convert the address of the school to geolocation data. In yet another example, the geolocation is associated with the school.

At the optional process 1040, missing performance and/or ranking scores are estimated. For example, a performance and/or a ranking score is missing because it is not available for a time period. In another example, the performance and/or the ranking score is missing because it is not found for a time period. In yet another example, the performance and/or the raking score for a time period is missing because it is not found from the school information sources. In yet another example, the performance and/or ranking score for the current time period is not yet available. In yet another example, a missing performance and/or ranking score reduces the usefulness of the school information.

According to some embodiments, a missing performance and/or ranking score is estimated. For example, performance and/or ranking scores from other time periods are used to estimate the missing performance and/or ranking score. In another example, performance and/or ranking scores from the previous n time periods are used to estimate the missing performance and/or ranking score. In yet another example, n is an integer. In yet another example, n varies from 1 to 5 or more. In yet another example, Equation 1 is used to estimate the missing performance and/or ranking score.

$$estimated missing score == \frac{{\sum }_{i = 1}^{i = n} {c}_{i} {S}_{i}}{{\sum }_{i = 1}^{i = n} {c}_{i}} \qquad ( Equation 1 )$$

where the estimated missing score is a performance and/or ranking score,
Sᵢ=score for time period i, and
cᵢ=weighting coefficient for time period i; 0≦cᵢ≦1.

In yet another example, an interpolation and/or an extrapolation function is used to estimate the missing performance and/or ranking score. In yet another example, the weighting coefficients cᵢ are weighted to place greater emphasis on more recent time periods with the weighting coefficient cᵢ≦cⱼ when time period i is earlier than time period j.

At the process 1050, the school information is stored. For example, the school information is associated with the unique identifier for the school. In another example, the unique identifier is stored with the associated school information. In yet another example, the school information is indexed by their corresponding unique identifier. In yet another example, the school information is stored in a common data store. In yet another example, the school information is stored in one or more data stores. In yet another example, the common data store and/or each of the one or more data stores are located in any one selected from a list consisting of memory, disk, CD, server, cloud storage, and the like.

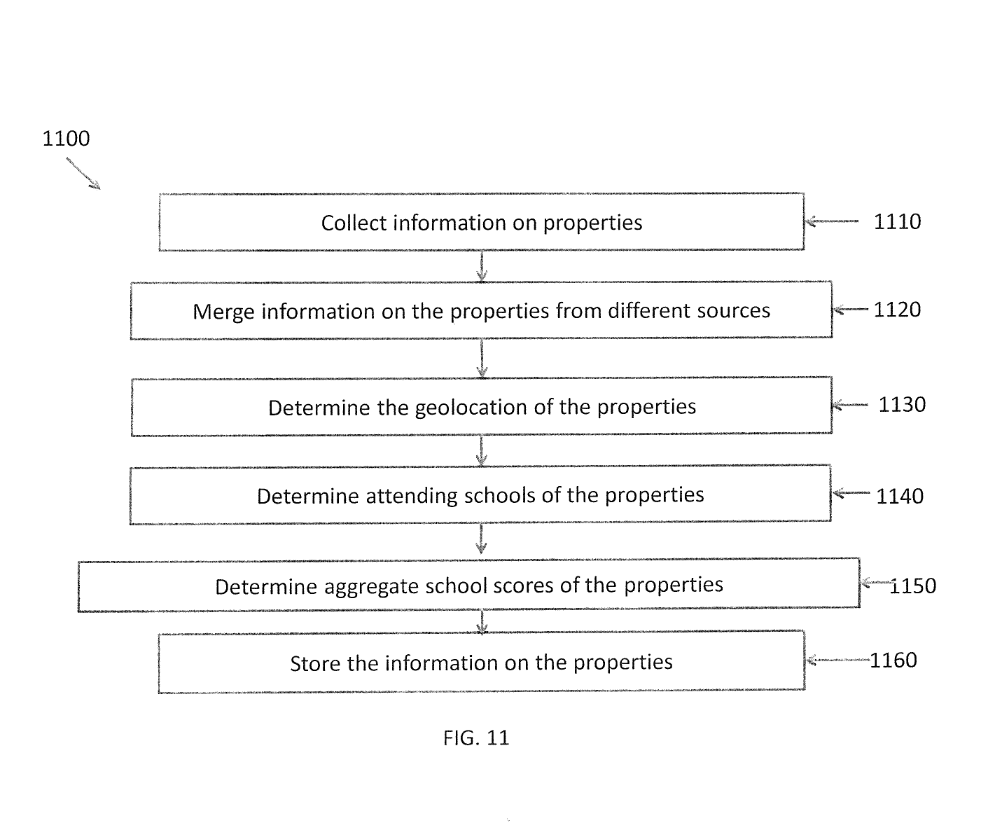

FIG. 11 is a simplified diagram showing a method for collecting and storing property information according to one embodiment of the present invention. This diagram is merely an example, which should not unduly limit the scope of the claims. One of ordinary skill in the art would recognize many variations, alternatives, and modifications. As shown in FIG. 11, the method 1100 includes a process 1110 for collecting information on properties, a process 1120 for merging information on the properties from difference sources, a process 1130 for determining the geolocation of the properties, a process 1140 for determining the attending schools of the properties, a process 1150 for determining aggregate school scores for the properties, and a process 1160 for storing the information on the properties. According to certain embodiments, the method 1100 is performed using variations among the processes 1110-1160 as would be recognized by one of ordinary skill in the art. For example, some or all of the processes of the method 1100 are performed by one or more computers (e.g., one or more servers) and/or one or more processors directed by software. In another example, some or all of the processes of the method 1100 are performed according to instructions included in one or more computer-readable media (e.g., one or more computer-readable media in a computer program product). In yet another example, some or all of the processes of the method 1100 are performed automatically. In some embodiments, one or more of the processes 1120 and 1150 are omitted.

At the process 1110, information on properties is collected. For example, information on the properties is collected from real estate data sources. In another example, information on the properties is collected from property listing services. In yet another example, information on the properties is collected from real estate agencies. In yet another example, information on the properties is collected from web sites. In yet another example, information on properties is collected from web services. In yet another example, information on the properties is collected from downloaded property files. In yet another example, information on the properties is collected from paper and/or electronic documents. In yet another example, information on the properties is collected from a single source. In yet another example, information on the properties is collected from a plurality of sources. In yet another example, an interface wrapper is used to collect the information on the properties.

According to certain embodiments, the process 1110 includes generating a list of properties. For example, the list of properties includes the collected information on the properties. In another example, the collected information includes an address for each of the properties. In yet another example, the address includes a street number, a street name, a city, a county, a state, and/or a zip code. In yet another example, the collected information includes a property identification number. In yet another example, the property identification number is a parcel identification number. In yet another example, the parcel identification number is a unique identification number for indentifying properties in a municipality, a county, and/or a state. In yet another example, the collected information further includes descriptors for each of the properties. In yet another example, the descriptors include one or more selected from a group consisting of lot size, square footage, number of rooms, number of bedrooms, number of bathrooms, date of construction, assessed value, date of last sale, date of listing, listing price, and the like.

In some embodiments, the process 1110 includes an optional process for developing the interface wrapper. For example, the interface wrapper includes software that browses web pages and/or web sites. In another example, the interface wrapper generates HTML requests. In yet another example, the interface wrapper receives HTML responses. In yet another example, the interface wrapper parses the HTML responses. In yet another example, the interface wrapper performs screen scraping. In yet another example, the interface wrapper, performs bulk data downloading. In yet another example, the interface wrapper generates web services calls. In yet another example, the interface wrapper receives web services responses. In yet another example, the interface wrapper parses the web services responses. According to certain embodiments, the interface wrapper is a software component. For example, the software component is customized for each web page, web site, and/or web service. In another example, the software component is semi-customized for each web page, web site, and/or web service. In yet another example, the process for developing an interface wrapper includes writing and/or testing the software component.

At the optional process 1120, information on the properties from different sources is merged. For example, if information on the properties is collected from a plurality of sources, the results are merged. In another example, a union of the collected information is performed. In yet another example, information collected from the plurality of sources is processed to remove duplicate properties. For example, more than one source from the plurality of sources may include information on the same property. In another example, removing duplicate properties reduces memory requirements and/or storage space. In yet another example, removing duplicate properties reduces computational time in future processing steps.

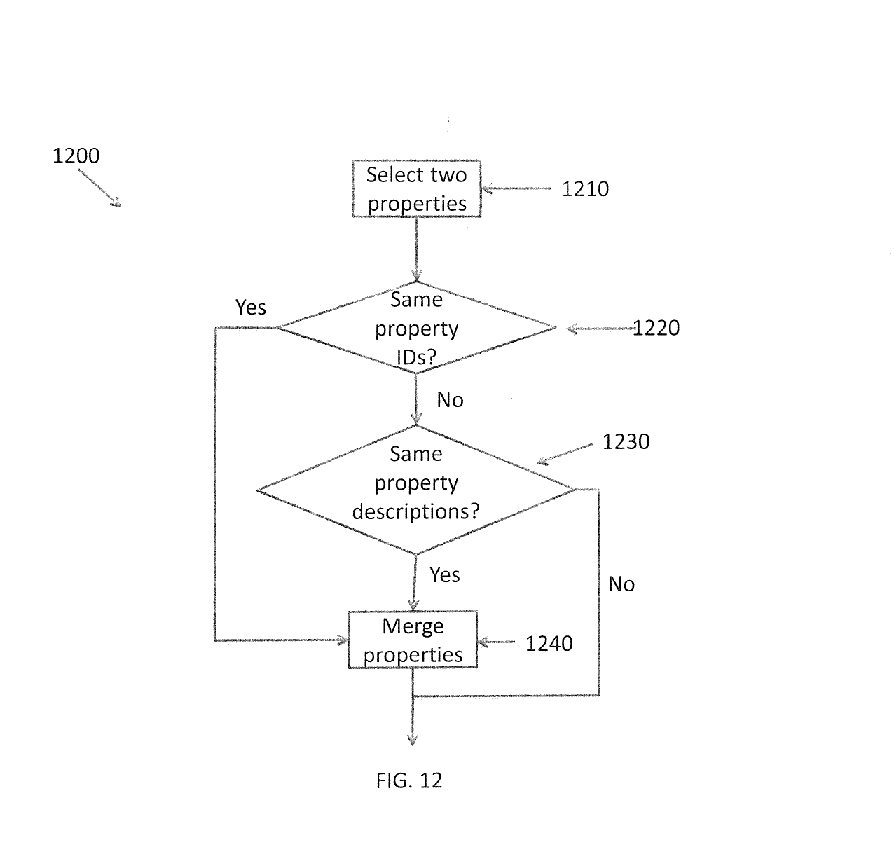

FIG. 12 is a simplified diagram showing a process for merging identical properties as part of a method 1100 for collecting and storing property information according to one embodiment of the present invention. This diagram is merely an example, which should not unduly limit the scope of the claims. One of ordinary skill in the art would recognize many variations, alternatives, and modifications. As shown in FIG. 12, the process 1200 includes a process 1210 for selecting information on two properties, a process 1220 for comparing the property IDs, a process 1230 for comparing other property descriptors and, a process 1240 for merging the two properties. According to certain embodiments, the process 1200 is performed using variations among the processes 1210-1240 as would be recognized by one of ordinary skill in the art. For example, the process 1120 includes the process 1200. In another example, the process 1120 uses the process 1200 multiple times. In yet another example, the process 1120 systematically uses the process 1200 to compare pairs of two properties from the plurality of sources. In yet another example, the process 1120 uses the process 1200 to compare all pairs of two properties whose information is collected from the plurality of sources. In yet another example, some or all of the processes of the process 1200 are performed by one or more computers (e.g., one or more servers) and/or one or more processors directed by software. In yet another example, some or all of the processes of the process 1200 are performed according to instructions included in one or more computer-readable media (e.g., one or more computer-readable media in a computer program product). In yet another example, some or all of the processes of the process 1200 are performed automatically.

At the process 1210, information on two properties is selected. For example, information on two properties collected from different sources among the plurality of sources are selected. In another example, information on two properties collected from the same source are selected.

At the process 1220, the property IDs (e.g., identifiers) are compared. For example, the property ID associated with one of the two properties is compared to the property ID associated with the other of the two properties. In another example, if the property IDs are the same, process 1240 is performed next. In yet another example, if the property IDs are different, process 1230 is performed next. In yet another example, the property ID is a parcel identification number for each of the two properties. In yet another example, the property ID is a multiple listing service (MLS) number for each of the two properties. In yet another example, if the property IDs are the same, the two properties are considered identical.

At the process 1230, other property descriptors are compared. For example, different sources in the plurality of sources use different property IDs for the identical property. In another example, other comparisons are performed to determine if the two properties are identical. In yet another example, one or more of the property descriptors are compared. In yet another example, addresses of the two properties are compared to determine if they are the same. In yet another example, listing prices of the two properties are compared to determine if they are the same. In yet another example, numbers of bedrooms of the two properties are compared to determine if they are the same. In yet another example, square footages of the two properties are compared to determine if they are the same. In yet another example the two square footages of the two properties are compared to determine if they are within 25 square feet of each other. In yet another example, yet other property descriptors are compared. In yet another example, if the comparison of the property descriptors determines that the two properties are identical, process 1240 is performed next. In yet another example, if the comparison of the property descriptors determines that the two properties are not identical, it is not necessary to merge the two properties.

At the process 1240, the two properties are merged. For example, the information collected on one of the two properties is copied into the other of the two properties. In another example, only the information not collected for the other of the two properties is copied from the one of the two properties. In yet another example, if conflicts exist in the collected information on the two properties collected from two of the plurality of sources, the collected information from the more reliable of the two sources is used and the collected information from the less reliable of the two sources is discarded. In yet another example, the one of the two properties is discarded.

Referring to FIG. 11, at the process 1130, the geolocation of the properties is determined. For example, the address of each of the properties is converted to a geolocation. In another example, a geocoding service is used to convert the address of each of the properties to geolocation data. In yet another example, the geolocation of each of the properties is associated with the corresponding property in the properties.

At the process 1140, attending schools for the properties are determined. For example, information on the attending schools is obtained from an integrated school information source. In another example, the integrated school information source includes integrated school information. In yet another example, the integrated school information includes the school boundary information and the additional school information stored in the process 350 as shown in FIG. 3. In yet another example, access to the integrated school information source is through a search interface. In yet another example, the search interface is the interface made accessible during the process 360 for supporting search as shown in FIG. 3.

According to some embodiments, the school boundary information is searched using the geolocations of the properties. For example, a query is prepared for a geolocation of each of the properties. In another example, the query requests the zero or more attending schools for the geolocation. In yet another example, the geolocation is compared to the boundary representation for one or more schools whose school boundary information is available. In yet another example, the geolocation is compared to the bounding rectangle for each of the one or more schools. In yet another example, use of the bounding rectangle provides an efficient way to determine a limited subset of the one or more schools for which the geolocation may be within the respective school boundaries. In yet another example, the geolocation is tested to determine whether the geolocation is within the school boundary of the one or more schools. In yet another example, the test to determine whether the geolocation is within the school boundary is a point in polygon test. In yet another example, if the geolocation is found to be within the school boundary then the school associated with the corresponding school boundary is determined to be an attending school for the corresponding property. In yet another example, the process 1140 determines that there are zero attending schools when the geolocation is not found to be within any school boundary. In yet another example, the process 1140 determines one or more attending schools for the geolocation. In yet another example, the one or more attending schools include schools at different levels (e.g., elementary, middle, high, etc.). In yet another example, the one or more attending schools are associated with the property corresponding to the geolocation. In yet another example, the additional information associated with each of the one or more attending schools is also retrieved and associated with the property corresponding to the geolocation.

At the process 1150, aggregate school scores for the properties are determined. For example, each of the properties is associated with as many as three or more attending schools. In another example, each of the attending schools is at a different level (e.g., elementary, middle, high, etc.). In yet another example, it is advantageous to have an aggregate school score for each of the properties that combines the performance and/or ranking scores for each of the attending schools. In yet another example, it is advantageous to have the aggregate school score for each of the properties provide a relative ranking of a respective school strength among each of the schools in a same geographic region. In yet another example, the process 1150 determines an aggregate school score for each of the properties.

According to some embodiments, a School and Housing (SnH) score is a suitable aggregate school score. For example, the SnH score is a number between 0 and 10. In another example, the SnH score aggregates the performance and/or ranking score associated with each of the one or more attending schools for a property. In yet another example, the SnH score provides a relative ranking of the respective school strength among each of the schools in the same geographic region. In yet another example, the SnH score includes a component based on the level for each of the one or more attending schools for a property. In yet another example, the SnH score is determined by comparing the performance and/or ranking score for each of the one or more attending schools to one or more performance and/or ranking scores of nearby schools of the same level. In yet another example, the SnH score is determined using Equations 2 and 3.

$$\begin{matrix}SnH score = a + {\sum }_{i = 1}^{n} {w}_{i} {\sum }_{j} f ( {S}_{i} , {S}_{j} ) & ( Equation 2 ) \\ f ( {S}_{i} , {S}_{j} ) = \{ \begin{matrix}{b}_{ij} , & {S}_{i} > {S}_{j} \\ 0 , & {S}_{i} \leq {S}_{j}\end{matrix} & ( Equation 3 )\end{matrix}$$

where the weighting and scaling coefficients a, bᵢⱼ, and wᵢ, are limited as follows: 0<a≦1, 0<bᵢⱼ≦1, and 0<wᵢ≦1.
   In yet another example, Sᵢ and Sⱼ are the performance and/or raking scores for schools i and j, respectively. In yet another example, n represents the number of school levels for the one or more attending schools of a property. In yet another example, schools j vary depending upon the number of nearby schools of the same level as school i. In yet another example, if school i represents a middle school, then the corresponding schools j represent nearby middle schools.

At the process 1160, the information on the properties is stored. For example, the information on the properties is associated with a unique identifier for each of the properties. In another example, the information on the properties includes the collected information on the properties. In yet another example, the information on the properties further includes the geolocations of the properties, the attending schools of the properties, and/or the aggregate school scores of the properties. In yet another example, the unique identifier is stored with the associated information on each of the properties. In yet another example, the information on the properties is indexed by the corresponding unique identifier. In yet another example, the attending schools for each of the properties is stored and associated with the corresponding collected information for the respective one of the properties. In yet another example, the aggregate school score for each of the properties is stored and associated with the corresponding collected information for the respective one of the properties. In yet another example, the information on the properties is stored in a common data store. In yet another example, the information on the properties is stored in one or more data stores. In yet another example, the common data store and/or each of the one or more data stores are located in any one selected from a list consisting of memory, disk, CD, server, cloud storage, and the like.

According to some embodiments, the integrated school information collected by the method 300 and/or the property information collected by the method 1100 are used to support search queries. For example, one of the search queries includes determining zero or more schools in a geographic region that match selected school criteria and/or selected geographic criteria. In another example, one of the search queries includes determining zero or more properties that match selected property criteria, selected geographic criteria, and/or selected school criteria. In yet another example, one of the search queries includes determining zero or more properties within a boundary of a selected school. In yet another example, one of the search queries includes determining all of the schools of different levels whose boundaries overlap the boundary of a target school. In yet another example, the search queries are accessed through a web site. In yet another example, the search queries are accessed through a web service. In yet another example, the search queries are accessed through other software methods. In yet another example, results of the search queries are returned.

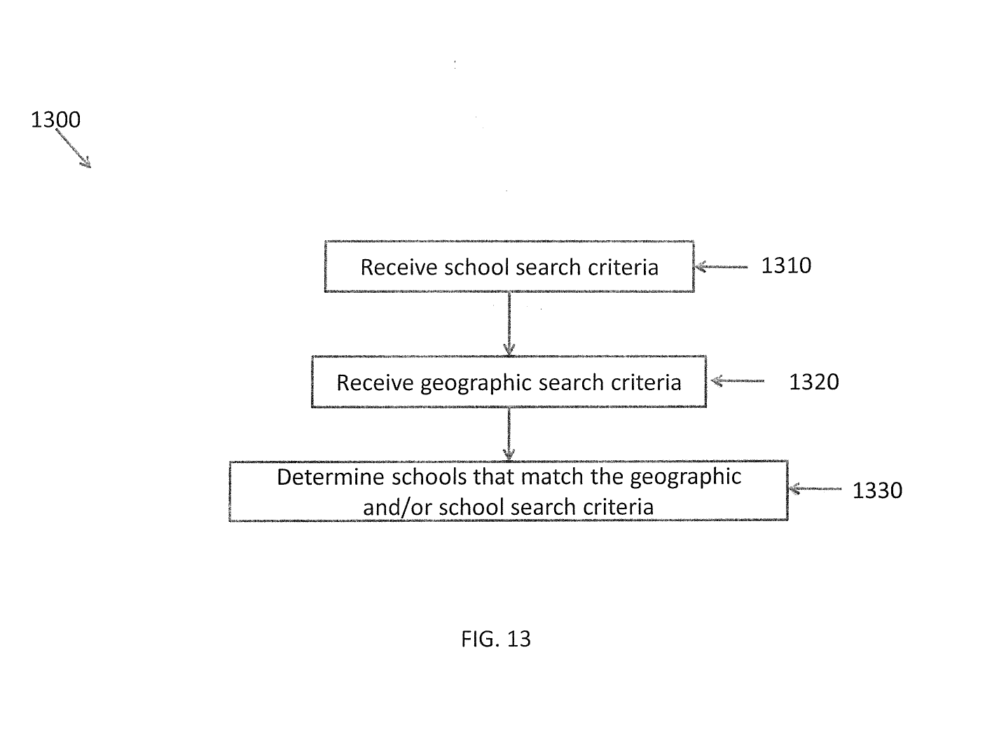

FIG. 13 is a simplified diagram showing a method for performing a school search query using school boundary information according to one embodiment of the present invention. This diagram is merely an example, which should not unduly limit the scope of the claims. One of ordinary skill in the art would recognize many variations, alternatives, and modifications. As shown in FIG. 13, the method 1300 includes a process 1310 for receiving school search criteria, a process 1320 for receiving geographic search criteria, and a process 1330 for determining schools that match the geographic and/or school search criteria. According to certain embodiments, the method 1300 is performed using variations among the processes 1310-1330 as would be recognized by one of ordinary skill in the art. For example, some or all of the processes of the method 1300 are performed by one or more computers (e.g., one or more servers) and/or one or more processors directed by software. In another example, some or all of the processes of the method 1300 are performed according to instructions included in one or more computer-readable media (e.g., one or more computer-readable media in a computer program product). In yet another example, some or all of the processes of the method 1300 are performed automatically. In some embodiments, only one of the processes 1310 or 1320 is performed.

At the optional process 1310, school search criteria are received. For example, the school search criteria (e.g., one or more school search parameters) are received from a search interface. In another example, the school search criteria include performance and/or ranking score criteria for one or more school levels. In yet another example, the performance and/or ranking score criteria includes a minimum acceptable score (e.g., a student performance threshold). In yet another example, the one or more school levels include one or more selected from a group consisting of elementary, middle, high, and the like. In yet another example, the school search criteria includes elementary school search criteria. In yet another example, the school search criteria includes middle school search criteria. In yet another example, the school search criteria includes high school search criteria. In yet another example, the school search criteria further includes an aggregating score criteria. In yet another example, the aggregating score criteria includes a minimum acceptable SnH score.

At the optional process 1320, geographic search criteria are received. For example, the property search criteria include geographic search limitations. In another example, the geographic search limitations include one or more selected from a group consisting of a zip code, a municipality, a county, and the like. In yet another example, the geographic search criteria includes a geolocation and a radius of search.

At the process 1330, schools that match the geographic and/or school search criteria are determined. For example, if the school search criteria include a performance and/or ranking score range, schools with a performance and/or raking score within the performance and/or ranking score range are determined. In another example, if the school search criteria include a SnH score range, schools with a SnH score within the SnH score range are determined. In yet another example, schools that match the school search criteria for a respective school level are determined separately. In yet another example, the elementary schools that match elementary school search criteria are determined. In yet another example, middle schools that match the middle school search criteria are determined. In yet another example, the high schools that match high school search criteria are determined. In yet another example, the schools matching the school search criteria are determined using a search query. In yet another example, the search query is a SQL query on a database. In yet another example, zero or more schools matching the school search criteria are determined. In yet another example, if no schools match the school search criteria, then no matching schools are determined.

In some embodiments, schools that match the geographic search criteria are determined. For example, if the geographic search criteria include a zip code, schools whose address includes the zip code are determined. In another example, if the geographic search criteria include a municipality, schools whose address includes the municipality are determined. In yet another example, if the geographic search criteria include a county, schools whose address includes the county are determined. In yet another example, if the geographic search criteria include a zip code, schools whose geolocation is within the boundaries of the zip code are determined. In yet another example, if the geographic search criteria include a municipality, schools whose geolocation is within the boundaries of the municipality are determined. In yet another example, if the geographic search criteria include a county, schools whose geolocation is within the boundaries of the county are determined. In yet another example, schools whose boundary overlaps the geographic search criteria are determined. In yet another example, the schools matching the geographic search criteria are determined using a search query. In yet another example, the search query is a SQL query on a database. In yet another example, zero or more schools matching the geographic search criteria are determined. In yet another example, if no schools match the geographic search criteria, then no matching schools are determined.

According to some embodiments, schools that match both the geographic search criteria and the school search criteria are determined. For example, a set of schools that match the geographic search criteria are intersected with a set of schools that match the school search criteria. In another example, the schools matching the geographic search criteria and the school search criteria are determined using a search query. In yet another example, the search query is a SQL query on a database. In yet another example, zero or more schools matching the geographic search criteria and the school search criteria are determined. In yet another example, if no schools match the geographic search criteria and the school search criteria, then no matching schools are determined.

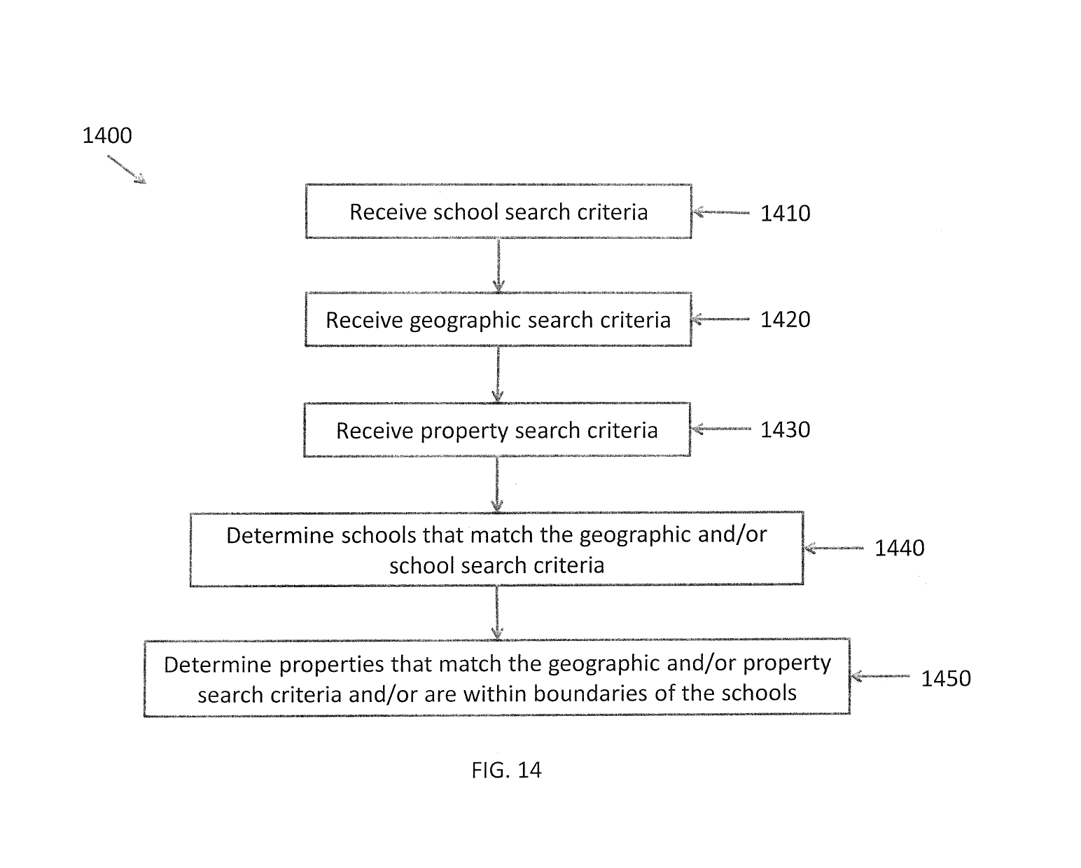

FIG. 14 is a simplified diagram showing a method for performing a property search query using school boundary information according to one embodiment of the present invention. This diagram is merely an example, which should not unduly limit the scope of the claims. One of ordinary skill in the art would recognize many variations, alternatives, and modifications. As shown in FIG. 14, the method 1400 includes a process 1410 for receiving school search criteria, a process 1420 for receiving geographic search criteria, a process 1430 for receiving property search criteria, a process 1440 for determining schools that match the geographic and/or school search criteria, and a process 1450 for determining properties that match the geographic and/or property search criteria and/or are within boundaries of the schools. According to certain embodiments, the method 1400 is performed using variations among the processes 1410-1450 as would be recognized by one of ordinary skill in the art. For example, some or all of the processes of the method 1400 are performed by one or more computers (e.g., one or more servers) and/or one or more processors directed by software. In another example, some or all of the processes of the method 1400 are performed according to instructions included in one or more computer-readable media (e.g., one or more computer-readable media in a computer program product). In yet another example, some or all of the processes of the method 1400 are performed automatically. In some embodiments, one or more of the processes 1410-1430 is omitted.

At the optional process 1410, school search criteria are received. For example, the school search criteria (e.g., one or more school search parameters) are received from a search interface. In another example, the school search criteria include performance and/or ranking score criteria for one or more school levels. In yet another example, the performance and/or ranking score criteria includes a minimum acceptable score (e.g., a student performance threshold). In yet another example, the one or more school levels include one or more selected from a group consisting of elementary, middle, high, and the like. In yet another example, the school search criteria includes elementary school search criteria. In yet another example, the school search criteria includes middle school search criteria. In yet another example, the school search criteria includes high school search criteria. In yet another example, the school search criteria further includes an aggregating score criteria. In yet another example, the aggregating score criteria includes a minimum acceptable SnH score. In yet another example, the process 1410 is the process 1310.

At the optional process 1420, geographic search criteria are received. For example, the property search criteria (e.g., one or more geographic search parameters) are received from a search interface. In another example, the geographic search criteria include geographic search limitations. In yet another example, the geographic search limitations include one or more selected from a group consisting of a zip code, a municipality, a county, and the like. In yet another example, the geographic search criteria includes a geolocation and a radius of search. In yet another example, the process 1420 is the process 1320.

At the optional process 1430, property search criteria are received. For example, the property search criteria (e.g., one or more property search parameters) are received from a search interface. In another example, the property search criteria include one or more property descriptors. In yet another example, the one or more property descriptors are each selected from a group consisting of lot size, square footage, number of rooms, number of bedrooms, number of bathrooms, date of construction, assessed value, date of last sale, date of listing, listing price, and the like. In yet another example, the property search criteria associated with one of the one or more of the property descriptors are an acceptable range for the respective property descriptor (e.g., a listing price within a dollar range). In yet another example, the property search criteria associated with one or the one or more of the property descriptors is a minimum acceptable value for the respective property descriptor (e.g., at least 3 bedrooms).

At the process 1440, schools that match the geographic and/or school search criteria are determined. For example, the process 1440 is the process 1330. In another example, if the school search criteria include a performance and/or ranking score range, schools with a performance and/or raking score within the performance and/or ranking score range are determined. In yet another example, if the school search criteria include a SnH score range, schools with a SnH score within the SnH score range are determined. In yet another example, schools that match the school search criteria for a respective school level are determined separately. In yet another example, the elementary schools that match elementary school search criteria are determined. In yet another example, middle schools that match the middle school search criteria are determined. In yet another example, the high schools that match high school search criteria are determined. In yet another example, the schools matching the school search criteria are determined using a search query. In yet another example, the search query is a SQL query on a database. In yet another example, zero or more schools matching the school search criteria are determined. In yet another example, if no schools match the school search criteria, then no matching schools are determined.

In some embodiments, schools that match the geographic search criteria are determined. For example, if the geographic search criteria include a zip code, schools whose address includes the zip code are determined. In another example, if the geographic search criteria include a municipality, schools whose address includes the municipality are determined. In yet another example, if the geographic search criteria include a county, schools whose address includes the county are determined. In yet another example, if the geographic search criteria include a zip code, schools whose geolocation is within the boundaries of the zip code are determined. In yet another example, if the geographic search criteria include a municipality, schools whose geolocation is within the boundaries of the municipality are determined. In yet another example, if the geographic search criteria include a county, schools whose geolocation is within the boundaries of the county are determined. In yet another example, schools whose boundary overlaps the geographic search criteria are determined. In yet another example, the schools matching the geographic search criteria are determined using a search query. In yet another example, the search query is a SQL query on a database. In yet another example, zero or more schools matching the geographic search criteria are determined. In yet another example, if no schools match the geographic search criteria, then no matching schools are determined.

According to some embodiments, schools that match both the geographic search criteria and the school search criteria are determined. For example, a set of schools that match the geographic search criteria are intersected with a set of schools that match the school search criteria. In another example, the schools matching the geographic search criteria and the school search criteria are determined using a search query. In yet another example, the search query is a SQL query on a database. In yet another example, zero or more schools matching the geographic search criteria and the school search criteria are determined. In yet another example, if no schools match the geographic search criteria and the school search criteria, then no matching schools are determined.

At the process 1450 properties that match the geographic and/or property search criteria and/or are within boundaries of the properties are determined. For example, properties located within the geographic search criteria are determined. For example, if the geographic search criteria include a zip code, properties whose address includes the zip code are determined. In another example, if the geographic search criteria include a municipality, properties whose address includes the municipality are determined. In yet another example, if the geographic search criteria include a county, properties whose address includes the county are determined. In yet another example, if the geographic search criteria include a zip code, properties whose geolocation is within the boundaries of the zip code are determined. In yet another example, if the geographic search criteria include a municipality, properties whose geolocation is within the boundaries of the municipality are determined. In yet another example, if the geographic search criteria include a county, properties whose geolocation is within the boundaries of the county are determined. In yet another example, the properties matching the geographic search criteria are determined using a search query. In yet another example, the search query is a SQL query on a database. In yet another example, zero or more properties matching the geographic search criteria are determined. In yet another example, if no properties match the geographic search criteria, then no matching properties are determined.

According to some embodiments, properties matching the property search criteria are determined. For example, property descriptors of properties are compared to the one or more property descriptors included in the property search criteria to determine if the corresponding properties match the property search criteria. In another example, if the property search criteria include a listing price range, properties whose listing price is within the listing price range are determined. In yet another example, if the property search criteria include additional property descriptors, properties whose descriptors match all of the additional property descriptors are determined. In yet another example, the properties matching the property search criteria are determined using a search query. In yet another example, the search query is a SQL query on a database. In yet another example, zero or more properties matching the property search criteria are determined. In yet another example, if no properties match the property search criteria, then no matching properties are determined.

In certain embodiments, properties within the boundaries of the schools are determined by the process 1450. For example, the attending school information associated with each of the properties is compared to the schools. In another example, the attending school information associated with each of the properties for each level of school is compared to the schools. In yet another example, if the comparison and/or comparisons is successful, the respective property is determined to be within the boundaries of the schools (e.g., within the attendance area of the schools). In yet another example, the attending school information associated with each of the properties is determined by the process 1140 of FIG. 11. In yet another example, the attending school information associated with each of the properties is determined by determining whether the geolocation of each of the properties is within the boundaries of the schools. In yet another example, the properties within the school boundaries are determined using a search query. In yet another example, the search query is a SQL query on a database. In yet another example, zero or more properties within the school boundaries are determined. In yet another example, if no properties within the school boundaries, then no matching properties are determined.

According to some embodiments, properties that match both the geographic search criteria and the property search criteria and are within boundaries of the schools are determined. For example, a set of properties that match the geographic search criteria are intersected with a set of properties that match the property search criteria and are additionally intersected with a set of properties that are within the school boundaries. In another example, the properties matching the geographic search criteria and the property search criteria and are within the school boundaries are determined using a search query. In yet another example, the search query is a SQL query on a database. In yet another example, zero or more properties matching the geographic search criteria and the property search criteria and are within the school boundaries are determined. In yet another example, if no properties match the geographic search criteria and the property search criteria and are within the school boundaries, then no matching properties are determined.

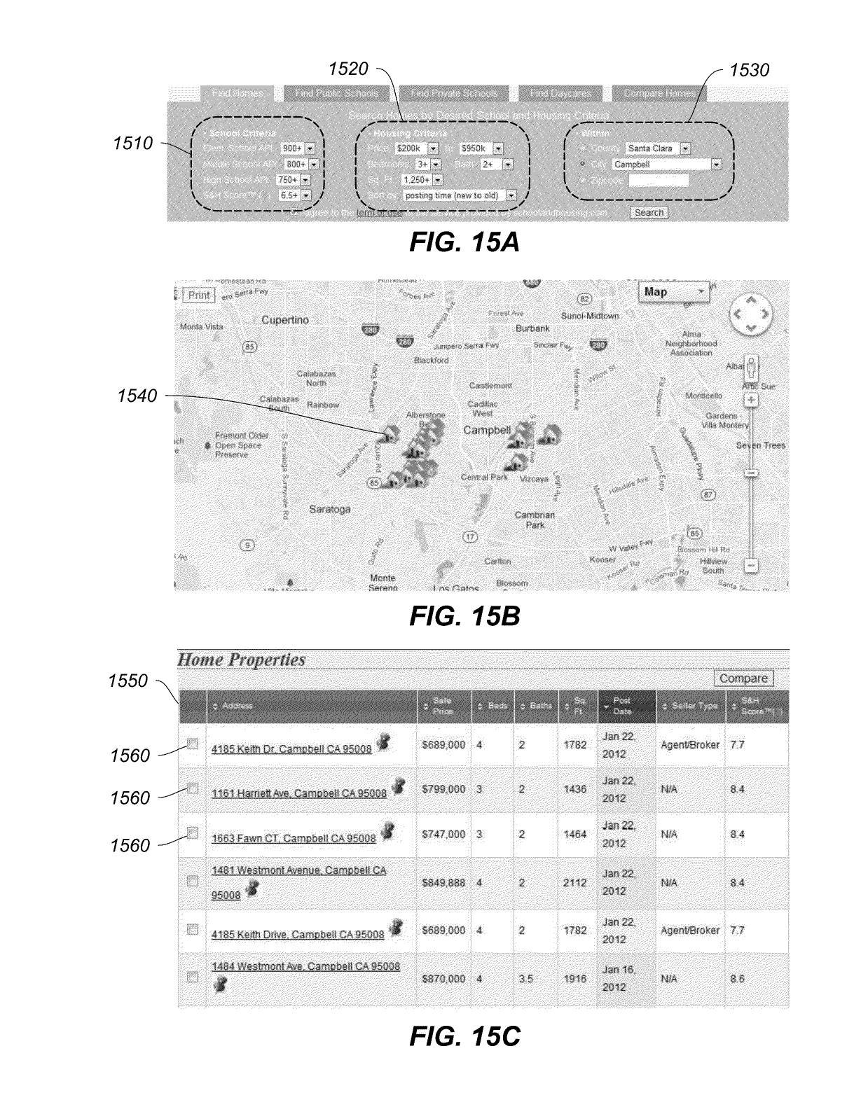

FIGS. 15A, 15B, and 15C are simplified diagrams showing samples of a web interface for an implementation of the method 1400 for performing a property search query using school boundary information according to one embodiment of the present invention. These diagrams are merely an example, which should not unduly limit the scope of the claims. One of ordinary skill in the art would recognize many variations, alternatives, and modifications. As shown in FIG. 15A, a search criteria input web page is depicted. For example, school search criteria 1510 is requested under the heading “School Criteria.” In another example, the school search criteria 1510 include the API as a performance score. In yet another example, the school search criteria 1510 further includes the SnH score. In yet another example, the property search criteria 1520 is requested under the heading “Housing Criteria.” In yet another example, the property search criteria 1520 includes property descriptors for listing price, number of bedrooms, number of bath rooms, and square footage. In yet another example, the geographic search criteria 1530 includes options for searching within a county, a city, or a zip code. As shown in FIG. 15B, results of the search method 1400 are depicted on a map showing each matching property using a “house” icon 1540 located at the corresponding geolocation. As shown in FIG. 15C, the results of the search method 1400 are depicted using a table 1550 with a row 1560 for each of the properties that match the various search criteria.

As discussed above and further emphasized here, FIGS. 15A, 15B, and 15C are merely an example, which should not unduly limit the scope of the claims. One of ordinary skill in the art would recognize many variations, alternatives, and modifications. In some embodiments, different search criteria are used. For example, lot size is included in the property search criteria 1520. In another example, other and/or additional property descriptors are used. In yet another example, rating scores other than the API score are used.

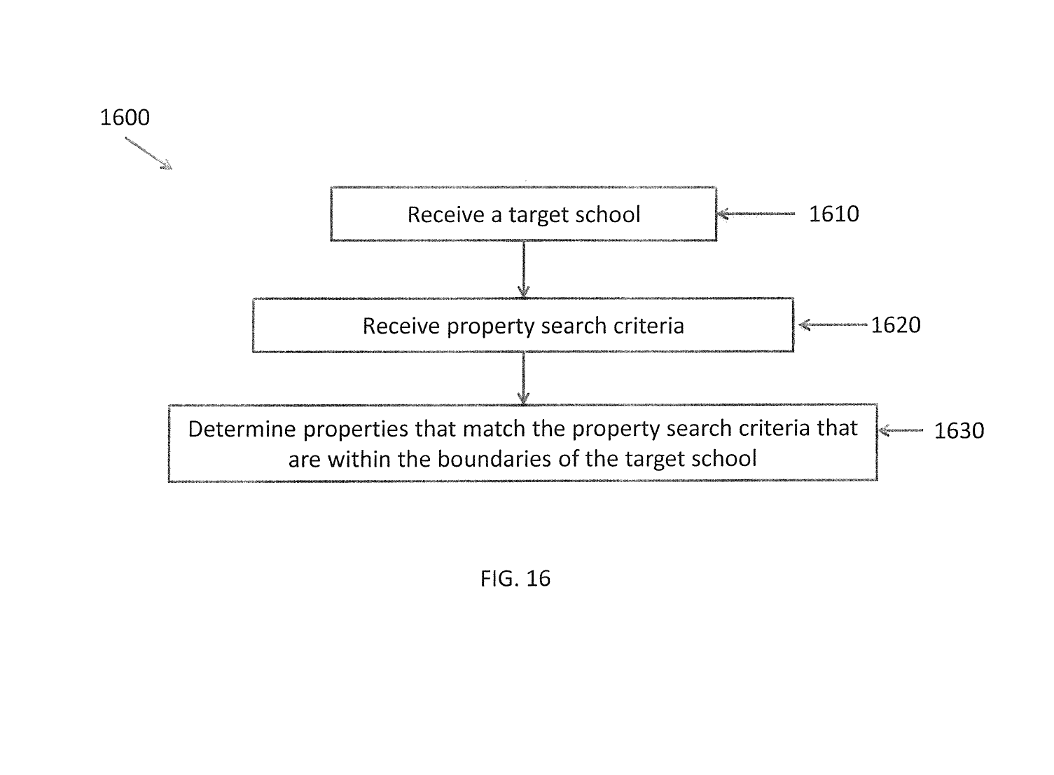

FIG. 16 is a simplified diagram showing a method for performing a property search query using school boundary information according to another embodiment of the present invention. This diagram is merely an example, which should not unduly limit the scope of the claims. One of ordinary skill in the art would recognize many variations, alternatives, and modifications. As shown in FIG. 16, the method 1600 includes a process 1610 for receiving a target school, a process 1620 for receiving property search criteria, a process 1630 for determining properties that match the property search criteria and are within boundaries of the target school. According to certain embodiments, the method 1600 is performed using variations among the processes 1610-1630 as would be recognized by one of ordinary skill in the art. For example, some or all of the processes of the method 1600 are performed by one or more computers (e.g., one or more servers) and/or one or more processors directed by software. In another example, some or all of the processes of the method 1600 are performed according to instructions included in one or more computer-readable media (e.g., one or more computer-readable media in a computer program product). In yet another example, some or all of the processes of the method 1600 are performed automatically.

At the process 1610, a target school is received. For example, a name of the target school is received. In another example, an identifier associated with the target school is received. In yet another example, the identifier is a county-district-school (CDS) code. In yet another example, the identifier is a National Center for Education Statistics (NCES) code. In yet another example, the identifier uniquely identifies the target school.

At the process 1620, property search criteria are received. For example, the property search criteria (e.g., one or more property search parameters) are received from a search interface. In another example, the property search criteria include one or more property descriptors. In yet another example, the one or more property descriptors are each selected from a group consisting of lot size, square footage, number of rooms, number of bedrooms, number of bathrooms, date of construction, assessed value, date of last sale, date of listing, listing price, and the like. In yet another example, the property search criteria associated with one of the one or more of the property descriptors are an acceptable range for the respective property descriptor (e.g., a listing price within a dollar range). In yet another example, the property search criteria associated with one or the one or more of the property descriptors is a minimum acceptable value for the respective property descriptor (e.g., at least 3 bedrooms).

At the process 1630, properties that match the property search criteria that are within the boundaries of the target school are determined. For example, property descriptors of properties are compared to the one or more property descriptors included in the property search criteria to determine if the corresponding properties match the property search criteria. In another example, if the property search criteria include a listing price range, properties whose listing price is within the listing price range are determined. In yet another example, if the property search criteria include additional property descriptors, properties whose descriptors match all of the additional property descriptors are determined. In yet another example, the properties matching the property search criteria are determined using a search query. In yet another example, the search query is a SQL query on a database. In yet another example, zero or more properties matching the property search criteria are determined. In yet another example, if no properties match the property search criteria, then no matching properties are determined.

In certain embodiments, properties within the boundaries of the target school are determined by the process 1630. For example, the attending school information associated with each of the properties is compared to the target school. In yet another example, if the comparison is successful, the respective property is determined to be within the boundaries of the target school (e.g., within the attendance area of the target school). In yet another example, the attending school information associated with each of the properties is determined by the process 1160 of FIG. 11. In yet another example, the attending school information associated with each of the properties is determined by determining whether the geolocation of each of the properties is within the boundaries of the target school. In yet another example, the properties within the school boundaries are determined using a search query. In yet another example, the search query is a SQL query on a database. In yet another example, zero or more properties within the school boundaries are determined. In yet another example, if no properties within the school boundaries, then no matching properties are determined.

According to some embodiments, properties that match the property search criteria and are within boundaries of the target school are determined using one or more search queries. For example, the one or more search queries are one or more SQL queries on a database. In yet another example, zero or more properties matching the property search criteria and are within the target school boundaries are determined. In yet another example, if no properties match the property search criteria and are within the target school boundaries, then no matching properties are determined.

As discussed above and further emphasized here, FIG. 16 is merely an example, which should not unduly limit the scope of the claims. One of ordinary skill in the art would recognize many variations, alternatives, and modifications. In some embodiments, the target school is replaced by a combination of schools. For example, the boundary of each of the combination of schools overlaps. In another example, each of the schools in the combination of schools is a different level.

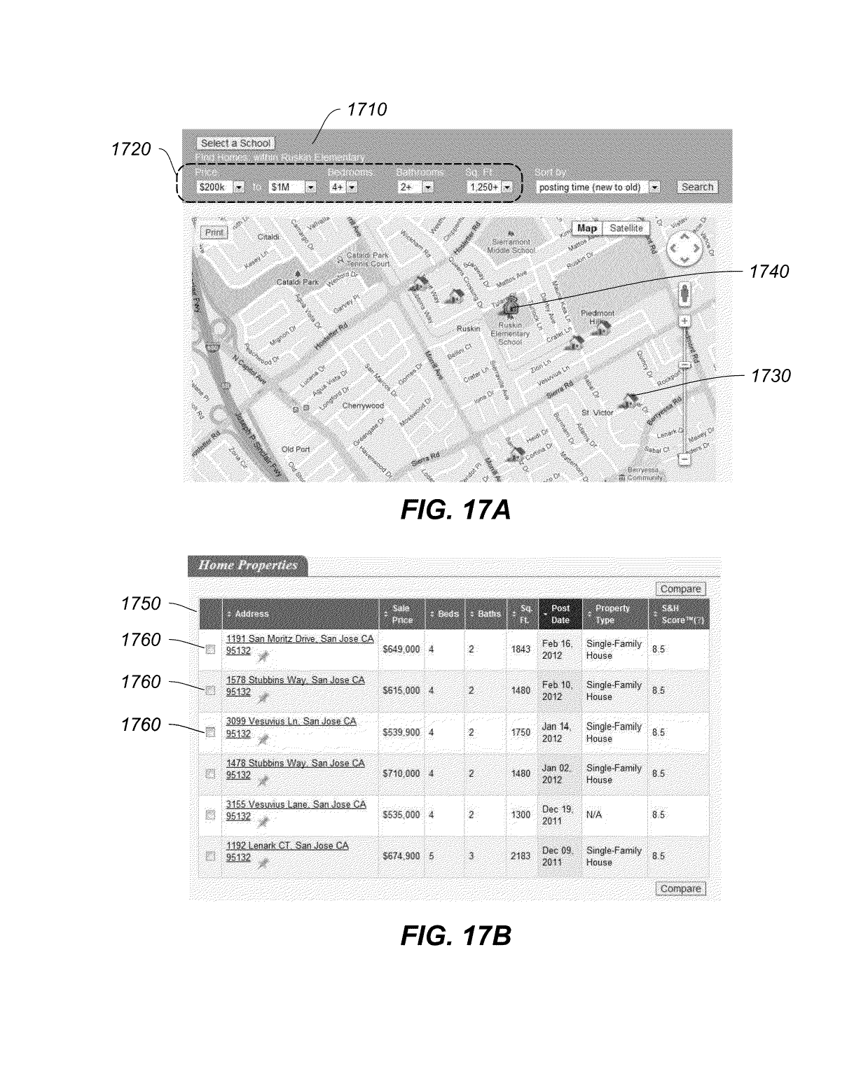

FIGS. 17A and 17B are simplified diagrams showing samples of a web interface for an implementation of the method 1600 for performing a property search query using school boundary information according to one embodiment of the present invention. These diagrams are merely an example, which should not unduly limit the scope of the claims. One of ordinary skill in the art would recognize many variations, alternatives, and modifications. As shown in FIG. 17A, a search criteria input web page is depicted. For example, a target school has already been identified as “Ruskin Elementary” 1710. In another example, property search criteria 1720 are requested. In yet another example, the property search criteria 1720 includes property descriptors for listing price, number of bedrooms, number of bath rooms, and square footage. Additionally, as shown in FIG. 17A, results of the search method 1600 are depicted on a map showing each matching property using a “house” icon 1730 located at the corresponding geolocation. As another example, the location of the target school is depicted using a school icon located at the corresponding geolocation 1740. As shown in FIG. 17B, the results of the search method 1400 are depicted using a table 1750 with a row 1760 for each of the properties that match the various search criteria.

As discussed above and further emphasized here, FIGS. 17A and 17B are merely an example, which should not unduly limit the scope of the claims. One of ordinary skill in the art would recognize many variations, alternatives, and modifications. In some embodiments, different search criteria are used. For example, lot size is included in the property search criteria 1720. In another example, an input control is added to select the target school.

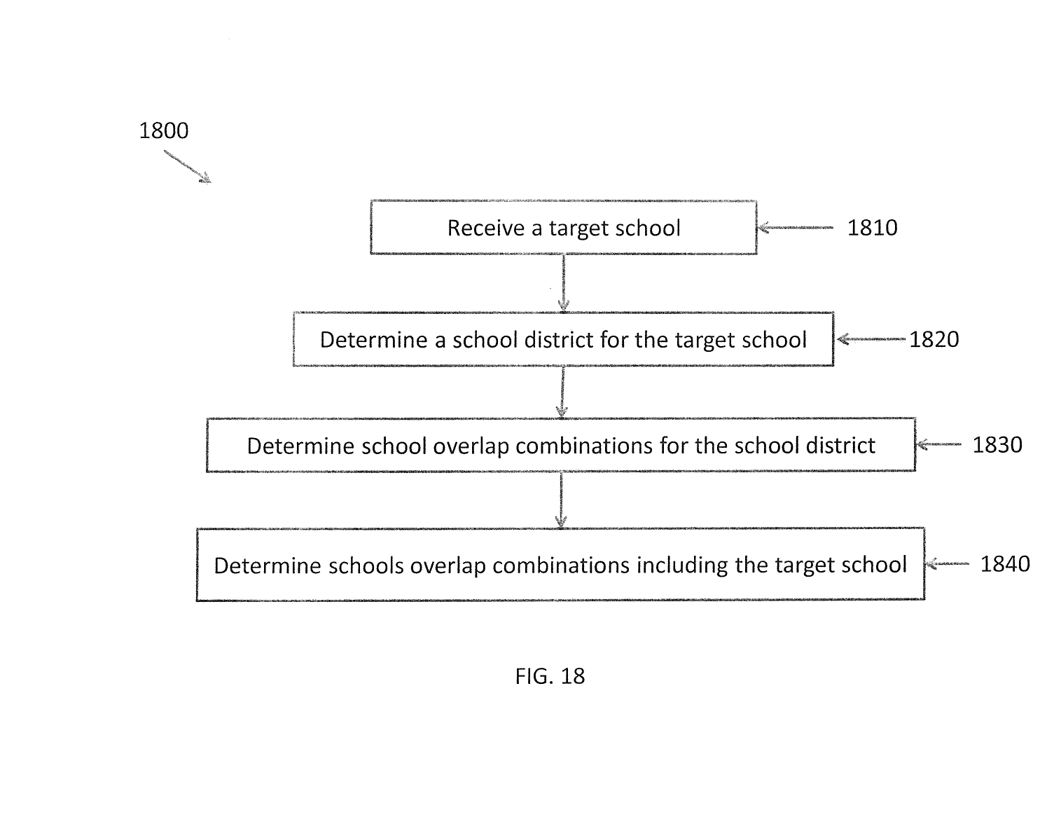

FIG. 18 is a simplified diagram showing a method for performing a school search query using school boundary information according to an embodiment of the present invention. This diagram is merely an example, which should not unduly limit the scope of the claims. One of ordinary skill in the art would recognize many variations, alternatives, and modifications. As shown in FIG. 18, the method 1800 includes a process 1810 for receiving a target school, a process 1820 for determining a school district for the target school, a process 1830 for determining school overlap combinations for the school district, and a process 1840 for determining school overlap combinations including the target school. According to certain embodiments, the method 1800 for performing a school search query using school boundary information is performed using variations among the processes 1810-1840 as would be recognized by one of ordinary skill in the art. For example, some or all of the processes of the method 1800 are performed by one or more computers (e.g., one or more servers) and/or one or more processors directed by software. In another example, some or all of the processes of the method 1800 are performed according to instructions included in one or more computer-readable media (e.g., one or more computer-readable media in a computer program product). In yet another example, some or all of the processes of the method 1800 are performed automatically. In yet another example, the process 1820 is omitted.

At the process 1810, a target school is received. For example, a name of the target school is received. In another example, an identifier is associated with the target school is received. In yet another example, the identifier a county-district-school (CDS) code. In yet another example, the identifier is a National Center for Education Statistics (NCES) code. In yet another example, the identifier uniquely identifies the target school.

At the optional process 1820, a school district for the target school is determined. For example, the school district associated with the target school is included in the additional school information as determined by the method 1000 for FIG. 10. In another example, the school district is retrieved from the location it was stored in during the process 1050.

At the process 1830, school overlap combinations for the school district are determined. For example, the school district includes one or more high schools, one or more middle schools, and one or more elementary schools. In another example, the boundaries of each of the one or more high schools, the one or more middle schools, and the one or more elementary schools overlap in different combinations.

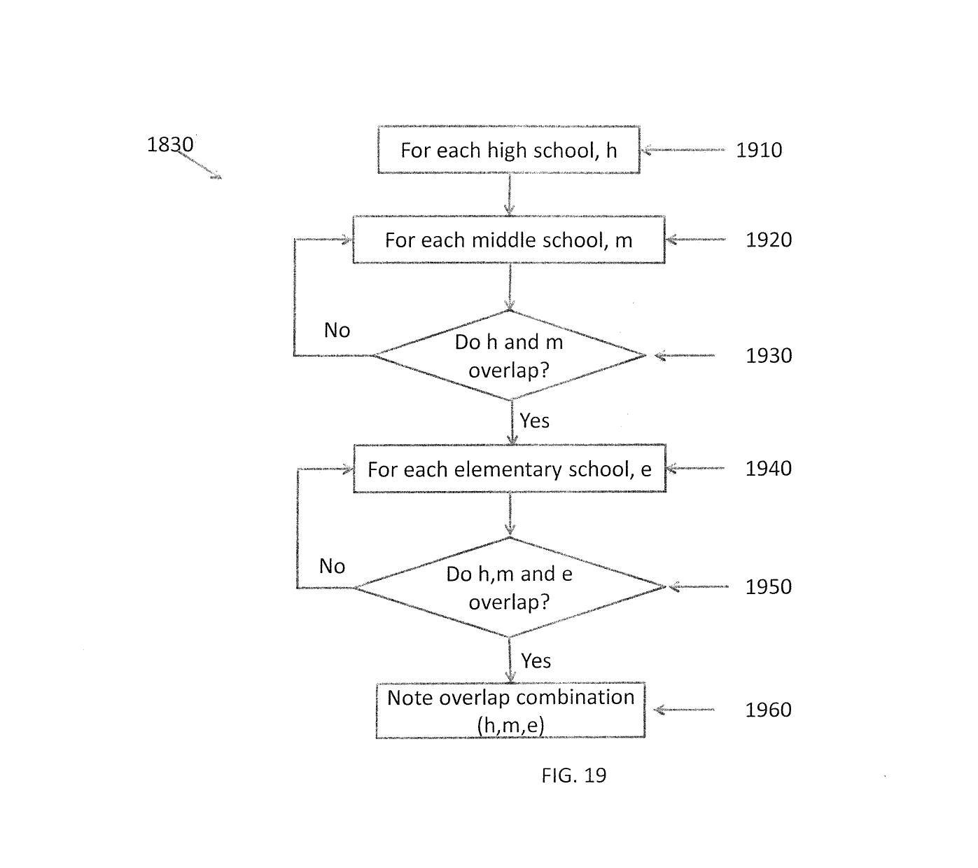

FIG. 19 is a simplified diagram showing a process for determining school overlap combinations using school boundary information as part of the method 1800 for performing a school search query using school boundary information according to an embodiment of the present invention. This diagram is merely an example, which should not unduly limit the scope of the claims. One of ordinary skill in the art would recognize many variations, alternatives, and modifications. As shown in FIG. 19, the process 1830 includes a process 1910 for considering each high school, a process 1920 for considering each middle school, a process 1930 for determining if a high school and a middle school overlap, a process 1940 for considering each elementary school, a process 1950 for determining if a high school, a middle school, and an elementary school overlap, and a process 1960 for identifying an overlapping combination. According to certain embodiments, the process 1830 is performed using variations among the processes 1910-1960 as would be recognized by one of ordinary skill in the art. For example, some or all of the processes of the process 1830 are performed by one or more computers (e.g., one or more servers) and/or one or more processors directed by software. In another example, some or all of the processes of the process 1830 are performed according to instructions included in one or more computer-readable media (e.g., one or more computer-readable media in a computer program product). In yet another example, some or all of the processes of the process 1830 are performed automatically.

At the process 1910, each high school is considered. For example, each high school in the school district is considered one after the other. In yet another example, the processes 1920-1960 are applied to each high school in the district as needed. In yet another example, a loop is executed for each high school in the district.

At the process 1920, each middle school is considered. For example, each middle school in the school district is considered one after the other. In yet another example, the processes 1930-1960 are applied to each high school and middle school combination in the district as needed. In yet another example, a loop is executed for each middle school in the district.

At the process 1930, an overlap between a high school and a middle school is determined. For example, the boundary associated with the high school is compared with the boundary of the middle school to determine if the two boundaries overlap. In another example, a boundary overlap computation determines an amount to which the boundary associated with the high school overlap the boundary associated with the middle school. In yet another example, the amount is compared to a threshold. In yet another example, if the threshold is equal to or above a minimum value, the high school and the middle school overlap. In yet another example, if the threshold is below a minimum value, the high school and the middle school do not overlap. In yet another example, the minimum value is 50 square feet. In yet another example, if the high school and the middle school overlap, control is passed to the process 1940. In yet another example, if the high school and the middle school do not overlap, control is returned to the process 1920 if there are additional middle schools to consider, to the process 1910 if there are no additional middle schools to consider, but additional high schools to consider, or the process 1830 ends if there are no additional middle schools and no additional high schools to consider.

At the process 1940, each elementary school is considered. For example, each elementary school in the school district is considered one after the other. In yet another example, the processes 1950 and 1960 are applied to each high school, middle school, and elementary school combination in the district as needed. In yet another example, a loop is executed for each elementary school in the district.

At the process 1950, an overlap between a high school, a middle school, an elementary school is determined. For example, the boundary associated with the high school is compared with the boundary of the middle school and are further compared to the boundary of the elementary school to determine if the three boundaries mutually overlap. In another example, a boundary overlap computation determines an amount to which the boundary associated with the high school overlap the boundary associated with the middle school and further overlap the boundary associated with the elementary school. In yet another example, the amount is compared to a threshold. In yet another example, if the threshold is equal to or above a minimum value, the high school, the middle school, and the elementary school overlap. In yet another example, if the threshold is below a minimum value, the high school, the middle school, and the elementary school do not overlap. In yet another example, the minimum value is 50 square feet. In yet another example, if the high school, the middle school, and the elementary school overlap, control is passed to the process 1960. In yet another example, if the high school, the middle school, and the elementary school do not overlap, control is returned to the process 1940 if there are additional elementary schools to consider, to the process 1920 if there are no additional elementary schools to consider, but additional middle schools to consider, to the process 1910 if there are no additional elementary schools to consider and no additional middle schools to consider, but additional high schools to consider, or the process 1830 ends if there are no additional elementary schools, no additional middle schools and no additional high schools to consider.

At the process 1960 the overlapping combination is identified. For example, the combination of the high school, the middle school, and the elementary school that mutually overlap is identified. In another example, the overlapping combination is stored for use in later searches. In yet another example, control is returned to the process 1940 if there are additional elementary schools to consider, to the process 1920 if there are no additional elementary schools to consider, but additional middle schools to consider, to the process 1910 if there are no additional elementary schools to consider and no additional middle schools to consider, but additional high schools to consider, or the process 1830 ends if there are no additional elementary schools, no additional middle schools and no additional high schools to consider.

Referring to FIG. 18, at the process 1840, the school overlap combinations including the target school are determined. For example, if the target school is an elementary school, the school overlap combinations including the target school as an elementary school are determined. In another example, if the target school is a middle school, the school overlap combinations including the target school as the middle school are determined. In yet another example, if the target school is a high school, the school overlap combinations including the target school as the high school are determined.

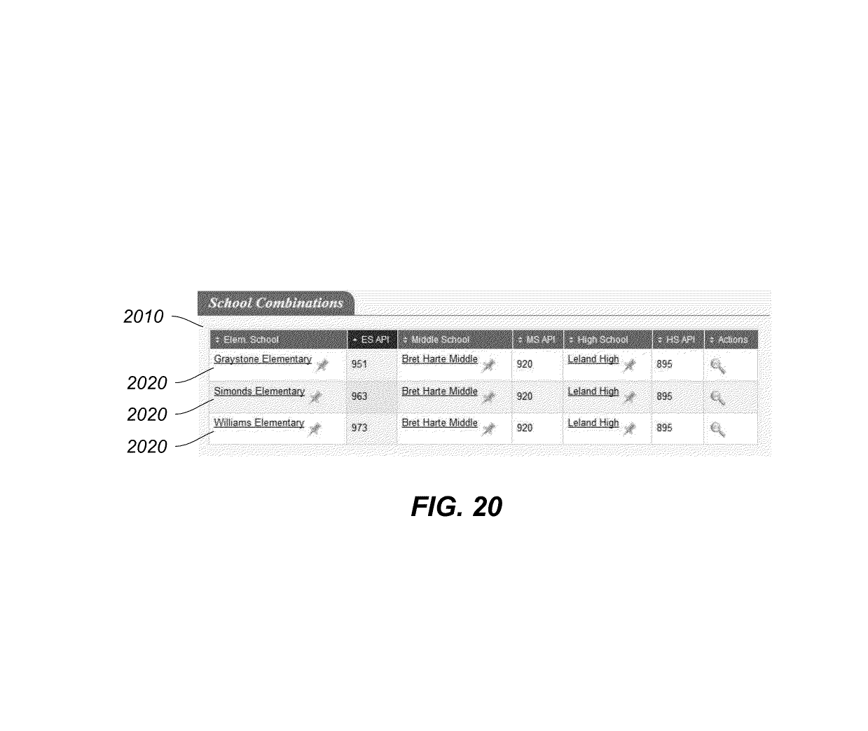

FIG. 20 is a simplified diagram showing a sample search result for the method 1800 for performing a school search query using school boundary information according to one embodiment of the present invention. This diagram is merely an example, which should not unduly limit the scope of the claims. One of ordinary skill in the art would recognize many variations, alternatives, and modifications. As shown in FIG. 20, a school combinations table 2010 is depicted for Bret Harte Middle school. For example, the table 2010 includes a row for 2020 each school overlapping combination.

As discussed above and further emphasized here, FIGS. 18-20 are merely examples, which should not unduly limit the scope of the claims. One of ordinary skill in the art would recognize many variations, alternatives, and modifications. In some embodiments, the schools at different levels are in different school districts. For example, a school district may only have one or more high schools. In another example, the one or more high schools are associated with middle and elementary schools in other school districts. In yet another example, the process 1820 determines not only the school district associated with the target school, but also the other school districts that include schools that are associated with the target school. In yet another example, the process 1830 includes all the schools in the school district and all the schools in the other school districts when determining the school overlap combinations. According to some embodiments, different numbers of levels of schools are used. For example, fewer than three levels of schools are compared for overlapping. In another example, more than three levels of schools are compared for overlapping. In yet another example, the number of considering processes (e.g., 1910, 1920, and 1940) is decreased or increased accordingly. In yet another example, the number and/or complexity of the overlapping test processes (e.g., 1930 and 1950) are decreased or increased accordingly.

In one embodiment of the present invention, a computer-implemented method for use with a school boundary digitization and integration process, includes collecting school boundary data from each school district, digitizing boundary information into a geographic data, and integrating school boundary geographic data from multiple school districts and other school information into one system.

In another embodiment of the present invention, a computer-implemented method for use with a school boundary based school locator process, includes geocoding a property address into geographic longitude/latitude, optionally selecting attending school candidates using school boundary rectangle, and verifying attending schools using the point-in-polygon algorithm.

In yet another embodiment of the present invention, a computer-implemented method for use with a school boundary based property search, includes two search scenarios. For example, one search scenario includes a process to search properties within the boundary of a selected school or an overlap of multiple selected schools, which includes a property-first method and a pre-processing method. In another example, the property-first method includes searching for properties with property search criteria first and then verifying attending schools of properties during the online search. In yet another example, the pre-processing method includes computing attending schools for properties offline, storing the attendance information in database, and processing the online search as database SQL queries with predicate on school id and property search criteria. In yet another example, another search scenario includes a process to search properties with property search criteria and school search criteria (e.g., school performance and/or ranking score ranges), which includes three processing methods: a property-first method, a school-first method, and a pre-processing method. In yet another example, the property-first method includes searching properties with property search criteria first and verifying their school search criteria on the fly during the search process. In yet another example, the school-first method includes searching for school overlapping areas satisfying school search criteria, then searching for properties with property search criteria within each overlapping area and finally removing properties that do not satisfy search criteria for all schools and duplicate properties. In yet another example, the pre-processing method includes computing attending schools for properties offline, storing the attendance information in a database, and processing the online search as database SQL queries with predicates on school search criteria and property search criteria.

In certain embodiments, the system is directed to determining and utilizing geographic boundaries. For example, a school geographic boundary based school locator is supported. In another example, support for property searching within the boundary of a selected school or an overlap of multiple selected schools. In yet another example, support for searching for properties with both property search criteria and school search criteria. In yet another example, support for building a system to digitize and integrate school boundary data across multiple school districts.

Existing school locators are independently developed by different school districts and/or other sources. These school locators are usually based on address search over an address database, where all the addresses in this school district and according public schools are stored. Such an approach has limitations:

For example, each school district only deals with its own addresses and does not cover other school districts. This is not user friendly, because when home buyers or real estate agents find a property, they have to first figure out which school district that the property belongs to, then use different school districts school locators. This may not be an easy task as the mapping between property address and school district is often unclear. In another example, inputting and maintaining all addresses in the databases takes big efforts. A school district usually covers a large number of addresses. Plus, addresses may change over time. New homes may be built, which requires new addresses to be added. In yet another example, text-search based queries are error-prone. For example, if “Mt” is used in the database as abbreviation of “Mountain” and user's input address uses “Mountain”, there will not be a correct match for this query. In yet another example, school districts develop school boundaries. Property search engines provide searches. However, there is no service to combine these two parties together to provide more user-friendly property search services.

According to some embodiments, system requires an offline process to collect school boundary data from multiple school districts in various formats (e.g., pdf file, web page), digitize and normalize the data into geographic boundary as polygons or multi-polygons, and integrate boundary data with school information in one system. For example, each polygon or multi-polygon consists of a set of (latitude, longitude) geographic points.

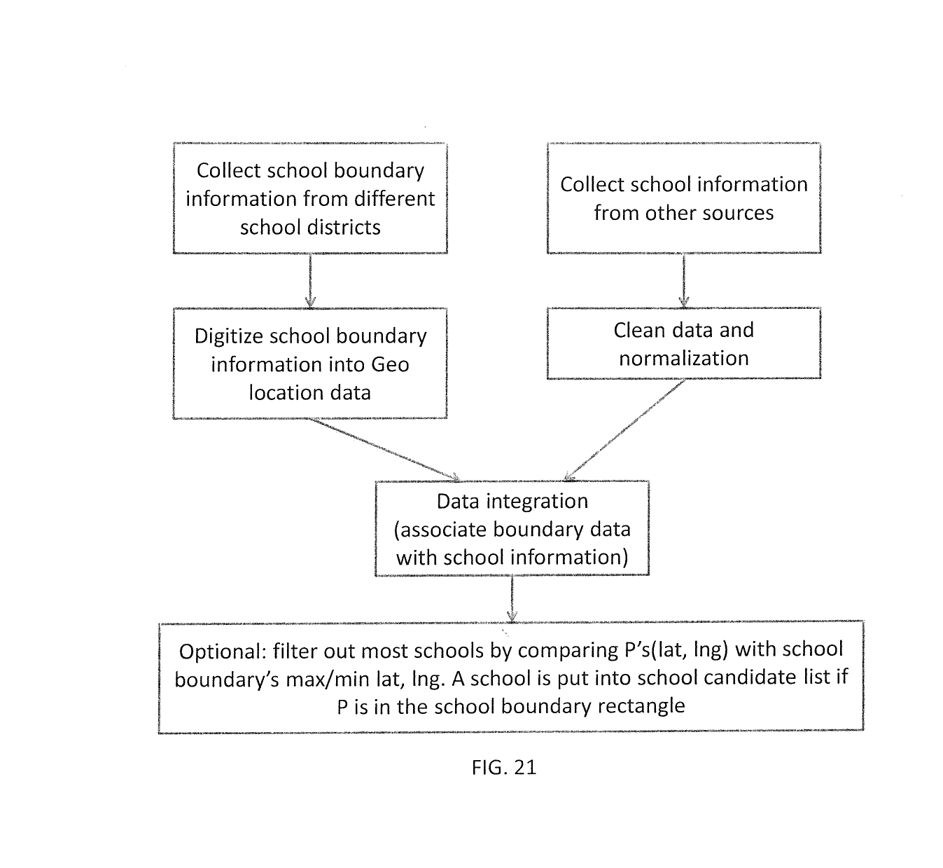

FIG. 21 is a simplified diagram of the school boundary digitization and integration process according to one embodiment of the present invention. For example, when a user inputs a street address and look for attending schools, we first use a geo-coding service to translate this address into a geographic (longitude, latitude) data point P. In another example, attending schools are determined for the given property by finding schools whose boundaries enclose the point P. In yet another example, there are many school boundary data stored in the system, this step involves checking the inclusion relation between the point P and all the schools' boundary polygons using the point-in-polygon algorithm. In yet another example, checking all schools is not time efficient. In yet another example, to reduce the processing time, a filter eliminates most schools from further consideration by comparing P with each school's boundary rectangles, which are represented by the min and max (latitude, longitude) of schools boundary data. In yet another example, this is done by comparing P's (latitude, longitude) with each rectangle's vertices (latitude, longitude). In yet another example, a school is considered as a candidate only if its boundary rectangle contains P. In yet another example, this optimization is optional, but can significantly improve the performance.

In yet another example, comparing to address-based text matching, geographic boundary based school locator is more robust in terms of address changes and misspellings. In yet another example, the geocoding service is already supported by some service providers (e.g., Google Geocoding Service). In yet another example, the complete street addresses are not stored. In yet another example, the data size is much smaller and easy to maintain.

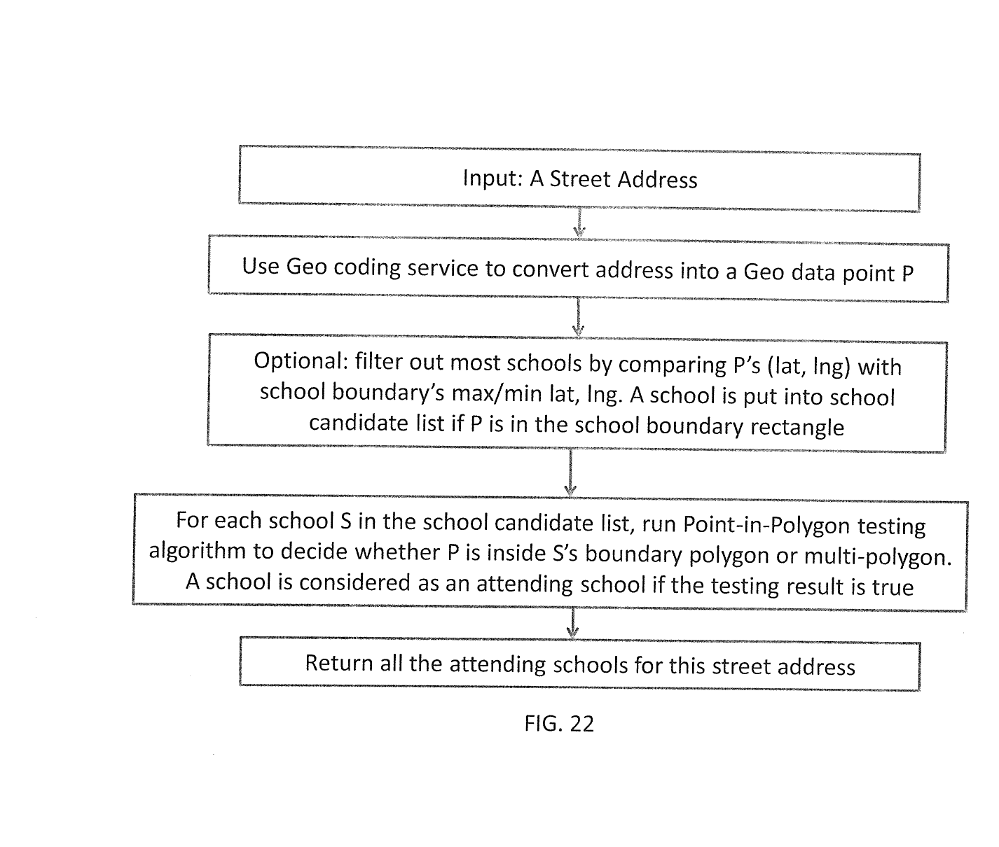

FIG. 22 is a simplified diagram of the school boundary data based school locator according to one embodiment of the present invention. For example, there are two major search scenarios: In another example, a user already knows the school and wants to find properties within the school attendance area. In yet another example, a user also wants to find properties within the overlapping boundary area of known elementary, middle and high schools. In yet another example, a user does not know the particular schools. In yet another example, the user wants to find properties with certain school and property search criteria. In yet another example, a user looks for single-family properties in San Jose with price less than $900,000, elementary school API score above 900, middle school API score above 870 and high school API score above 850.

In yet another example, the property-first processing method includes identifying properties satisfying the property search criteria and then for each property in the result list, it is determined whether it is inside the given boundary area. In yet another example, if multiple schools are considered, an overlap area is computed based on the boundaries of those schools.

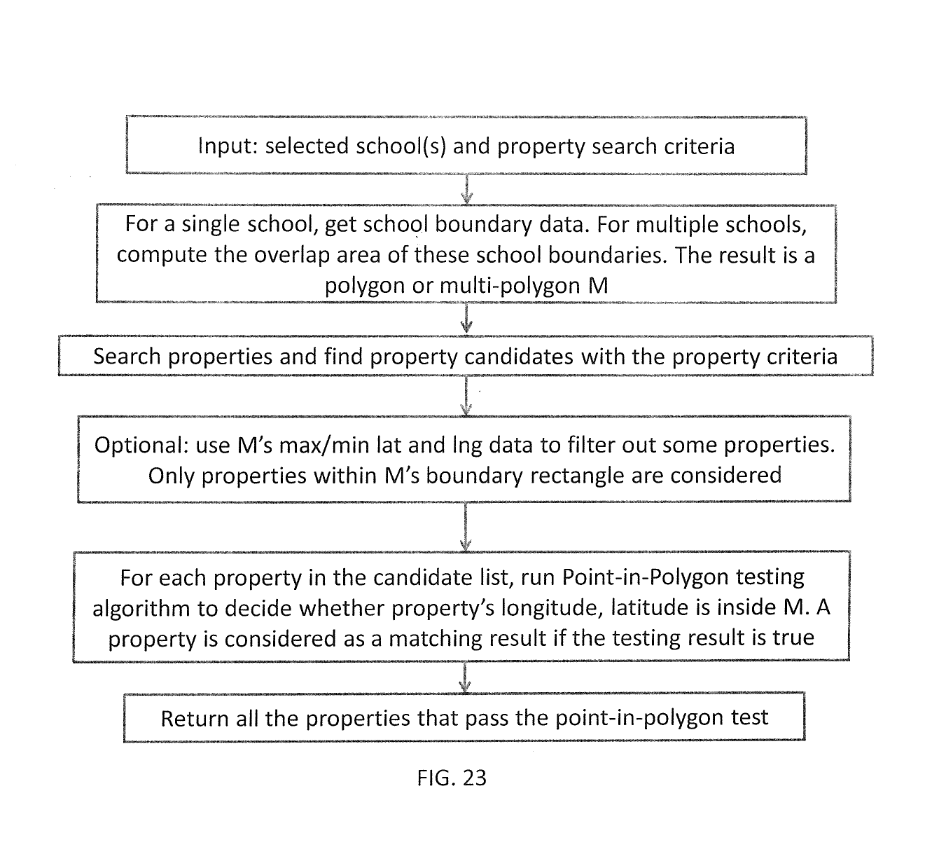

FIG. 23 is a simplified diagram of the property-first process of searching for properties within the boundary of a school or an overlap of multiple schools according to one embodiment of the present invention. For example, the property-first method requires testing point-in-polygon on the fly during the search process. In another example, the pre-processing method achieves better performance with the cost of more storage space and an offline processing step. In yet another example, the pre-processing method includes identifying the attending schools for all properties offline and storing the school attendance information. In yet another example, a search includes processing SQL queries.

In yet another example, a relational table PROPERTY_SCHOOL (PROPERTY_ID, SCHOOL_ID) is used to store the offline processed school attendance result for all properties. In yet another example, if a user is looking for properties within the boundary of a school with ID 12345, the SQL query to find matching property IDs is SELECT PROPERTY_ID FROM PROPERTY_SCHOOL WHERE SCHOOL_ID=12345. In yet another example, if a user considers multiple schools (e.g., 12345, 67890), the SQL query is SELECT PROPERTY_ID FROM PROPERTY_SCHOOL WHERE SCHOOL_ID=12345 INTERSECT SELECT PROPERTY_ID FROM PROPERTY_SCHOOL WHERE SCHOOL_ID=67890.

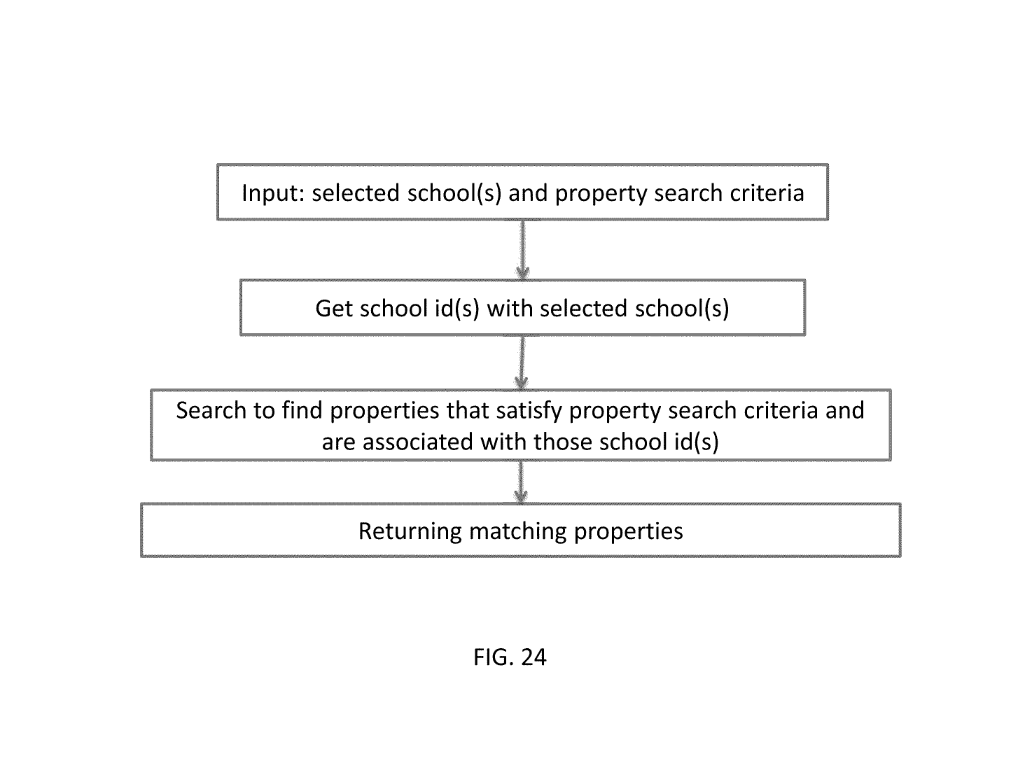

FIG. 24 is a simplified diagram of the pre-processing method for searching for properties within the boundary of a school or an overlap of multiple schools according to one embodiment of the present invention. For example, the property-first processing method includes identifying properties satisfying the property search criteria and then for each property in the result list, determining its attending schools and then verifying the school search criteria.

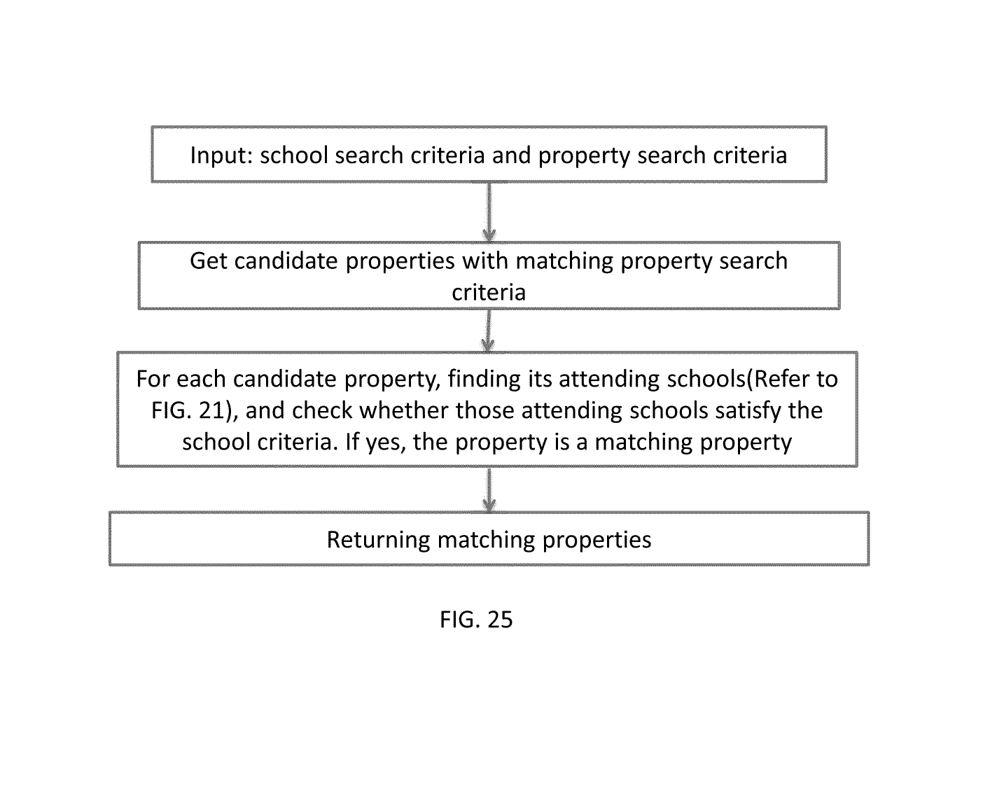

FIG. 25 is a simplified diagram of the property-first process of searching for properties with both school search criteria and property search criteria according to one embodiment of the present invention. For example, the property-first process includes identifying all properties satisfying the property search criteria and then identifying those properties that also satisfy the school search criteria. In another example, the school search criteria in a user's query covers multiple schools. In yet another example, properties satisfying all the school search criteria are determined. In yet another example, because school boundaries have overlaps, one property may appear multiple times. In yet another example, de-duplication has to be done to generate the final result.

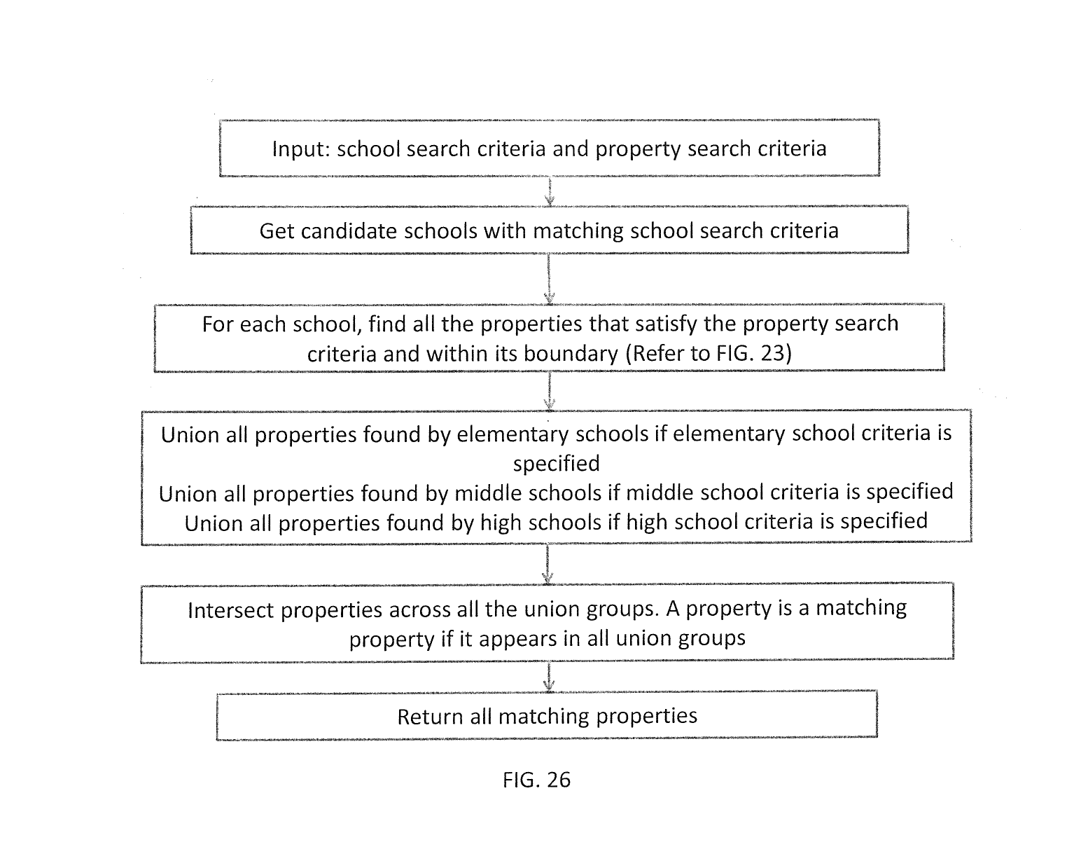

FIG. 26 is a simplified diagram of the school-first process of searching for properties with both school search criteria and property search criteria according to one embodiment of the present invention. For example, the school-first processing method includes identifying all schools satisfying the school search criteria and then determining the properties within the boundary of each school. In another example, both the property-first method and school-first method require significant computation on the fly during the search process. In yet another example, the pre-processing method achieves better performance with the cost of more storage space and an offline processing step. In yet another example, the pre-processing method includes identifying attending schools for all properties offline and storing the school attendance information. In yet another example, a search includes processing SQL queries.

In yet another example, a relational table PROPERTY_SCHOOL (PROPERTY_ID, SCHOOL_ID) is used to store the offline processed school attendance result for all properties. In yet another example, if a user is looking for properties in Santa Clara County with elementary school API more than 900 and middle school API more than 850, a SQL query to find matching property IDs is SELECT PROPERTY_ID FROM PROPERTY_SCHOOL, SCHOOL WHERE PROPERTY_SCHOOL.SCHOOL_ID=SCHOOL.SCHOOL_ID AND SCHOOL.TYPE=‘ELEMENTARY’ AND SCHOOL.API>900 AND SCHOOL.COUNTY=‘SANTA CLARA’ INTERSECT SELECT PROPERTY_ID FROM PROPERTY_SCHOOL, SCHOOL WHERE PROPERTY_SCHOOL.SCHOOL_ID=SCHOOL.SCHOOL_ID AND SCHOOL.TYPE=‘MIDDLE’ AND SCHOOL.API>850 AND SCHOOL.COUNTY=‘SANTA CLARA’.

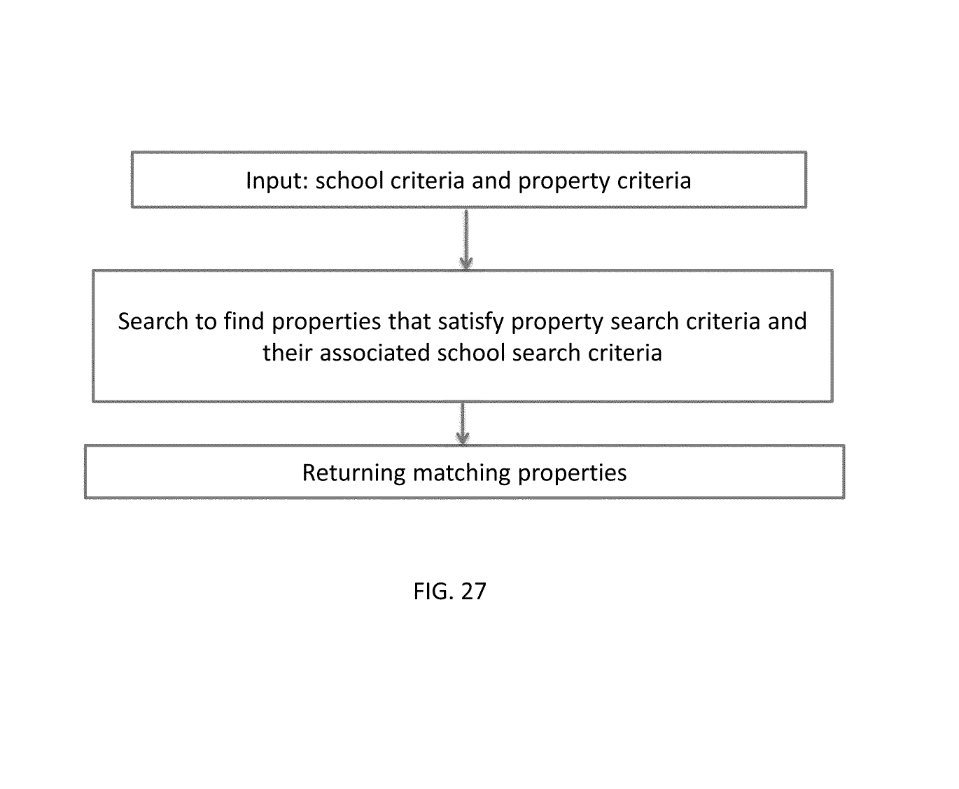

FIG. 27 is a simplified diagram of the pre-processing method for searching for properties with both school search criteria and property search criteria according to one embodiment of the present invention.

According to one embodiment, a computer-implemented method for use with a school boundary based school locator, includes geo-coding an address into geographic longitude/latitude and optionally selecting attending school candidates using school boundary rectangle verifying school attendance using the point-in-polygon algorithm.

According to another embodiment, a computer-implemented method for use with a school boundary based property search, includes searching for properties within the boundary of a selected school or an overlap of multiple selected schools and searching for properties with both school search criteria and property search criteria.

For example, searching for properties within the boundary of a selected school or an overlap of multiple selected schools can be implemented using one of the two methods: property-first method and pre-processing method. In another example, searching for properties with both school search criteria and property search criteria can be implemented using one of the three methods: property-first method and pre-processing method. In yet another example, the property-first method includes searching for properties with property search criteria and verifying attending schools of properties during the search. In yet another example, the pre-processing method includes computing attending schools for properties offline, storing the attendance information in database, and processing the online search as database SQL queries with predicate on school id and property search criteria. In yet another example, the property-first method includes searching properties with property search criteria and verifying their school search criteria on the fly during the search process. In yet another example, the school-first method includes searching for school overlapping areas satisfying school search criteria, searching for properties with property search criteria within each overlapping area, and removing properties that do not satisfy search criteria for all schools and duplicate properties. In yet another example, the pre-processing method includes computing attending schools for properties offline, storing the attendance information in database, and processing the search using database SQL queries with predicates on school search criteria and property search criteria.

According to yet another embodiment, a computer-implemented method for use with a school boundary digitization and integration process, includes collecting school boundary data from each school district, digitizing boundary files into a geographic data, and integrating school boundary geographic data from multiple school districts and other school information sources into one system.

According to at least one embodiment, a method for collecting and integrating school information includes collecting boundary data for one or more schools; determining one or more boundary lines based on at least the collected boundary data, each of the one or more boundary lines representing a border between a first area assigned to a first school selected from the one or more schools and a second area assigned to a second school selected from the one or more schools; digitizing the one or more boundary lines; collecting student performance data for the one or more schools, the collected student performance data including first student performance data for the first school and second student performance data for the second school; and storing the one or more digitized boundary lines and the student performance data in one or more data stores. The process for storing the one or more digitized boundary lines and the student performance data includes associating the one or more digitized boundary lines with at least the first school and the second school and associating the first student performance data with the first school and the second student performance data with the second school. For example, the method for collecting and integrating school information is implemented according to at least FIG. 3. In another example, the method for collecting and integrating school information is performed by at least one computer server.

In yet another example, the method further includes providing a search interface to allow one or more searches based on at least information associated with the stored one or more digitized boundary lines. In yet another example, the process for providing a search interface includes providing the search interface to allow the one or more searches based on at least information associated with the stored first student performance data. In yet another example, the student performance data include one or more Academic Performance Index (API) scores. In yet another example, the student performance data include ranking data for at least the first school and the second school. In yet another example, the student performance data include aggregate school scores for at least the first school and the second school. In yet another example, each of the one or more data stores includes a database. In yet another example, each of the one or more data stores includes a file. In yet another example, the method further includes identifying missing student performance data, estimating the missing student performance data based on at least information associated with the collected student performance data, and storing the missing student performance data. In yet another example, the process for storing the missing student performance data includes associating the missing student performance data with at least one of the one or more schools.

According to another embodiment, a method for creating one or more boundary lines includes identifying one or more sources of school boundary data; processing information associated with each of the one or more sources of school boundary data; identifying a format for each of the one or more sources of school boundary data; collecting boundary data for one or more schools from the one or more sources of school boundary data; determining one or more boundary lines based on at least the collected boundary data, each of the one or more boundary lines representing a border between a first area assigned to a first school selected from the one or more schools and a second area assigned to a second school selected from the one or more schools; digitizing the one or more boundary lines; resolving inconsistencies between the one or more digitized boundary lines; and storing the one or more digitized boundary lines in one or more data stores. The process for storing the one or more digitized boundary lines includes associating the one or more digitized boundary lines with at least the first school and the second school. For example, the method for creating one or more boundary lines is implemented according to at least FIG. 4. In another example, the method for creating or more boundary lines is performed by at least one computer server.

In yet another example, one or more boundary lines associated with the first school define one or more polygons. In yet another example, the process for determining one or more boundary lines includes aligning one or more of the one or more boundary lines with one or more geographic landmarks. In yet another example, the boundary lines are represented using at least one or more geolocations. In yet another example, the method further includes determining a bounding rectangle that encloses at least the first area and storing the bounding rectangle in the one or more data stores. In yet another example, the process for storing the bounding rectangle includes associating the bounding rectangle with the first school. In yet another example, the process for resolving inconsistencies between the one or more digitized boundary lines includes identifying one or more first regions based on at least information associated with one or more first boundary lines selected from the one or more boundary lines, the one or more first boundary lines being associated with the first school and determined using a first source selected from the one or more sources of school boundary data; identifying one or more second regions based on at least information associated with one or more second boundary lines selected from the one or more boundary lines, the one or more second boundary lines being associated with the first school and determined using a second source selected from the one or more sources of school boundary data; calculating one or more differences between the one or more first regions and the one or more second regions; processing the one or more differences and a predetermined threshold; and if the one or more differences are greater than the predetermined threshold, removing the one or more first boundary lines determined using the first source from the one or more boundary lines. In yet another example, the predetermined threshold is 50 square feet. In yet another example, the format of each of the one or more sources of school boundary data includes one selected from a group consisting of a street attendance directory, an online school locator, and a boundary map.

In yet another example, a first source of school boundary data includes a street attendance directory and the process for determining one or more boundary lines includes selecting a first attending school record from the street attendance directory, the first attending school record matching one or more first addresses to a first school, the one or more first addresses including at least a first property address; receiving a second attending school record from the street attendance directory, the second attending school record matching one or more second addresses to a second school, the one or more second addresses including at least a second property address; converting at least the first property address to a first geolocation; converting at least the second property address to a second geolocation; assigning a first symbol to the first school; assigning a second symbol to the second school; displaying the first symbol in a boundary editor at at least a first screen position based on at least information associated with the first geolocation and displaying the second symbol in the boundary editor at at least a second screen position based on at least information associated with the second geolocation; and locating the one or more boundary lines between one or more displays of the first symbol and one or more displays of the second symbol. In yet another example, the process for determining one or more boundary lines further includes generating an address format converter for converting the one or more first addresses to a uniform address format and converting the one or more first addresses to a uniform address format.

In yet another example, a first source of school boundary data includes an online school locator and the process for determining one or more boundary lines includes collecting one or more addresses including a first address and a second address; querying the online school locator using an interface wrapper based on at least information associated with the first address; querying the online school locator using an interface wrapper based on at least information associated with the second address; receiving, from the online school locator, information associated with a first school based on at least information associated with the first address; receiving, from the online school locator, information associated with a second school based on at least information associated with the second address; converting the first address to a first geolocation; converting the second address to a second geolocation; assigning a first symbol to the first school; assigning a second symbol to the second school; displaying the first symbol in a boundary editor at at least a first screen position based on at least information associated with the first geolocation and displaying the second symbol in the boundary editor at at least a second screen position based on at least information associated with the second geolocation; and locating the one or more boundary lines between one or more displays of the first symbol and one or more displays of the second symbol. In yet another example, the process for determining one or more boundary lines further includes generating the interface wrapper.

In yet another example, a first source of school boundary data includes a boundary map with one or more school boundaries and the process for determining one or more boundary lines includes loading the boundary map into a boundary editor; loading a street map into the boundary editor, the street map corresponding to the boundary map; aligning the boundary map and the corresponding street map; adjusting at least a scale for the boundary map or the corresponding street map; and converting the one or more school boundaries on the boundary map into the one or more boundary lines on the corresponding street map. In yet another example, the process for determining one or more boundary lines further includes loading one or more previously determined boundary lines in the boundary editor.

According to yet another embodiment, a method for collecting school data includes collecting first student performance data associated with a school from a first data source; collecting second student performance data associated with the school from a second data source; processing information associated with the first student performance data and the second student performance data; processing the first student performance data and the second student performance data; if the first student performance data is not consistent with the second student performance data, generating third student performance data based on at least information associated with the second student performance data; if the first student performance data is consistent with the second student performance data, generating the third student performance data based on at least information associated with the first student performance data and the second student performance data; determining a geolocation of the school; and storing the third student performance data and the geolocation in one or more data stores. The process for storing the third student performance data and the geolocation includes associating the third student performance data with the school and associating the geolocation with the school. For example, the method for collecting school data is implemented according to at least FIG. 10. In another example, the method for collecting school data is performed by at least one computer server.

In yet another example, the third student performance data include one or more Academic Performance Index (API) scores. In yet another example, the third student performance data include ranking data for the school. In yet another example, the third student performance data include aggregate school scores for the school. In yet another example, the method further includes identifying missing student performance data, estimating the missing student performance data based on at least information associated with the third student performance data, and storing the missing student performance data. The process for storing the missing student performance data includes associating the missing student performance data with at least the school. In yet another example, the process for estimating the missing student performance data includes using a function selected from a group consisting of an interpolation function and an extrapolation function.

According to yet another embodiment, a method for collecting and storing property data includes accessing a first property data source using a first interface; requesting at least first property data correspond to a first property from the first property data source; determining a geolocation for the first property based on at least information associated with the first property data; accessing one or more first data stores; receiving, from the one or more first data stores, information associated with one or more attending schools related to the geolocation; and storing the first property data and the one or more attending schools in one or more second data stores. The process for storing the first property data and the one or more attending schools includes associating the one or more attending schools with the first property. For example, the method for collecting and storing property data is implemented according to at least FIG. 11. In another example, the method for collecting and storing property data is performed by at least one computer server.

In yet another example, the one or more first data stores and the one or more second data stores are different. In yet another example, the method further includes determining the one or more attending schools based on at least information associated with the geolocation, the one or more attending schools including a first school. The process for determining one or more attending schools includes receiving, from the one or more first data stores, information associated with one or more boundary lines associated with the first school; determining an attendance area for the first school based on at least information associated with the one or more boundary lines; processing the geolocation and the attendance area; and determining if the geolocation is within the attendance area. In yet another example, the process for determining one or more attending schools further includes receiving, from the one or more first data stores, a bounding rectangle associated with the first school; processing the geolocation and the bounding rectangle; and determining if the geolocation is within the bounding rectangle. In yet another example, the method further includes requesting, from the one or more first data stores, first student performance data for the one or more attending schools; determining an aggregate school score for at least the first property based on at least information associated with the first student performance data; and storing the aggregate school score in the one or more second data stores. The process for storing the aggregate school score in the one or more second data stores includes associating the aggregate school score with the first property In yet another example, the process for determining an aggregate school score for at least the first property includes computing a weighted sum of the first student performance data.

In yet another example, the process for determining an aggregate school score for at least the first property includes requesting, from the one or more first data stores, one or more first schools based on at least information associated with the geolocation; requesting, from the one or more first data stores, second student performance data for the one or more first schools; initializing the aggregate school score to a first predetermined constant; determining, for each first attending school selected from the one or more attending schools, a partial aggregate score; and adding the partial aggregate score weighted by a weighting constant to the aggregate school score. The process for determining, for each first attending school selected from the one or more attending schools, a partial aggregate score includes initializing the partial aggregate score to a second predetermined constant; requesting, from the one or more first data stores, information associated with one or more second schools for each of the one or more first schools; the one or more second schools including a second school; requesting, from the one or more first data stores, third student performance data based on at least information associated with the second school; processing the second student performance data and the third student performance data; and adding a corresponding coefficient to the partial aggregate score if the second student performance data is greater than the third student performance data. In yet another example, the second predetermined constant is zero. In yet another example, the second predetermined constant is not zero. In yet another example, the method further includes accessing a second property data source using a second interface; requesting at least second property data corresponding to the first property from the second property data source; processing a first property identifier based on information associated with the first property data and a second property identifier based on information associated with the second property data; if the first property identifier and the second property identifier are the same, merging the second property data with the first property data; and if the first property identifier and the second property identified are different, processing the first property data and the second property data and merging the second property data with the first property data if the first property and the second property are the same.

According to yet another embodiment, a method for searching for a school includes receiving, by a search interface, one or more school search parameters and one or more geographic search parameters, the one or more school search parameters including at least one or more student performance thresholds; processing information associated with the one or more school search parameters and the one or more geographic search parameters; accessing one or more data stores; requesting, from the one or more data stores, at least student performance data for a school; processing the student performance data and the one or more student performance thresholds; requesting, from the one or more data stores, at least one or more attendance boundaries for the school; processing the one or more attendance boundaries and the one or more geographic search parameters; and generating a search result identifying at least data associated with the school if the one or more attendance boundaries satisfy the one or more geographic search parameters and the student performance data meets or exceeds the one or more student performance thresholds. For example, the method for searching for a school is implemented according to at least FIG. 13. In another example, the method for searching for a school is performed by at least one computer server.

In yet another example, student performance data include one or more Academic Performance Index (API) scores. In yet another example, the student performance data include ranking data for the school In yet another example, the student performance data includes one or more aggregate school scores. In yet another example, the process for processing the one or more attendance boundaries and the one or more geographic search parameters includes identifying a first region associated with the one or more attendance boundaries, identifying a second region associated with the one or more geographic search parameters, and processing the first region and the second region to determine if the first region and the second region share a third region at least as large as a predetermined threshold. In yet another example, the predetermined threshold is 50 square feet.

According to yet another embodiment, a method for searching for a property includes receiving, by a search interface, one or more school search parameters, one or more geographic search parameters, and one or more property search parameters, the one or more school search parameters including at least one or more student performance thresholds; processing information associated with the one or more school search parameters, the one or more geographic parameters, and the one or more property search parameters; accessing one or more data stores; requesting, from the one or more data stores, at least student performance data for a school; processing the student performance data and the one or more student performance thresholds; requesting, from the one or more data stores, at least one or more attendance boundaries for the school; requesting, from the one or more data stores, at least property location data and property characteristic data corresponding to a property, the property location data including an address corresponding to the property; processing information associated with the property characteristic data and the one or more property search parameters; processing information associated with the address and the one or more geographic search parameters; processing information associated with the address and the one or more attendance boundaries; and generating a search result identifying at least data associated with the property if the student performance data meets or exceeds the one or more student performance thresholds, the address satisfies the geographic search parameters' the address is within the one or more attendance boundaries, and the first property satisfies the one or more property search parameters. For example, the method for searching for a property is implemented according to at least FIG. 14. In another example, the method for searching for a property is performed by at least one computer server.

In yet another example, the method further includes displaying the search result on a display screen. In yet another example, the process for displaying the search result includes displaying a map, displaying at least a first icon representing the address of the property, determining a location associated with the school, and displaying at least a second icon representing the location of the school. In yet another example, the method further includes determining a first area based on at least information associated with the one or more attendance boundaries, determining a second area based on at least information associated with the geographic search parameters, and processing the first area and the second area to determine if the first are and the second area overlap. In yet another example, the method further includes determining an attendance area based on at least information associated with the one or more attendance boundaries, determining a geolocation using information associated with at least the address, and determining whether the geolocation is within the attendance area. In yet another example, the method further includes requesting, from the one or more data stores, a bounding rectangle associated with the school and determining whether the geolocation is within the bounding rectangle. In yet another example, the student performance data include one or more Academic Performance Index (API) scores. In yet another example, the student performance data include ranking data for the school. In yet another example, the student performance data includes one or more aggregate school scores.

According to yet another embodiment, a method for searching for a property includes receiving, by a search interface, a target school and property search parameters; processing information associated with the target school and the one or more property search parameters; accessing one or more data stores; requesting, from the one or more data stores, one or more attendance boundaries for the target school; requesting, from the one or more data stores, at least property location data and property characteristic data corresponding to a property, the property location data including an address corresponding to the property; processing information associated with the property characteristic data and the one or more property search parameters; processing information associated with the address and the one or more attendance boundaries; and generating a search result identifying at least data associated with the property if the address is within at least the one or more first attendance boundaries and the property satisfies the one or more property search parameters. For example, the method for searching for a property is implemented according to at least FIG. 16. In another example, the method for searching for a property is performed by at least one computer server.

In yet another example, the method further includes determining a first area based on at least information associated with the one or more attendance boundaries, determining a second area based on at least information associated with the geographic search parameters, and processing the first area and the second area to determine if the first area and the second area overlap. In yet another example, the method further includes determining an attendance area based on at least information associated with the one or more attendance boundaries, determining a geolocation using information associated with at least the address, and determining whether the geolocation is within the attendance area. In yet another example, the method further includes requesting, from the one or more data stores, a bounding rectangle associated with the target school and determining whether the geolocation is within the bounding rectangle.

According to yet another embodiment, a method for searching for a property includes receiving, by a search interface, a first target school, a second target school, and property search parameters; processing information associated with the first target school, the second target school, and the one or more property search parameters; accessing one or more data stores; requesting, from the one or more data stores, one or more first attendance boundaries for the first target school; requesting, from the one or more data stores, one or more second attendance boundaries for the second target school; requesting, from the one or more data stores, at least property location data and property characteristic data corresponding to a property, the property location data including an address corresponding to the property; processing information associated with the property characteristic data and the one or more property search parameters; processing information associated with the address and the one or more first attendance boundaries; processing information associated with the address and the one or more second attendance boundaries; and generating a search result identifying at least data associated with the property if the address is within the one or more first attendance boundaries, the address is within the one or more second attendance boundaries, and the first property satisfies the one or more property search parameters. For example, the method for searching for a property is implemented according to at least FIG. 16. In another example, the method for searching for a property is performed by at least one computer server.

According to yet another embodiment, a method for identifying one or more school combinations includes receiving, by a search interface, a first school; processing information associated with the first school; accessing one or more data stores; requesting, from the one or more data stores, one or more first attendance boundaries for the first school; requesting, from the one or more data stores, one or more second attendance boundaries for at least a second school; determining a first area based on at least information associated with the first attendance boundaries; determining a second area based on at least information associated with the second attendance boundaries; processing the first area and the second area; identifying a school combination if the first area and the second area overlap; and generating a search result identifying at least data associated with the school combination. For example, the method for identifying one or more school combinations is implemented according to at least FIG. 18. In another example, the method for identifying one or more school combinations is performed by at least one computer server.

In yet another example, the method further includes requesting, from the one or more data stores, at least information associated with a third school of a first level; requesting, from the one or more data stores, at least information associated with a fourth school of a second level; requesting, from the one or more data stores, at least information associated with a fifth school of a third level; requesting, from the one or more data stores, information associated with one or more third attendance boundaries associated with the third school; requesting, from the one or more data stores, information associated with one or more fourth attendance boundaries associated with the fourth school; requesting, from the one or more data stores, information associated with one or more fifth attendance boundaries associated with the third school; determining a third area based on information associated with the one or more third attendance boundaries; determining a fourth area based on information associated with the one or more fourth attendance boundaries; determining a fifth area based on information associated with the one or more fifth attendance boundaries; and processing the third area, the fourth area, and the fifth area to determine if they share a sixth area at least as large as a predetermined threshold. In yet another example, the predetermined threshold is 50 square feet. In yet another example, the first school is selected from a group consisting of the third school, the fourth school, and the fifth school. In yet another example, the method further includes requesting, from the one or more data stores, a school district associated with the first school. The third school is associated with the school district, the fourth school is associated with the school district, and the fifth school is associated with the school district.

According to yet another embodiment, a computer program product includes a computer readable medium including instructions for collecting and integrating school information. The computer readable medium includes one or more instructions for collecting boundary data for one or more schools; one or more instructions for determining one or more boundary lines based on at least the collected boundary data, each of the one or more boundary lines representing a border between a first area assigned to a first school selected from the one or more schools and a second area assigned to a second school selected from the one or more schools; one or more instructions for digitizing the one or more boundary lines; one or more instructions for collecting student performance data for the one or more schools, the collected student performance data one or more instructions for including first student performance data for the first school and second student performance data for the second school; and one or more instructions for storing the one or more digitized boundary lines and the student performance data in one or more data stores. The one or more instructions for storing the one or more digitized boundary lines and the student performance data includes one or more instructions for associating the one or more digitized boundary lines with at least the first school and the second school and one or more instructions for associating the first student performance data with the first school and the second student performance data with the second school. For example, the computer program product including a computer readable medium including instructions for collecting and integrating school information is implemented according to at least FIG. 3.

According to yet another embodiment, a computer program product includes a computer readable medium including instructions for creating one or more boundary lines. The computer readable medium includes one or more instructions for identifying one or more sources of school boundary data; one or more instructions for processing information associated with each of the one or more sources of school boundary data; one or more instructions for identifying a format for each of the one or more sources of school boundary data; one or more instructions for collecting boundary data for one or more schools from the one or more sources of school boundary data; one or more instructions for determining one or more boundary lines based on at least the collected boundary data, each of the one or more boundary lines representing a border between a first area assigned to a first school selected from the one or more schools and a second area assigned to a second school selected from the one or more schools; one or more instructions for digitizing the one or more boundary lines; one or more instructions for resolving inconsistencies between the one or more digitized boundary lines; and one or more instructions for storing the one or more digitized boundary lines in one or more data stores. The one or more instructions for storing the one or more digitized boundary lines includes one or more instructions for associating the one or more digitized boundary lines with at least the first school and the second school. For example, the computer program product including a computer readable medium including instructions for creating one or more boundary lines is implemented according to at least FIG. 4.

According to yet another embodiment, a computer program product includes a computer readable medium including instructions for collecting school data. The computer readable medium includes one or more instructions for collecting first student performance data associated with a school from a first data source; one or more instructions for collecting second student performance data associated with the school from a second data source; one or more instructions for processing information associated with the first student performance data and the second student performance data; one or more instructions for processing the first student performance data and the second student performance data; if the first student performance data is not consistent with the second student performance data, one or more instructions for generating third student performance data based on at least information associated with the second student performance data; if the first student performance data is consistent with the second student performance data, one or more instructions for generating the third student performance data based on at least information associated with the first student performance data and the second student performance data; one or more instructions for determining a geolocation of the school; and one or more instructions for storing the third student performance data and the geolocation in one or more data stores. The one or more instructions for storing the third student performance data and the geolocation includes one or more instructions for associating the third student performance data with the school and one or more instructions for associating the geolocation with the school. For example, the computer program product including a computer readable medium including instructions for collecting school data is implemented according to at least FIG. 10.

According to yet another embodiment, a computer program product includes a computer readable medium including instructions for collecting and storing property data. The computer readable medium includes one or more instructions for accessing a first property data source using a first interface; one or more instructions for requesting at least first property data correspond to a first property from the first property data source; one or more instructions for determining a geolocation for the first property based on at least information associated with the first property data; one or more instructions for accessing one or more first data stores; one or more instructions for receiving, from the one or more first data stores, information associated with one or more attending schools related to the geolocation; and one or more instructions for storing the first property data and the one or more attending schools in one or more second data stores. The one or more instructions for storing the first property data and the one or more attending schools includes one or more instructions for associating the one or more attending schools with the first property. For example, the computer program product including a computer readable medium including instructions for collecting and storing property data is implemented according to at least FIG. 11.

According to yet another embodiment, a computer program product includes a computer readable medium including instructions for searching for a school. The computer readable medium includes one or more instructions for receiving, by a search interface, one or more school search parameters and one or more geographic search parameters, the one or more school search parameters including at least one or more student performance thresholds; one or more instructions for processing information associated with the one or more school search parameters and the one or more geographic search parameters; one or more instructions for accessing one or more data stores; requesting, from the one or more data stores, at least student performance data for a school; one or more instructions for processing the student performance data and the one or more student performance thresholds; one or more instructions for requesting, from the one or more data stores, at least one or more attendance boundaries for the school; one or more instructions for processing the one or more attendance boundaries and the one or more geographic search parameters; and one or more instructions for generating a search result identifying at least data associated with the school if the one or more attendance boundaries satisfy the one or more geographic search parameters and the student performance data meets or exceeds the one or more student performance thresholds. For example, a computer program product including a computer readable medium including instructions for searching for a school is implemented according to at least FIG. 13.

According to yet another embodiment, a computer program product includes a computer readable medium including instructions for searching for a property. The computer readable medium includes one or more instructions for receiving, by a search interface, one or more school search parameters, one or more geographic search parameters, and one or more property search parameters, the one or more school search parameters including at least one or more student performance thresholds; one or more instructions for processing information associated with the one or more school search parameters, the one or more geographic parameters, and the one or more property search parameters; one or more instructions for accessing one or more data stores; one or more instructions for requesting, from the one or more data stores, at least student performance data for a school; one or more instructions for processing the student performance data and the one or more student performance thresholds; one or more instructions for requesting, from the one or more data stores, at least one or more attendance boundaries for the school; one or more instructions for requesting, from the one or more data stores, at least property location data and property characteristic data corresponding to a property, the property location data including an address corresponding to the property; one or more instructions for processing information associated with the property characteristic data and the one or more property search parameters; one or more instructions for processing information associated with the address and the one or more geographic search parameters; one or more instructions for processing information associated with the address and the one or more attendance boundaries; and one or more instructions for generating a search result identifying at least data associated with the property if the student performance data meets or exceeds the one or more student performance thresholds, the address satisfies the geographic search parameters' the address is within the one or more attendance boundaries, and the first property satisfies the one or more property search parameters. For example, the computer program product including a computer readable medium including instructions for searching for a property is implemented according to at least FIG. 14.

According to yet another embodiment, a computer program product includes a computer readable medium including instructions for searching for a property. The computer readable medium includes one or more instructions for receiving, by a search interface, a target school and property search parameters; one or more instructions for processing information associated with the target school and the one or more property search parameters; one or more instructions for accessing one or more data stores; one or more instructions for requesting, from the one or more data stores, one or more attendance boundaries for the target school; one or more instructions for requesting, from the one or more data stores, at least property location data and property characteristic data corresponding to a property, the property location data including an address corresponding to the property; one or more instructions for processing information associated with the property characteristic data and the one or more property search parameters; one or more instructions for processing information associated with the address and the one or more attendance boundaries; and one or more instructions for generating a search result identifying at least data associated with the property if the address is within at least the one or more first attendance boundaries and the property satisfies the one or more property search parameters. For example, the computer program product including a computer readable medium including instructions for searching for a property is implemented according to at least FIG. 16.

According to yet another embodiment, a computer program product includes a computer readable medium including instructions for searching for a property. The computer readable medium includes one or more instructions for receiving, by a search interface, a first target school, a second target school, and property search parameters; one or more instructions for processing information associated with the first target school, the second target school, and the one or more property search parameters; one or more instructions for accessing one or more data stores; one or more instructions for requesting, from the one or more data stores, one or more first attendance boundaries for the first target school; one or more instructions for requesting, from the one or more data stores, one or more second attendance boundaries for the second target school; one or more instructions for requesting, from the one or more data stores, at least property location data and property characteristic data corresponding to a property, the property location data including an address corresponding to the property; one or more instructions for processing information associated with the property characteristic data and the one or more property search parameters; one or more instructions for processing information associated with the address and the one or more first attendance boundaries; one or more instructions for processing information associated with the address and the one or more second attendance boundaries; and one or more instructions for generating a search result identifying at least data associated with the property if the address is within the one or more first attendance boundaries, the address is within the one or more second attendance boundaries, and the first property satisfies the one or more property search parameters. For example, the computer program product including a computer readable medium including instructions for searching for a property is implemented according to at least FIG. 16.

According to yet another embodiment, a computer program product includes a computer readable medium including instructions for identifying one or more school combinations. The computer readable medium includes one or more instructions for receiving, by a search interface, a first school; one or more instructions for processing information associated with the first school; accessing one or more data stores; requesting, from the one or more data stores, one or more first attendance boundaries for the first school; one or more instructions for requesting, from the one or more data stores, one or more second attendance boundaries for at least a second school; one or more instructions for determining a first area based on at least information associated with the first attendance boundaries; determining a second area based on at least information associated with the second attendance boundaries; one or more instructions for processing the first area and the second area; one or more instructions for identifying a school combination if the first area and the second area overlap; and one or more instructions for generating a search result identifying at least data associated with the school combination. For example, the computer program product including a computer readable medium including instructions for identifying one or more school combinations is implemented according to at least FIG. 18.

Although specific embodiments of the present invention have been described, it will be understood by those of skill in the art that there are other embodiments that are equivalent to the described embodiments. For example, various embodiments and/or examples of the present invention can be combined. Accordingly, it is to be understood that the invention is not to be limited by the specific illustrated embodiments, but only by the scope of the appended claims.

What is claimed is:

1. A method for collecting and integrating school information, the method comprising:
collecting boundary data for one or more schools;
determining one or more boundary lines based on at least the collected boundary data, each of the one or more boundary lines representing a border between a first area assigned to a first school selected from the one or more schools and a second area assigned to a second school selected from the one or more schools;
digitizing the one or more boundary lines;
collecting student performance data for the one or more schools, the collected student performance data including first student performance data for the first school and second student performance data for the second school; and
storing the one or more digitized boundary lines and the student performance data in one or more data stores;
wherein the process for storing the one or more digitized boundary lines and the student performance data includes:
associating the one or more digitized boundary lines with at least the first school and the second school; and
associating the first student performance data with the first school and the second student performance data with the second school.

2. The method of claim 1, and further comprising providing a search interface to allow one or more searches based on at least information associated with the stored one or more digitized boundary lines.

3. The method of claim 2 wherein the process for providing a search interface includes providing the search interface to allow the one or more searches based on at least information associated with the stored first student performance data.

4. The method of claim 1 wherein the student performance data include one or more Academic Performance Index (API) scores.

5. The method of claim 1 wherein the student performance data include ranking data for at least the first school and the second school.

6. The method of claim 1 wherein the student performance data include aggregate school scores for at least the first school and the second school.

7. The method of claim 1 wherein each of the one or more data stores includes a database.

8. The method of claim 1 wherein each of the one or more data stores includes a file.

9. The method of claim 1, and further comprising:
identifying missing student performance data;
estimating the missing student performance data based on at least information associated with the collected student performance data; and
storing the missing student performance data;
wherein the process for storing the missing student performance data includes associating the missing student performance data with at least one of the one or more schools.

10. A method for creating one or more boundary lines, the method comprising:
identifying one or more sources of school boundary data;
processing information associated with each of the one or more sources of school boundary data;
identifying a format for each of the one or more sources of school boundary data;
collecting boundary data for one or more schools from the one or more sources of school boundary data;
determining one or more boundary lines based on at least the collected boundary data, each of the one or more boundary lines representing a border between a first area assigned to a first school selected from the one or more schools and a second area assigned to a second school selected from the one or more schools;
digitizing the one or more boundary lines;
resolving inconsistencies between the one or more digitized boundary lines; and
storing the one or more digitized boundary lines in one or more data stores;
wherein the process for storing the one or more digitized boundary lines includes associating the one or more digitized boundary lines with at least the first school and the second school.

11. The method of claim 10 wherein the one or more boundary lines associated with the first school define one or more polygons.

12. The method of claim 10 wherein the process for determining one or more boundary lines includes aligning one or more of the one or more boundary lines with one or more geographic landmarks.

13. The method of claim 10 wherein the boundary lines are represented using at least one or more geolocations.

14. The method of claim 10, and further comprising:
determining a bounding rectangle that encloses at least the first area; and
storing the bounding rectangle in the one or more data stores;
wherein the process for storing the bounding rectangle includes associating the bounding rectangle with the first school.

15. The method of claim 10 wherein the process for resolving inconsistencies between the one or more digitized boundary lines includes:
identifying one or more first regions based on at least information associated with one or more first boundary lines selected from the one or more boundary lines, the one or more first boundary lines being associated with the first school and determined using a first source selected from the one or more sources of school boundary data;
identifying one or more second regions based on at least information associated with one or more second boundary lines selected from the one or more boundary lines, the one or more second boundary lines being associated with the first school and determined using a second source selected from the one or more sources of school boundary data;
calculating one or more differences between the one or more first regions and the one or more second regions;
processing the one or more differences and a predetermined threshold; and
if the one or more differences are greater than the predetermined threshold, removing the one or more first boundary lines determined using the first source from the one or more boundary lines.

16. The method of claim 15 wherein the predetermined threshold is 50 square feet.

17. The method of claim 10 wherein the format of each of the one or more sources of school boundary data includes one selected from a group consisting of a street attendance directory, an online school locator, and a boundary map.

18. The method of claim 10 wherein:
a first source of school boundary data includes a street attendance directory; and
the process for determining one or more boundary lines includes:
selecting a first attending school record from the street attendance directory, the first attending school record matching one or more first addresses to a first school, the one or more first addresses including at least a first property address;
receiving a second attending school record from the street attendance directory, the second attending school record matching one or more second addresses to a second school, the one or more second addresses including at least a second property address;
converting at least the first property address to a first geolocation;
converting at least the second property address to a second geolocation;
assigning a first symbol to the first school;
assigning a second symbol to the second school;
displaying the first symbol in a boundary editor at at least a first screen position based on at least information associated with the first geolocation and displaying the second symbol in the boundary editor at at least a second screen position based on at least information associated with the second geolocation; and
locating the one or more boundary lines between one or more displays of the first symbol and one or more displays of the second symbol.

19. The method of claim 18 wherein the process for determining one or more boundary lines further includes:
generating an address format converter for converting the one or more first addresses to a uniform address format; and
converting the one or more first addresses to a uniform address format.

20. The method of claim 10 wherein:
a first source of school boundary data includes an online school locator; and
the process for determining one or more boundary lines includes:
collecting one or more addresses including a first address and a second address;
querying the online school locator using an interface wrapper based on at least information associated with the first address;
querying the online school locator using an interface wrapper based on at least information associated with the second address;
receiving, from the online school locator, information associated with a first school based on at least information associated with the first address;
receiving, from the online school locator, information associated with a second school based on at least information associated with the second address;
converting the first address to a first geolocation;
converting the second address to a second geolocation;
assigning a first symbol to the first school;
assigning a second symbol to the second school;
displaying the first symbol in a boundary editor at at least a first screen position based on at least information associated with the first geolocation and displaying the second symbol in the boundary editor at at least a second screen position based on at least information associated with the second geolocation; and
locating the one or more boundary lines between one or more displays of the first symbol and one or more displays of the second symbol.

21. The method of claim 20 wherein the process for determining one or more boundary lines further includes generating the interface wrapper.

22. The method of claim 10 wherein:
a first source of school boundary data includes a boundary map with one or more school boundaries; and
the process for determining one or more boundary lines includes:
loading the boundary map into a boundary editor;
loading a street map into the boundary editor, the street map corresponding to the boundary map;
aligning the boundary map and the corresponding street map;
adjusting at least a scale for the boundary map or the corresponding street map; and
converting the one or more school boundaries on the boundary map into the one or more boundary lines on the corresponding street map.

23. The method of claim 22 wherein the process for determining one or more boundary lines further includes loading one or more previously determined boundary lines in the boundary editor.

24. A method for collecting school data, the method comprising:
collecting first student performance data associated with a school from a first data source;
collecting second student performance data associated with the school from a second data source;
processing information associated with the first student performance data and the second student performance data;
processing the first student performance data and the second student performance data;
if the first student performance data is not consistent with the second student performance data, generating third student performance data based on at least information associated with the second student performance data;
if the first student performance data is consistent with the second student performance data, generating the third student performance data based on at least information associated with the first student performance data and the second student performance data;
determining a geolocation of the school; and
storing the third student performance data and the geolocation in one or more data stores;
wherein the process for storing the third student performance data and the geolocation includes:
associating the third student performance data with the school; and
associating the geolocation with the school.

25. The method of claim 24 wherein the third student performance data include one or more Academic Performance Index (API) scores.

26. The method of claim 24 wherein the third student performance data include ranking data for the school.

27. The method of claim 24 wherein the third student performance data include aggregate school scores for the school.

28. The method of claim 24, and further comprising:
identifying missing student performance data;
estimating the missing student performance data based on at least information associated with the third student performance data; and
storing the missing student performance data;
wherein the process for storing the missing student performance data includes associating the missing student performance data with at least the school.

29. The method of claim 28 wherein the process for estimating the missing student performance data includes using a function selected from a group consisting of an interpolation function and an extrapolation function.

30. A method for collecting and storing property data, the method comprising:
accessing a first property data source using a first interface;
requesting at least first property data correspond to a first property from the first property data source;
determining a geolocation for the first property based on at least information associated with the first property data;
accessing one or more first data stores;
receiving, from the one or more first data stores, information associated with one or more attending schools related to the geolocation; and
storing the first property data and the one or more attending schools in one or more second data stores;
wherein the process for storing the first property data and the one or more attending schools includes associating the one or more attending schools with the first property.

31. The method of claim 30 wherein the one or more first data stores and the one or more second data stores are different.

32. The method of claim 30, and further comprising:
determining the one or more attending schools based on at least information associated with the geolocation, the one or more attending schools including a first school;
wherein the process for determining one or more attending schools includes:
receiving, from the one or more first data stores, information associated with one or more boundary lines associated with the first school;
determining an attendance area for the first school based on at least information associated with the one or more boundary lines;
processing the geolocation and the attendance area; and
determining if the geolocation is within the attendance area.

33. The method of claim 32 wherein the process for determining one or more attending schools further includes:
receiving, from the one or more first data stores, a bounding rectangle associated with the first school;
processing the geolocation and the bounding rectangle; and
determining if the geolocation is within the bounding rectangle.

34. The method of claim 30, and further comprising:
requesting, from the one or more first data stores, first student performance data for the one or more attending schools;
determining an aggregate school score for at least the first property based on at least information associated with the first student performance data; and
storing the aggregate school score in the one or more second data stores;
wherein the process for storing the aggregate school score in the one or more second data stores includes associating the aggregate school score with the first property.

35. The method of claim 34 wherein the process for determining an aggregate school score for at least the first property includes computing a weighted sum of the first student performance data.

36. The method of claim 34 wherein the process for determining an aggregate school score for at least the first property includes:
requesting, from the one or more first data stores, one or more first schools based on at least information associated with the geolocation;
requesting, from the one or more first data stores, second student performance data for the one or more first schools;
initializing the aggregate school score to a first predetermined constant;
determining, for each first attending school selected from the one or more attending schools, a partial aggregate score; and
adding the partial aggregate score weighted by a weighting constant to the aggregate school score;
wherein the process for determining, for each first attending school selected from the one or more attending schools, a partial aggregate score includes:
initializing the partial aggregate score to a second predetermined constant;
requesting, from the one or more first data stores, information associated with one or more second schools for each of the one or more first schools; the one or more second schools including a second school;
requesting, from the one or more first data stores, third student performance data based on at least information associated with the second school;
processing the second student performance data and the third student performance data; and
adding a corresponding coefficient to the partial aggregate score if the second student performance data is greater than the third student performance data.

37. The method of claim 36 wherein the second predetermined constant is zero.

38. The method of claim 36 wherein the second predetermined constant is not zero.

39. The method of claim 30, and further comprising:
accessing a second property data source using a second interface;
requesting at least second property data corresponding to the first property from the second property data source;
processing a first property identifier based on information associated with the first property data and a second property identifier based on information associated with the second property data;
if the first property identifier and the second property identifier are the same, merging the second property data with the first property data; and
if the first property identifier and the second property identified are different, processing the first property data and the second property data and merging the second property data with the first property data if the first property and the second property are the same.

40. A method for searching for a school, the method comprising:
receiving, by a search interface, one or more school search parameters and one or more geographic search parameters, the one or more school search parameters including at least one or more student performance thresholds;
processing information associated with the one or more school search parameters and the one or more geographic search parameters;
accessing one or more data stores;
requesting, from the one or more data stores, at least student performance data for a school;
processing the student performance data and the one or more student performance thresholds;
requesting, from the one or more data stores, at least one or more attendance boundaries for the school;
processing the one or more attendance boundaries and the one or more geographic search parameters; and
generating a search result identifying at least data associated with the school if the one or more attendance boundaries satisfy the one or more geographic search parameters and the student performance data meets or exceeds the one or more student performance thresholds.

41. The method of claim 40 wherein the student performance data include one or more Academic Performance Index (API) scores.

42. The method of claim 40 wherein the student performance data include ranking data for the school.

43. The method of claim 40 wherein the student performance data includes one or more aggregate school scores.

44. The method of claim 40 wherein the process for processing the one or more attendance boundaries and the one or more geographic search parameters includes:
identifying a first region associated with the one or more attendance boundaries;
identifying a second region associated with the one or more geographic search parameters; and
processing the first region and the second region to determine if the first region and the second region share a third region at least as large as a predetermined threshold.

45. The method of claim 44 wherein the predetermined threshold is 50 square feet.

46. A method for searching for a property, the method comprising:
receiving, by a search interface, one or more school search parameters, one or more geographic search parameters, and one or more property search parameters, the one or more school search parameters including at least one or more student performance thresholds;
processing information associated with the one or more school search parameters, the one or more geographic parameters, and the one or more property search parameters;
accessing one or more data stores;
requesting, from the one or more data stores, at least student performance data for a school;
processing the student performance data and the one or more student performance thresholds;
requesting, from the one or more data stores, at least one or more attendance boundaries for the school;
requesting, from the one or more data stores, at least property location data and property characteristic data corresponding to a property, the property location data including an address corresponding to the property;
processing information associated with the property characteristic data and the one or more property search parameters;
processing information associated with the address and the one or more geographic search parameters;
processing information associated with the address and the one or more attendance boundaries; and
generating a search result identifying at least data associated with the property if the student performance data meets or exceeds the one or more student performance thresholds, the address satisfies the geographic search parameters' the address is within the one or more attendance boundaries, and the first property satisfies the one or more property search parameters.

47. The method of claim 46, and further comprising displaying the search result on a display screen.

48. The method of claim 47 wherein the process for displaying the search result includes:
displaying a map;
displaying at least a first icon representing the address of the property;
determining a location associated with the school; and
displaying at least a second icon representing the location of the school.

49. The method of claim 46, and further comprising:
determining a first area based on at least information associated with the one or more attendance boundaries;
determining a second area based on at least information associated with the geographic search parameters; and
processing the first area and the second area to determine if the first are and the second area overlap.

50. The method of claim 46, and further comprising:
determining an attendance area based on at least information associated with the one or more attendance boundaries;
determining a geolocation using information associated with at least the address; and
determining whether the geolocation is within the attendance area.

51. The method of claim 50, and further comprising:
requesting, from the one or more data stores, a bounding rectangle associated with the school; and
determining whether the geolocation is within the bounding rectangle.

52. The method of claim 46 wherein the student performance data include one or more Academic Performance Index (API) scores.

53. The method of claim 46 wherein the student performance data include ranking data for the school.

54. The method of claim 46 wherein the student performance data includes one or more aggregate school scores.

55. A method for searching for a property, the method comprising:
receiving, by a search interface, a target school and property search parameters;
processing information associated with the target school and the one or more property search parameters;
accessing one or more data stores;
requesting, from the one or more data stores, one or more attendance boundaries for the target school;
requesting, from the one or more data stores, at least property location data and property characteristic data corresponding to a property, the property location data including an address corresponding to the property;
processing information associated with the property characteristic data and the one or more property search parameters;
processing information associated with the address and the one or more attendance boundaries; and
generating a search result identifying at least data associated with the property if the address is within at least the one or more first attendance boundaries and the property satisfies the one or more property search parameters.

56. The method of claim 55, and further comprising:
determining a first area based on at least information associated with the one or more attendance boundaries;
determining a second area based on at least information associated with the geographic search parameters; and
processing the first area and the second area to determine if the first area and the second area overlap.

57. The method of claim 55, and further comprising:
determining an attendance area based on at least information associated with the one or more attendance boundaries;
determining a geolocation using information associated with at least the address; and
determining whether the geolocation is within the attendance area.

58. The method of claim 57, and further comprising:
requesting, from the one or more data stores, a bounding rectangle associated with the target school; and
determining whether the geolocation is within the bounding rectangle.

59. A method for searching for a property, the method comprising:
receiving, by a search interface, a first target school, a second target school, and property search parameters;
processing information associated with the first target school, the second target school, and the one or more property search parameters;
accessing one or more data stores;
requesting, from the one or more data stores, one or more first attendance boundaries for the first target school;
requesting, from the one or more data stores, one or more second attendance boundaries for the second target school;
requesting, from the one or more data stores, at least property location data and property characteristic data corresponding to a property, the property location data including an address corresponding to the property;
processing information associated with the property characteristic data and the one or more property search parameters;
processing information associated with the address and the one or more first attendance boundaries;
processing information associated with the address and the one or more second attendance boundaries; and
generating a search result identifying at least data associated with the property if the address is within the one or more first attendance boundaries, the address is within the one or more second attendance boundaries, and the first property satisfies the one or more property search parameters.

60. A method for identifying one or more school combinations, the method comprising:
receiving, by a search interface, a first school;
processing information associated with the first school;
accessing one or more data stores;
requesting, from the one or more data stores, one or more first attendance boundaries for the first school;
requesting, from the one or more data stores, one or more second attendance boundaries for at least a second school;
determining a first area based on at least information associated with the first attendance boundaries;
determining a second area based on at least information associated with the second attendance boundaries;
processing the first area and the second area;
identifying a school combination if the first area and the second area overlap; and
generating a search result identifying at least data associated with the school combination.

61. The method of claim 60, and further comprising:
requesting, from the one or more data stores, at least information associated with a third school of a first level;
requesting, from the one or more data stores, at least information associated with a fourth school of a second level;
requesting, from the one or more data stores, at least information associated with a fifth school of a third level;
requesting, from the one or more data stores, information associated with one or more third attendance boundaries associated with the third school;
requesting, from the one or more data stores, information associated with one or more fourth attendance boundaries associated with the fourth school;
requesting, from the one or more data stores, information associated with one or more fifth attendance boundaries associated with the third school;
determining a third area based on information associated with the one or more third attendance boundaries;
determining a fourth area based on information associated with the one or more fourth attendance boundaries;
determining a fifth area based on information associated with the one or more fifth attendance boundaries; and
processing the third area, the fourth area, and the fifth area to determine if they share a sixth area at least as large as a predetermined threshold.

62. The method of claim 61 wherein the predetermined threshold is 50 square feet.

63. The method of claim 61 wherein the first school is selected from a group consisting of the third school, the fourth school, and the fifth school.

64. The method of claim 61, and further comprising:
requesting, from the one or more data stores, a school district associated with the first school;
wherein:
the third school is associated with the school district;
the fourth school is associated with the school district; and
the fifth school is associated with the school district.
